(19) United States
(12) Patent Application Publication
(10) Pub. No.: US 2017/0132200 A1
(43) Pub. Date: May 11, 2017

(54) Method, System, and Medium for Workflow Management of Document Processing

(71) Applicants: James Noland, Girard, PA (US); Christopher Mentch, Erie, PA (US)

(72) Inventors: James Noland, Girard, PA (US); Christopher Mentch, Erie, PA (US)

(21) Appl. No.: 15/322,169

(22) PCT Filed: Jun. 25, 2015
(86) PCT No.: PCT/US15/37769

§ 371 Date: Dec. 26, 2016

Related U.S. Application Data
(60) Provisional application No. 62/028,400, filed on Jul. 24, 2014.
(60) Provisional application No. 62/017,056, filed on Jun. 25, 2014.

(51) Int. Cl. G06F 17/24; G06Q 40/08; G06Q 10/10; G06F 17/21; G06F 3/0482

(52) U.S. Cl. CPC G06F 17/248; G06F 17/212; G06F 17/243; G06F 3/0482; G06Q 10/103; G06Q 40/08; G06F 3/04845

(57) ABSTRACT

A system is provided for workflow management of document processing utilizing one or more objects associated with a workflow, wherein at least one object is imported from an external database. The system creates or edits templates in a template editor utilizing the display device, and stores, in a template, rendering-data received through a builder interface. The system maps to a workflow a template set whose criterion is satisfied by one of the objects associated with the workflow. The system generates a workflow of documents that are each rendered from the stored rendering-data in a template within a template set mapped to the workflow.

This application takes priority from U.S. provisional application 62/028,400, filed on Jul. 24, 2014, and U.S. provisional application 62/017,056, filed on Jun. 25, 2014, which are both incorporated in their entirety herein by reference.

### BACKGROUND

Traditionally, assembling and completing a collection of required medically-related documents (a workflow) has been extremely complicated, time consuming, and inefficient. Bottlenecks often occur when waiting for a particular document in a workflow. For example, a user may not have received all the documents required by an insurance provider that they need to sign. They may have forgotten just a single signature among a multitude of documents that they need to return. Further, users often have to keep recreating the same groups of documents based on certain recurring triggering conditions. For example, a consistent set of documents may be needed when dealing with the same insurance company. Hence, such a recurring condition may require its own unique, but consistent, set of documents. There exists a need for more efficient and accurate document workflow management.

### SUMMARY

A computer-implemented method, system, and/or non-transitory computer-readable medium are provided for workflow management of document processing through a user interface utilizing one or more objects associated with a workflow, wherein at least one object is imported from an external database. Templates are created or edited in a template editor utilizing the display device. Rendering-data received through a builder interface is stored in a template. A template set, whose criterion is satisfied by one of the objects associated with a workflow, is mapped to the workflow. A workflow of documents is generated, with each document being rendered from the stored rendering-data in a template within a template set mapped to the workflow.

In variations of the computer-implemented method, system, and/or non-transitory computer-readable medium, the workflow comprises a workstate whose initiation requires the completion of another workstate, each workstate comprises a task whose initiation requires the completion of another task, and a team is assigned to each workstate. Each team comprises a plurality of roles, with each task corresponding to a role that corresponds to a team member, with at least one team member being selected among a plurality of users having such role.

In some embodiments of the computer-implemented method, system, and/or non-transitory computer-readable medium, the workflow comprises a workstate whose initiation requires the completion of another workstate, each workstate comprises a task whose initiation requires the completion of another task, and a team is assigned to each workstate. Each team can comprise a plurality of roles, with each task corresponding to a role that corresponds to a team member, with at least one team member being selected among a plurality of users having such role, and may also include each task, step, and workstate having a deadline, wherein each team member receives a notification when a threshold amount of time, prior to their task's deadline, is exceeded and a subsequent notification when the deadline elapses. Each step can be completed when the last incomplete constituent task is completed, with each workstate being completed when the last incomplete constituent step is completed, and with the workflow is completed with the last incomplete workstate is completed.

In other variations of the computer-implemented method, system, and/or non-transitory computer-readable medium, the criterion can further comprise an object trigger condition that attaches a template set to a workflow. Trigger conditions can comprise insurance provider object trigger options for a specified insurance provider object or any insurance provider object associated with the workflow, or a diagnosis object trigger option, or item object trigger options comprising an item object code trigger, an item object name trigger, and an item object manufacturer trigger.

In other embodiments, the computer-implemented method, system, and/or non-transitory computer-readable medium includes managing the template sets to which a template is assigned.

In some variations, the computer-implemented method, system, and/or non-transitory computer-readable medium also comprises rendering one or more documents, each being rendered based upon the same selected template and being attached to the same workflow.

Variations of the computer-implemented method, system, and/or non-transitory computer-readable medium can comprise rendering one or more documents, each being based upon the same selected template and attached to the same workflow, based on displayed options. Display options can comprise rendering a document with a list of all insurance provider objects associated with the workflow, rendering a document for each insurance provider object selected from among those associated with the workflow. Each generated document contains information regarding its associated insurance provider object, and rendering a document for each insurance provider object associated with the workflow, wherein each generated document contains information regarding its associated insurance provider object.

In some embodiments of the computer-implemented method, system, and/or non-transitory computer-readable medium, the template editor further comprises assigning or removing a template with respect to a template set based on object options comprising objects not being applicable, any objects, and only selected objects, as well as code object options to use a template for all code objects, to use only specified code objects, and an option to exclude code objects entirely. The template editor further comprises displaying options to upload a template and to initialize or edit each of a template's properties, comprising template title, field default font size, page counter location, recipient instructions text field, a fax cover sheet flag, and a compliance document flag.

Other variations of the computer-implemented method, system, and/or non-transitory computer-readable medium render documents containing item object codes for all item objects associated with the instant workflow, all item objects whose codes are specified, or all item objects except those whose codes are specified as being excluded. Documents method can also be attached to the instant workflow which are rendered based upon the same selected template associated with the instant workflow.

In other embodiments of the computer-implemented method, system, and/or non-transitory computer-readable medium, the template builder interface displays an editable template with a listing of selectable input field templates and receives input designating a location within the template for a selected input field template. The template builder interface can also render a document, based upon the edited template, having an input field located thereon according to the received position information.

In some variations of the computer-implemented method, system, and/or non-transitory computer-readable medium, the template builder interface displays a selected editable template with a listing of selectable input field templates and receives input dragging and sizing a selected field template onto a pixel-defined location within the editable template. The template builder interface can also display editable field property options comprising a required-field flag, a flag to propagate the field template to subsequent pages upon rendering, a specified default value, a specified comparison value, an encryption option, and a specified number of fields over which to split the instant field over upon rendering. The template builder interface may also display a preview version of the editable template, wherein each associated field template is displayed according to its respective specified pixel position and specified field properties, and render a document, based on the template, having an input field located thereon according to the received input.

In variations of the computer-implemented method, system, and/or non-transitory computer-readable medium, the template editor displays options to assign and remove a template with respect to a template set and options to create and edit a template.

In some embodiments of the computer-implemented method, system, and/or non-transitory computer-readable medium, the template editor displays options to toggle template visibility, to indicate a template is a favorite, and to clone a template by requiring a different title.

In other variations of the computer-implemented method, system, and/or non-transitory computer-readable medium, the template editor further comprises a customizable checklist designating which fields in a rendered document require completion prior to the rendered document being designated as complete.

In other embodiments of the computer-implemented method, system, and/or non-transitory computer-readable medium, the user interface displays options for downloading, secure-sending electronic transmission, and faxing a rendered document.

In some variations of the computer-implemented method, system, and/or non-transitory computer-readable medium, the template builder interface displays a notification in a rendered document when an object value does not match any values in a list of comparison values in a field in the template.

In variations of the computer-implemented method, system, and/or non-transitory computer-readable medium, the template builder interface outputs an item object listing within a rendered document, with any item objects exceeding a quantity threshold for a page being rendered on a subsequent page of the rendered document.

In some embodiments of the computer-implemented method, system, and/or non-transitory computer-readable medium, the template builder interface further comprises an editable field property flag that auto-copies a value entered into a field rendered across all supplemental pages in a rendered document.

In other variations of the computer-implemented method, system, and/or non-transitory computer-readable medium, the user interface receives input delegating each document template in a workflow to one or more different users, which removes the workflow from the user's interface until at least one delegated document template is returned or cancelled.

In other embodiments of the computer-implemented method, system, and/or non-transitory computer-readable medium, the user interface further comprises a profit analyzer interface that displays a profit index calculated by dividing a received positive item allowance amount by a received positive item cost amount.

In some variations of the computer-implemented method, system, and/or non-transitory computer-readable medium, the user interface displays an object imported from an outside database as a selectable pre-generated object.

In variations of the computer-implemented method, system, and/or non-transitory computer-readable medium, a template can be manually associated with a workflow.

In some embodiments of the computer-implemented method, system, and/or non-transitory computer-readable medium, a field may be displayed in the rendered document only if a recipient account is of a role type matching a role type specified by the recipient options within the field's recipient options.

In other variations of the computer-implemented method, system, and/or non-transitory computer-readable medium, a change in data associated with a field propagates the field's data by causing an automatic re-rendering of all documents in the same workflow utilizing the field.

In other embodiments, the computer-implemented method, system, and/or non-transitory computer-readable medium comprises a signature input field that includes options to type and draw a signature, an option indicating the signer is authorized to sign, and an option indicating the client cannot sign with a field receiving the signer's name and relationship to the client and a field receiving a reason the client cannot sign.

In some variations of the computer-implemented method, system, and/or non-transitory computer-readable medium, the quantity of pages in a rendered document corresponds to the quantity of item objects rendered in the rendered document.

In variations of the computer-implemented method, system, and/or non-transitory computer-readable medium, the criterion further comprises an object trigger condition that attaches a template set to a workflow based on satisfying a data range condition for an input value received in a field in a rendered document from the template set.

In some embodiments of the computer-implemented method, system, and/or non-transitory computer-readable medium, rendered documents are dynamically replicated into the workflow based on each different value of an object type within a workflow, each rendered document reflecting its respective value of the object type.

In other variations of the computer-implemented method, system, and/or non-transitory computer-readable medium, rendered documents are delegated within a user account to selected user accounts associated with the user account, each selected user account being assigned to complete at least one delegated rendered document.

In other embodiments of the computer-implemented method, system, and/or non-transitory computer-readable medium, rendered documents are delegated within a user account to selected user accounts associated with the user account, with each selected user account being assigned to complete at least one delegated rendered document. Upon completion of an assigned rendered document, the user interface presents append and replace options for the completed document.

In some variations of the computer-implemented method, system, and/or non-transitory computer-readable medium, the workflow utilizes a work-in-progress comprising tasks to be completed, documents to be completed, appointments to be completed, role assigned to each task, deadline to complete each task, and the next work-in-progress state.

In variations of the computer-implemented method, system, and/or non-transitory computer-readable medium, the user interface presents a graphical dashboard interface of all workflows associated with a user account.

In some embodiments of the computer-implemented method, system, and/or non-transitory computer-readable medium, the user interface removes a task associated with a user's account when the user has delegated all portions of the task to other users or groups within an organization to which the user account belongs.

In other variations of the computer-implemented method, system, and/or non-transitory computer-readable medium, the user interface provides an option that hides a client's last name in all documentation associated with an organization.

In other embodiments of the computer-implemented method, system, and/or non-transitory computer-readable medium, the criterion further comprises an object trigger condition that attaches a template set to a workflow based on satisfying a data range condition for an input value received in a field in a rendered document from the template set. A document from the attached template set, once rendered, displays fields pre-populated with data from an object associated with the object trigger condition.

In some variations of the computer-implemented method, system, and/or non-transitory computer-readable medium, the user interface further presents administrative options, for user accounts and fax numbers, comprising add, edit, update, and delete, with respect to both a company's account and to each of the company's plurality of branch locations.

A document rendering computer-implemented method, system, and/or non-transitory computer-readable medium utilizing a template builder interface on a display device comprises displaying a listing of selectable input field templates in an editable template, displaying a thumbnail version of each template page, and subsequently receiving input dragging and sizing a selected field template onto the editable template, with the field template location corresponding to editable location values within the editable template. Editable field properties are displayed comprising a required-field flag, a flag to propagate both the field template and its received data to subsequent pages upon rendering, a default value, and a comparison value. Subsequently, a preview version of the editable template is displayed, wherein each associated field template is displayed according to its respective specified location values and its field property values. Subsequently a document is rendered on the display device, based on the template, with an input field located on the rendered document according to the specified location values. In variations of the document rendering computer-implemented method, system, and/or non-transitory computer-readable medium utilizing the template builder interface, options for a currently selected field template include dragging, resizing, copying, deleting, field character limit, mandatory default value, optional default value, an encryption option, measurement unit types comprising weight measurement units, time measurement units, and size units comprising length, width, and height measurement units. More options include specifying a field type that comprises a text field, a drop-down list that utilizes input in a delimited document, a numeric split value that specifies a number of fields over which to split the instant field between upon rendering. Further options include selecting a recipient role comprising clinician, vendor, physician, and client.

Those skilled in the art will realize that this invention is capable of embodiments that are different from those shown and that details of the devices, media and methods can be changed in various manners without departing from the scope of this invention. Accordingly, the drawings and descriptions are to be regarded as including such equivalent embodiments as do not depart from the spirit and scope of this invention.

### BRIEF DESCRIPTION OF DRAWINGS

For a more complete understanding and appreciation of this invention, and its many advantages, reference will be made to the following detailed description taken in conjunction with the accompanying drawings.

FIG. 1 is a flowchart illustrating workflow modification based on objects.

FIG. 2 is a screenshot of an account login interface.

FIG. 3 is a screenshot depicting an account creation interface.

FIG. 4 is a screenshot depicting a login credentials creation interface.

FIG. 5 is a screenshot of a Terms of Use acceptance interface.

FIG. 6 is a screenshot of a password retrieval interface.

FIG. 7 is a screenshot depicting a home interface.

FIG. 8 is a screenshot continuing a depiction of the home interface.

FIG. 9 is a screenshot continuing a depiction of the home interface with a date selection option.

FIG. 10 is a screenshot showing a support request interface.

FIG. 11 is a screenshot of a profile interface.

FIG. 12 is a screenshot of a password change interface.

FIG. 13 is a screenshot of an email address management interface.

FIG. 14 is a screenshot of adding an email address in the email address management interface.

FIG. 15 is a screenshot of a fax preference management interface.

FIG. 16 is a screenshot depicting access to an external data source for client information.

FIG. 17 is a screenshot of a user management interface.

FIG. 18 is a screenshot of a user being added in the user management interface.

FIG. 19 is a screenshot of a branch user permissions interface.

FIG. 20 is a screenshot of a branch management interface.

FIG. 21 is a screenshot of a specified branch in the branch management interface.

FIG. 22 is a screenshot of a company management interface.

FIG. 23 is a screenshot of an administration interface.

FIG. 24 is a screenshot of a logo management interface.

FIG. 25 is a screenshot of a fax number management interface.

FIG. 26 is a screenshot of a fax number permissions management interface.

FIG. 27 is a screenshot of a client creation interface.

FIG. 28 is a further screenshot of the client creation interface.

FIG. 29 is a screenshot of a workflow object creation interface depicting confirmation of client information.

FIG. 30 is a screenshot depicting a client notes interface.

FIG. 31 is a screenshot depicting a client audit interface.

FIG. 32 is a screenshot of a workflow object creation interface depicting diagnosis, insurance, and previous equipment interfaces.

FIG. 33 is a screenshot depicting the previous equipment creation interface.

FIG. 34 is a screenshot depicting text being imported into a customized comment field.

FIG. 35 is a screenshot of a customized comment text field being updated.

FIG. 36 is a screenshot of a workflow object creation interface.

FIG. 37 is a screenshot depicting an equipment item with an accompanying customized comment text field.

FIG. 38 is a screenshot depicting a text template with a different client's information applied to placeholders.

FIG. 39 is a screenshot depicting a workflow notes interface.

FIG. 40 is a screenshot depicting utilizing options in a workflow notes interface.

FIG. 41 is a screenshot depicting a pop-out version of a workflow notes interface.

FIG. 42 is a screenshot of a workflow messaging interface.

FIG. 43 is a screenshot of a workflow object creation interface with options to add a physician and create a new workflow.

FIG. 44 is a screenshot of a workflow object creation interface with physician search options.

FIG. 45 is a screenshot of a workflow object creation interface with physician creation options.

FIG. 46 is a screenshot depicting a client information interface.

FIG. 47 is a screenshot of a change in workflow status.

FIG. 48 is a screenshot further depicting a client information interface with diagnosis, insurance, and clinician options.

FIG. 49 is a screenshot further depicting a client information interface with clinician and physician options.

FIG. 50 is a screenshot further depicting a client information interface with physician, vendor, and evaluation participant options.

FIG. 51 is a screenshot further depicting a client information interface with vendor, and evaluation participant options.

FIG. 52 is a screenshot depicting an item information interface.

FIG. 53 is a screenshot depicting an item adding interface.

FIG. 54 is a screenshot of items being appended to an item kit in an item adding interface.

FIG. 55 is a screenshot depicting the creation of a new item kit within an item adding interface.

FIG. 56 is a screenshot depicting a profit analysis interface.

FIG. 57 is a screenshot depicting a company options modification interface.

FIG. 58 is a screenshot depicting a client information final review interface with evaluation date, client information, and diagnosis data options.

FIG. 59 is a screenshot further depicting a client information final review interface with insurance, subject, primary item, and item list options.

FIG. 60 is a screenshot further depicting a client information final review interface with primary equipment item category selection options and clinician options.

FIG. 61 is a screenshot further depicting a client information final review interface with primary equipment item model selection options and clinician options.

FIG. 62 is a screenshot further depicting a client information final review interface with primary item, item list, and clinician options.

FIG. 63 is a screenshot depicting an interface to edit a primary item.

FIG. 64 is a screenshot depicting an interface to add an item.

FIG. 65 is a screenshot depicting a quick-add interface for a new item.

FIG. 66 is a screenshot further depicting a client information final review interface with physician, vendor, and evaluation participant options.

FIG. 67 is a screenshot depicting a workflow template management interface.

FIG. 68 is a screenshot further depicting a template management interface with a team note displayed.

FIG. 69 is a screenshot depicting a template status history interface.

FIG. 70 is a screenshot depicting a template QA interface.

FIG. 71 is a screenshot depicting a rendered template preview interface.

FIG. 72 is a screenshot depicting a template editing interface.

FIG. 73 is a screenshot depicting a signature field management interface.

FIG. 74 is a screenshot further depicting a template editing interface.

FIG. 75 is a screenshot further depicting a template management interface.

FIG. 76 is a screenshot depicting a template preview interface.

FIG. 77 is a flowchart for a template builder interface.

FIG. 78 is a screenshot depicting a template builder interface.

FIG. 79 is a screenshot further depicting a template builder interface with active field options.

FIG. 80 is a screenshot further depicting a template builder interface with field properties.

FIG. 81 is a screenshot further depicting a template builder interface with more field properties.

FIG. 82 is a screenshot depicting a template field preview interface.

FIG. 83 is a screenshot depicting a secure send interface.

FIG. 84 is a screenshot depicting an email received via secure send.

FIG. 85 is a screenshot depicting a send fax interface.

FIG. 86 is a screenshot further depicting a workflow template management interface with updated template request and fax request data.

FIG. 87 is a screenshot depicting a signed template copy upload interface.

FIG. 88 is a screenshot depicting a deleted items interface.

FIG. 89 is a screenshot depicting a My Database interface.

FIG. 90 is a flowchart for a template editor interface.

FIG. 91 is a screenshot depicting a template listing management interface.

FIG. 92 is a screenshot depicting a template management interface.

FIG. 93 is a screenshot depicting an add template interface.

FIG. 94 is a flowchart for a template set interface.

FIG. 95 is a screenshot depicting a template set listing management interface.

FIG. 96 is a screenshot depicting an add template set interface.

FIG. 97 is a screenshot depicting a template set management interface.

FIG. 98 is a screenshot depicting an insurance trigger interface.

FIG. 99 is a screenshot depicting a diagnosis trigger interface.

FIG. 100 is a screenshot depicting an item trigger interface.

FIG. 101 is a screenshot further depicting a template set management interface.

FIG. 102 is a screenshot depicting a global item listing management interface.

FIG. 103 is a screenshot depicting an item management interface.

FIG. 104 is a screenshot further depicting an item management interface.

FIG. 105 is a screenshot depicting an item kit management interface.

FIG. 106 is a screenshot depicting a diagnosis management interface.

FIG. 107 is a screenshot depicting a diagnosis record audit interface.

FIG. 108 is a screenshot depicting an insurance provider management interface.

FIG. 109 is a screenshot depicting an insurance provider audit interface.

FIG. 110 is a screenshot depicting a resource search interface.

FIG. 111 is a screenshot depicting a resource search results interface.

FIG. 112 is a screenshot depicting a resource management interface.

FIG. 113 is a screenshot depicting a resource creation interface.

FIG. 114 is a screenshot depicting a workflow note management interface.

FIG. 115 is a screenshot depicting a vendor accounts listing management interface.

FIG. 116 is a screenshot depicting an add vendor interface.

FIG. 117 is a screenshot depicting a previous item comment management interface.

FIG. 118 is a screenshot depicting a letter closing text management interface.

FIG. 119 is a screenshot depicting an attestation text management interface.

FIG. 120 is a screenshot depicting a client search interface.

FIG. 121 is a screenshot further depicting the home interface utilizing a client search.

FIG. 122 is a screenshot depicting an inbox interface.

FIG. 123 is a screenshot depicting a workflow management interface.

FIG. 124 is an illustration depicting workstates, steps, tasks, and timing within a workflow.

FIG. 125 is an illustration depicting QA item status review interface for a workstate.

FIG. 126 is an illustration depicting a workstate change interface.

FIG. 127 is an illustration depicting a change in workstate ownership.

FIG. 128 is an illustration depicting QA item status review for a workstate with elevated privileges.

FIG. 129 is an illustration depicting a workstate change with elevated privileges.

FIG. 130 is an illustration depicting a change in workstate ownership with elevated privileges.

FIG. 131 is an illustration depicting an element view of a workflow.

FIG. 132 is an illustration depicting a workstate view of a workflow with expanded workstates.

FIG. 133 is an illustration depicting a workstate view of a workflow with collapsed workstates.

FIG. 134 is an illustration depicting a workstate history view of a workflow.

FIG. 135 is an illustration depicting a document search interface.

FIG. 136 is an illustration depicting a document search interface with document records.

FIG. 137 is an illustration depicting a document search interface with advanced search options.

FIG. 138 is an illustration depicting a document search interface with additional advanced search options.

FIG. 139 is an illustration depicting an alternate embodiment of a document search interface with document records.

FIG. 140 is a block diagram of an embodiment of a computer system that can function in one or more embodiments disclosed herein.

FIG. 141 is a block diagram of an exemplary computing network that can function in one or more of the embodiments described herein.

### DETAILED DESCRIPTION

Referring to the drawings, some of the reference numerals are used to designate the same or corresponding parts through several of the embodiments and figures shown and described. Corresponding parts are denoted in different embodiments with the addition of lowercase letters. Variations of corresponding parts in form or function that are depicted in the figures are described. It will be understood that variations in the embodiments can generally be interchanged without deviating from the invention.

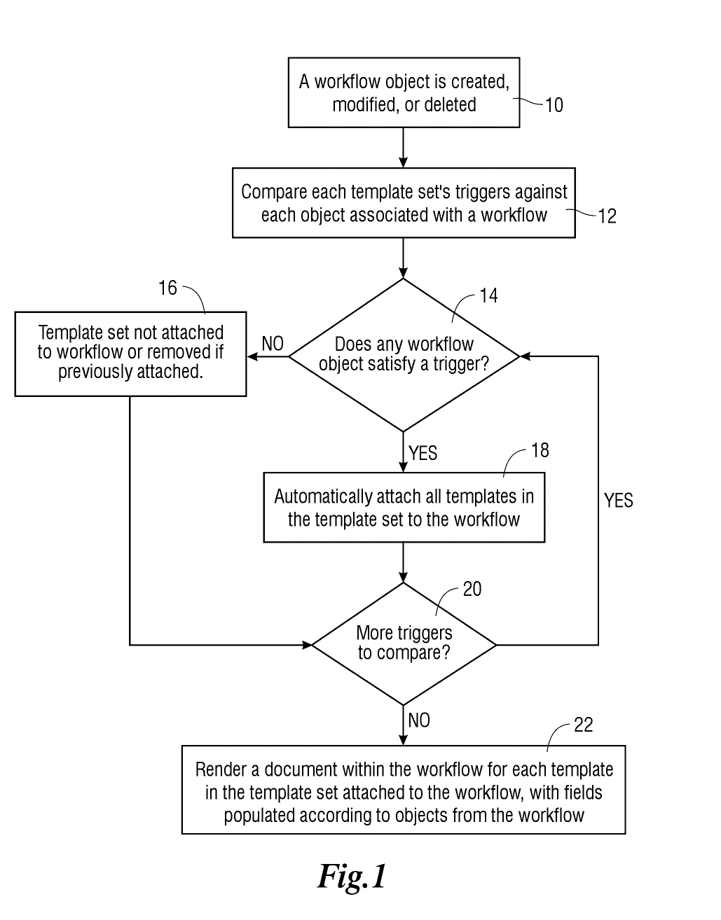

A collection of documents, also known as a workflow, is often needed in the context of medical care, medical/rehab equipment, and insurance billing. As used herein, the terms document set and template set can all be used interchangeably. Similarly, the term form builder can be used interchangeably with the term template builder. Workflow management relates to, among other things, the creation, modification, quality control, assignment and tracking of rendered documents, templates, and the collections to which each template belongs. Workflow management can also relate to arranging documents in order of priority (for example, among multiple/chained-dependencies among documents, among users, or both) and/or sorting of documents. The templates needed for a workflow may depend on a variety of factors, for example a diagnosis, the type of equipment, or the one or more insurance companies involved. FIG. 1 provides, for embodiments, a high-level overview of aspects of workflow management, as will be discussed in more detail below. As part of a workflow, objects associated with the workflow (such as clients, equipment items, diagnoses, insurers, etc.) can be created, modified, deleted, or imported 10. Once workflow objects are complete (or modified), they are compared to triggers belong to different template sets 12. If none of a template set's trigger's criteria are met 14, then the template set may not be added to the workflow 16. Similarly, if a trigger's criteria are no longer met by a template set within the workflow 14, then the template set (and rendered documents based thereon) may be removed 16 from the workflow. If, however, a workflow object satisfies one of a template set's triggers' criteria 14, that template set can then be added/appended to the instant workflow 18. Similarly, if an update to a workflow object subsequently makes it a match for a trigger's criterion 14, then the template set with which the trigger(s) is/are associated can be added/appended to the workflow 18. This is performed until all (or specified) triggers have been compared with workflow objects 20. Either automatically or on-demand, some or all templates associated with the workflow can be rendered into documents, utilizing data from the workflow's objects 22. In some embodiments, a template may not belong to any template sets, or alternatively it may belong to multiple template sets. Additionally, template sets may be utilized for any number of workflows. In some embodiments, each template can have its own trigger(s), irrespective of whether such template belongs to any template sets. A template, therefore, may be added to a workflow without belong to a template set.

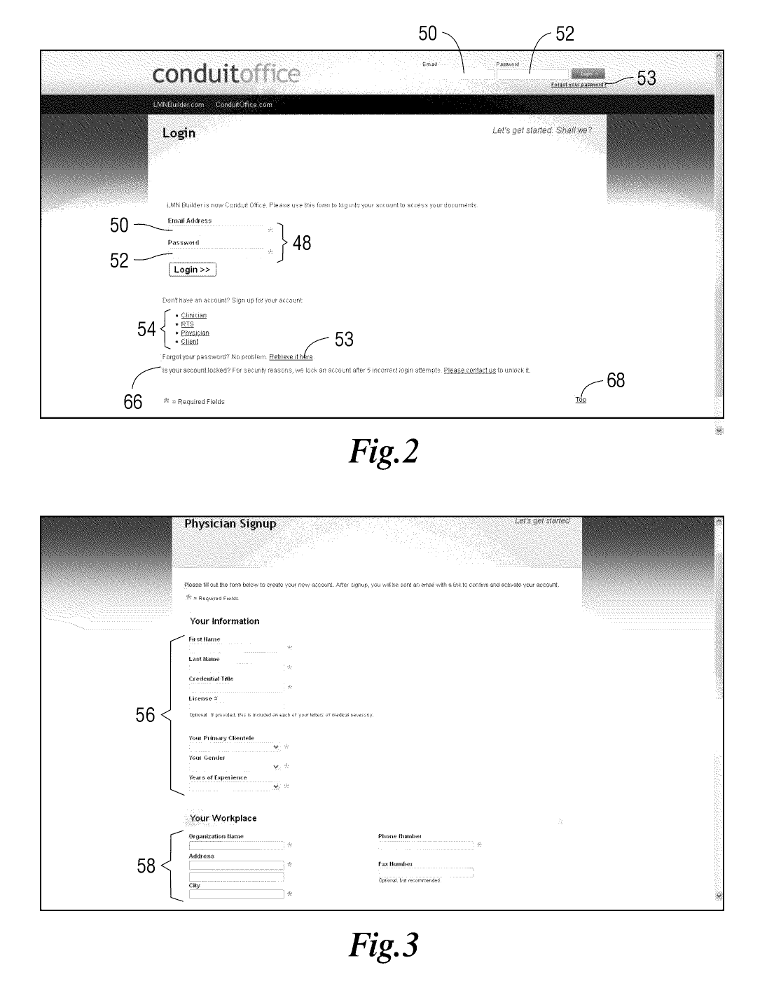

In some embodiments, online accounts must first be generated for users, wherein the account types can include, for example, clinicians, Rehab Technology Suppliers (or RTS, hereinafter ‘vendors’), physicians, and clients. A user can be any individual utilizing any interface described herein. Clinician users can utilize clinician-type accounts, vendor users can utilize vendor-type accounts, physician users can utilize physician-type accounts, and client users can utilize client-type accounts, for example. Once generated, online accounts can use any appropriate method for online authentication including, but not limited to, password(s), biometric authentication(s), periodically/randomly-generated PIN(s), CAPTCHA(s), and/or RE-CAPTCHA(s). The instant embodiment employs an automatic logout after a period of inactivity. Some embodiments utilize a definable timeout period. Other embodiments do not utilize an automatic logout feature. FIG. 2 depicts an embodiment of an interface having required fields for a username 50 and a password 52 for authentication. In the instant embodiment, any field described herein, including password fields, can optionally utilize input obfuscation (such as dots) instead of the actual input. Any field described herein that displays previously entered input can optionally display obfuscate stored text (such as dots) when retrieved, whereas other embodiments may not employ such obfuscation. Any field described throughout can be a required field, wherein received input is not complete until the input conforms to the requirements of the input field. Additionally, any interface can utilize an add option to add new data, whether a single field or a collection of fields. Some embodiments may require certain fields to be completed prior an add option being selectable. In other embodiments, an add option can be selectable without conditions on its accessibility.

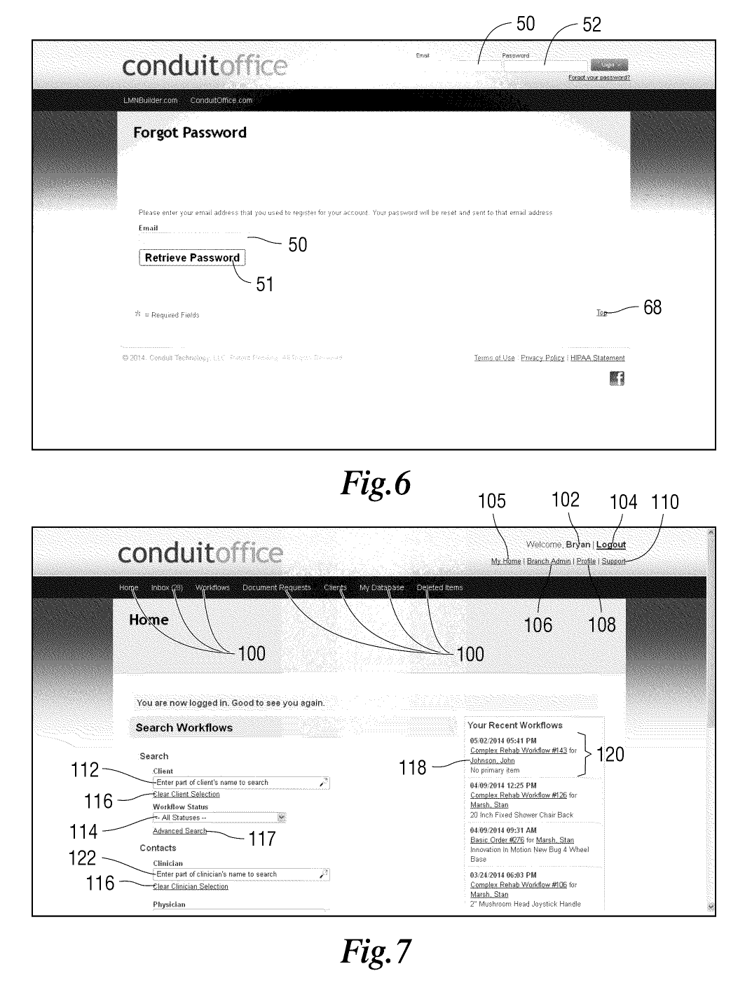

The interface also presents password retrieval options 53, as discussed below with respect to FIG. 6. The interface further presents an option to unlock a user account 66. In some embodiments, a user can become locked out of their account after a threshold number of unsuccessful login attempts. In some embodiments, an administrator can set such a lockout threshold. In other embodiments, the user can set such a lockout threshold for their own account. The interface further includes a top view option 68 that when selected returns to the top of the interface screen, where any interface screen can utilize such view options. Other embodiments can include options to return to the bottom, left, or right of an interface screen.

Although FIG. 2 and subsequent figures depict asterisks to denote required fields, any notation can be utilized. In some embodiments, required fields need not be visibly denoted at all. Any field described herein can be a required field. Any field described throughout can have any appropriate validation conditions, such as requiring a maximum/minimum of letters/numbers/special-characters/uppercase/lower-case or total characters, requiring certain characters (e.g., requiring an ‘@’ symbol for input received in email address fields), formatting requirements (e.g., requiring XX/XX/XXXX or XX-XX-XX for input received in date fields). Any appropriate type of field validation technique can be utilized in various embodiments.

Any account login interface described herein can optionally utilize a role-selection field (not shown) as well, which allows a user to specify whether they have a clinician, vendor, physician, or client account, for example. Activities involving protected client data require a secure online account, and secure data transmission, to comply with The Health Insurance Portability and Accountability Act of 1996 (HIPAA). To achieve HIPAA compliance, all account types provide secure data storage and transmission. However, many aspects described herein do not utilize such client information, and therefore those aspects can utilize any manner of transmittal and/or notification, including (but not limited to) unsecured email, text message, internet/IP-based messaging, phone call, pager, etc. (all are hereinafter designated as a notification). Therefore, users of each account type are required to utilize their secure online account for aspects that involve protected client data, but not necessarily for other aspects herein. Therefore, no element or limitation should be construed as requiring the utilization of a secure online account, or secure data transmission, unless it utilizes client data protected under HIPAA. In some embodiments, any text field can utilize a text-clearing option whereby a user can clear any text currently in the text field, regardless of whether the text was entered by the user or pre-populated. The interface can also present account-creation options 54, which can include links register respective account types, here shown as clinician, vendor, physician, and client. However, any other type of user account is possible and is in no way limited to these specific account types or to only such associated functionality.

FIG. 3 depicts account creation after the interface receives input for a physician account-creation option 54 (from FIG. 2), although the following can apply to any account type. User information 56 can be requested through input fields that can include name, credential/title, license #, clientele type (pediatric, adult, geriatric, etc.), gender, and experience level. Workplace/contact information 58 can include organization name, phone/fax number, street address, and city, for example. Any provided information can be utilized in workflows as discussed below.

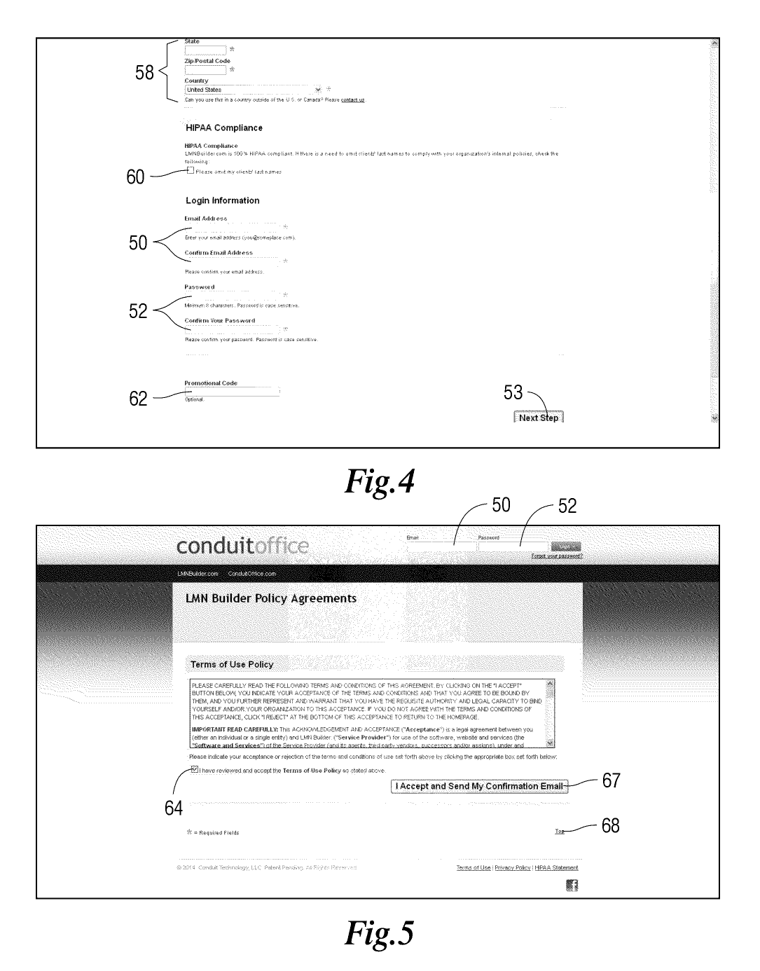

FIG. 4 continues with the account creation depicted in the instant embodiment. Workplace/contact information 58 can further include county, state, zip/postal code, and country, for example. The interface can also utilize an option to omit a client's last name 60. The interface also receives a user email address 50 that can serve as the username, and also receives a password 52, both of which can be required to be typed multiple times to confirm accuracy. Additionally, the interface can process optional promotional codes 62 entered by the user, and present a selectable completion indicator 63. FIG. 5 continues with the account creation depicted in the instant embodiment. The interface can require a user to accept terms and conditions 64 and utilize an acceptance confirmation indicator 67.

In some embodiments, when a user forgets their password, they can utilize a password retrieval interface. FIG. 6 depicts an exemplary password retrieval interface, requesting the user's email address 50 and a password retrieval option 51. Although FIG. 6 depicts the user's email being used to receive a temporary password, other embodiments can utilize any authentication technique (or combination thereof) discussed above in FIG. 2 with respect to account authentication. In some embodiments, other identifying information associated with a user account, such as a user name, can also be utilized. Returning to FIG. 2, a security warning 66 discloses an account locking feature wherein a certain number of incorrect login attempts will lock the account associated with the user name. In some embodiments any number of incorrect attempts can be utilized as the account-locking threshold. Some embodiments present this threshold lockout number as an option definable by the account holder or other users.

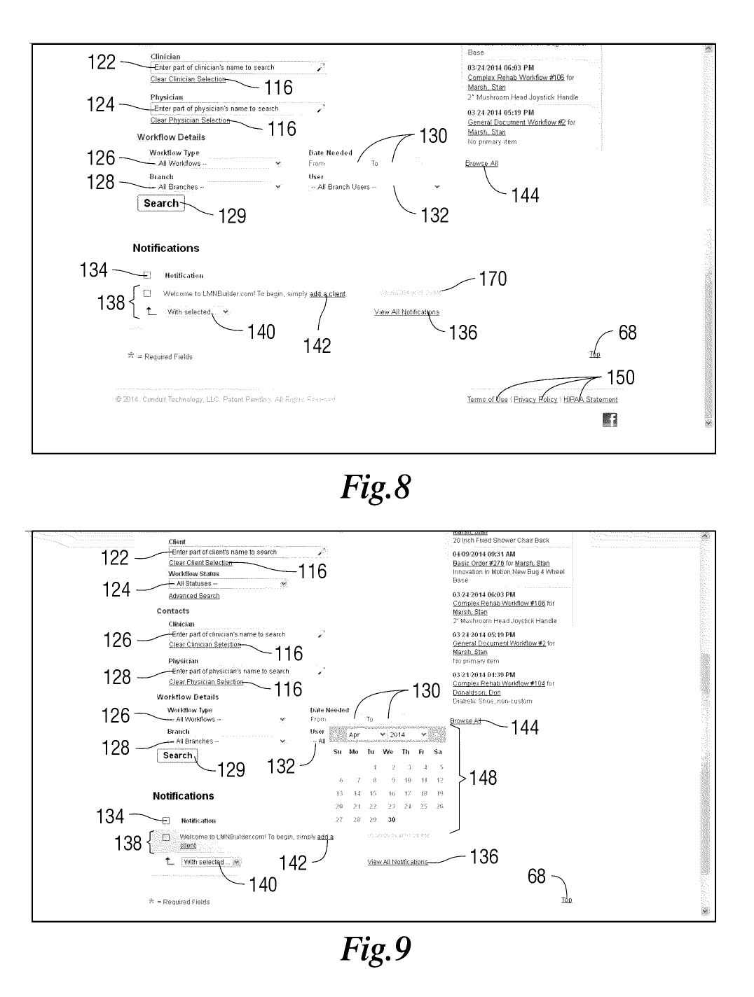

FIG. 7 depicts a home interface used in some embodiments to manage workflows associated with an account. The interface displays heading links 100 (each discussed in detail below) that can provide quick access to the home interface, to an inbox interface, to a workflow management interface, to a clients interface (whose options are shown in FIGS. 7-8 for client creation and FIG. 122 for client search), to a My Database interface, and to a deleted items interface. Other links can be displayed in other embodiments. In some embodiments, the heading links 100 are visible in every interface screen disclosed herein. The home interface can display a username 102, which in various embodiments can be displayed as a custom-created name, a first name, last name, a title, any other identifier, and/or any combination thereof. The home interface also provides a logout option 104. The home interface further provides administrative options that, in some embodiments, are selectable in any interface screen disclosed herein. Administrative options can include a home option 105 that returns the user to the instant interface. Administrative options can also include a branch administration option 106, a profile management option 108, and a support option 110.

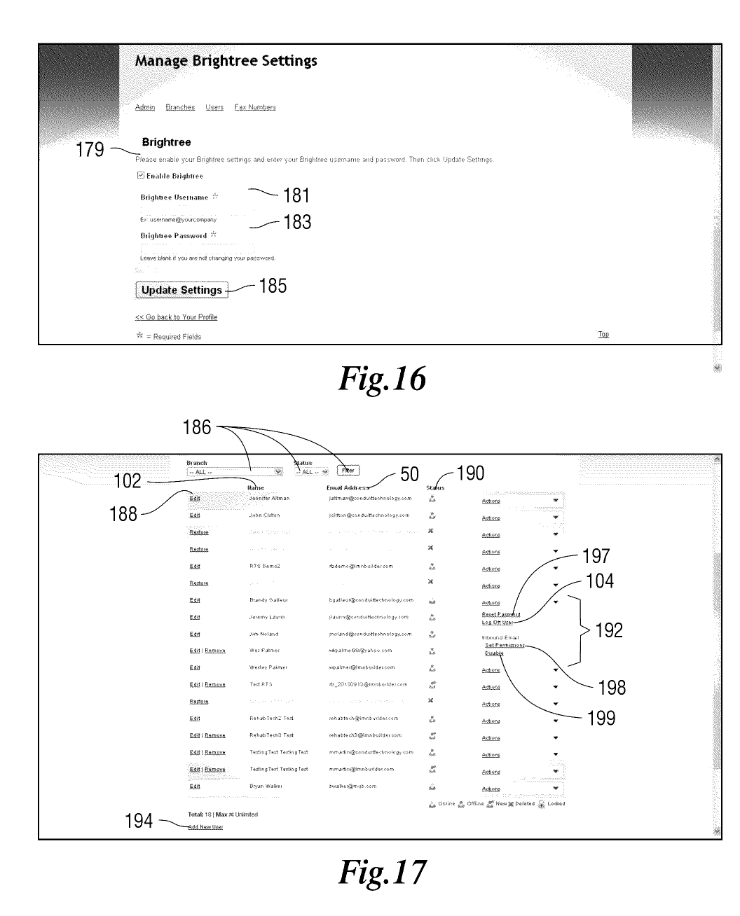

The home interface further provides the user with options to search for workflows by various criteria, including a client's name 112 and workflow status 114 (e.g., new assessment, in progress, submitted, printed to fax, accepted, rejected completed, downloaded, overdue, and cancelled). Any text field described herein can utilize any type of suitable search technique, such as searching existing records according to a received portion of a name, a partial description, or a partial number. Additionally, a user can also search for client accounts from BRIGHTREE® or any other suitable data sources or external databases, which may require separate authentication, as depicted in FIG. 16.

Returning to FIG. 7, in some embodiments, the user can then import the client information from the data source. Any field described herein can utilize a ‘Clear Selection’ 116 option (or any other suitable name) to remove any contents within a field. The home interface includes an ‘Advanced Search’ 117 set of option, which in the present embodiment reveals more search options discussed below. In other embodiments, some, all, or other options can be always visible. Additionally, any interface described herein can utilize an Advanced Search 117 type of option to hide/reveal fields or other data. Search options can also include clinician name 122. The interface in some embodiments can also display recent workflows 120 associated with the account, such as recently created and/or edited workflows. A recent workflow listing 120 can include a date/time-stamp, a link to the workflow, and a description and/or link to an equipment item associated with the workflow. Additionally, it can include a link to the client 118, which can lead to a listing of all of the client's workflows.

In FIG. 8, the home interface further includes workflow search options that include physician name 124, vendor name (not shown), workflow type 126 (e.g., basic order, complex rehab workflow, general document workflow, seating and evaluation, specification sheet), date needed range 130, and user 132. The date needed range 130, or any other field, can utilize any suitable date-specification interface, as one embodiment depicts in 148 of FIG. 9. The home interface can present a search option 129 to search by any criteria specified above with respect to FIGS. 7-8.

Returning to FIG. 8, a user can also search workflows according to associated users 132. For example, other users at a branch location may be associated with the instant account and/or the workflow. The interface can also include an option to browse all recent workflows 144. The interface can further include a notifications section, wherein notifications associated with the account can be displayed. Notification can include workflow update notifications, wherein a notification can be provided whenever another user, who has been delegated a task (such as completing forms specified by the instant user) completes such a task, or performs any action that warrants a status update regarding that delegated task. As discussed in detail below with respect to FIGS. 83-87, users can send template documents to other users (such as with secure send and/or fax options), and thereby delegate (and re-delegate as necessary) tasks, such as completion of template documents that they receive.

The notifications section in FIG. 8 can include an option to select/de-select all notifications 134. Any selectable listing can include such a select/de-select all option. The notifications section can include an option to view all notifications 136. Each notification listing 138 may display a date/time-stamp 170 and can utilize a selectable field, such as a checkbox, that can be utilized with a notification option 140 and include options such as deleting selected notifications. A notification listing 138 can also utilize an option to create a new client 142, although such an option can be utilized anywhere else in various embodiments. Creating a new client 142 can also initialize a new workflow. Additionally, some embodiments may include options to sort notifications by various criteria, such as date/time-stamp, notification name, account-type, and/or the names of users having various account types. Any interface screen, including the home interface screen, can provide notice options 150 to view, for example, terms of use, privacy policy, and HIPAA statement materials.

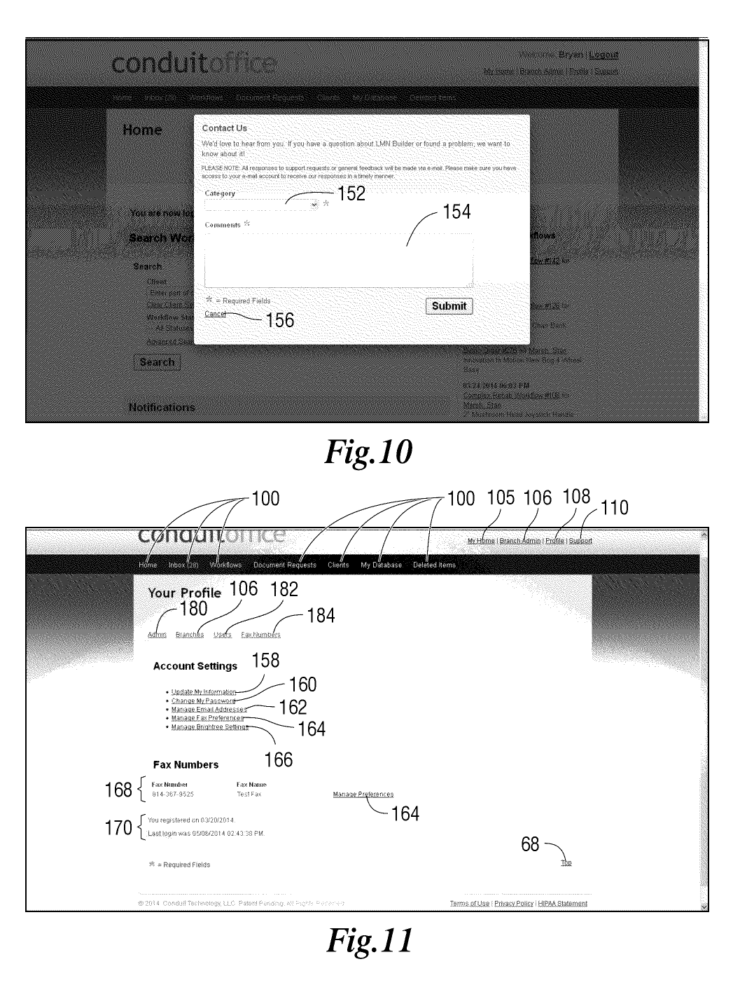

FIG. 10 illustrates a contact interface for a user to receive support, which corresponds to the support option 110 in FIG. 7. A user can select a category 152 and type in a comments field 152. In other embodiments, the user can create a custom category. The contact interface also provides a cancel option 156, which returns the user to the previous screen. In other embodiments, a cancel option 156 can return the user to any specified interface described herein. Any interface described herein can utilize a cancel or similar option wherein changes are not committed. In some embodiments, a pop-up or other notification will seek confirmation prior to performing such a cancel option, which can include notification that changes made will not be saved.

FIG. 11 depicts a profile interface that can correspond with the profile management option 108 in FIG. 7, displaying options to update the user's information 158, change their password 160, manage their email addresses 162, manage fax preferences 164, and manage data sources 166. Additionally, the user can view fax preference information 168 which can include a fax number, fax name, and also a managing fax preferences option 164. The profile interface also displays timestamps 170, such as when the account was registered and the last login time. Timestamps can be displayed and/or used for calculations/queries and can be displayed in any appropriate temporal units for any activity. Timestamps can also be utilized for any interface described herein. Options are also presented, for example, to select the admin option 180, user management option 182, and fax number management option 184. Any usage of the term “fax” herein can include e-fax technology, which is readily known in the art as utilizing internet-based protocols and does not warrant further discussion.

Selecting the option to update user information 158 can bring up the account creation interface discussed above with respect to FIGS. 3-4. In some embodiments, the fields are pre-populated with the account's current information, although not all the fields in those figures need be utilized. Additional fields not depicted in FIGS. 3-4 can be utilized as well.

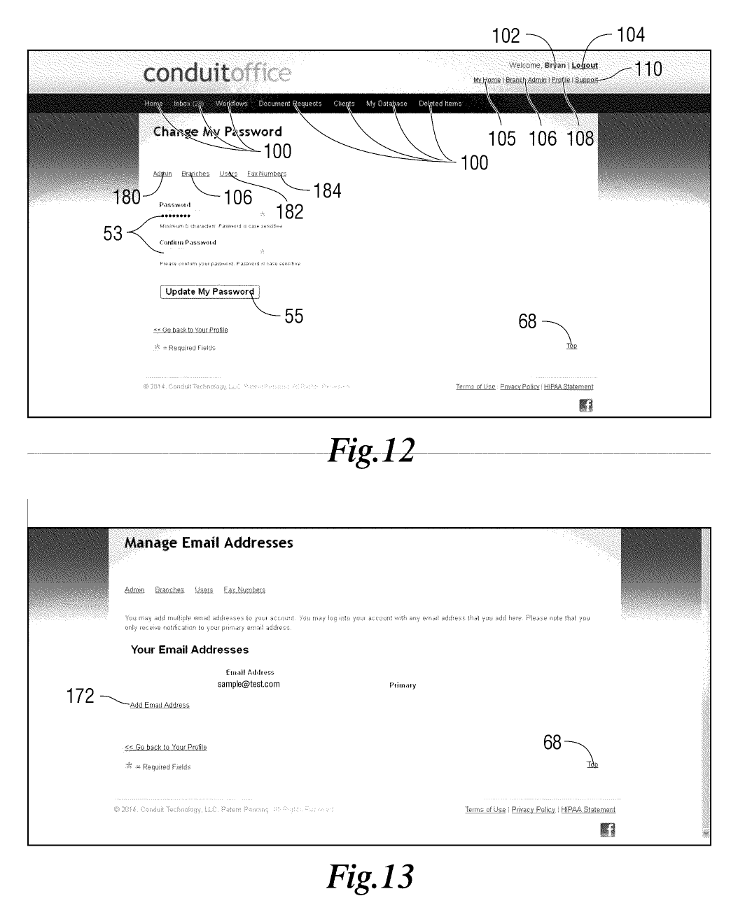

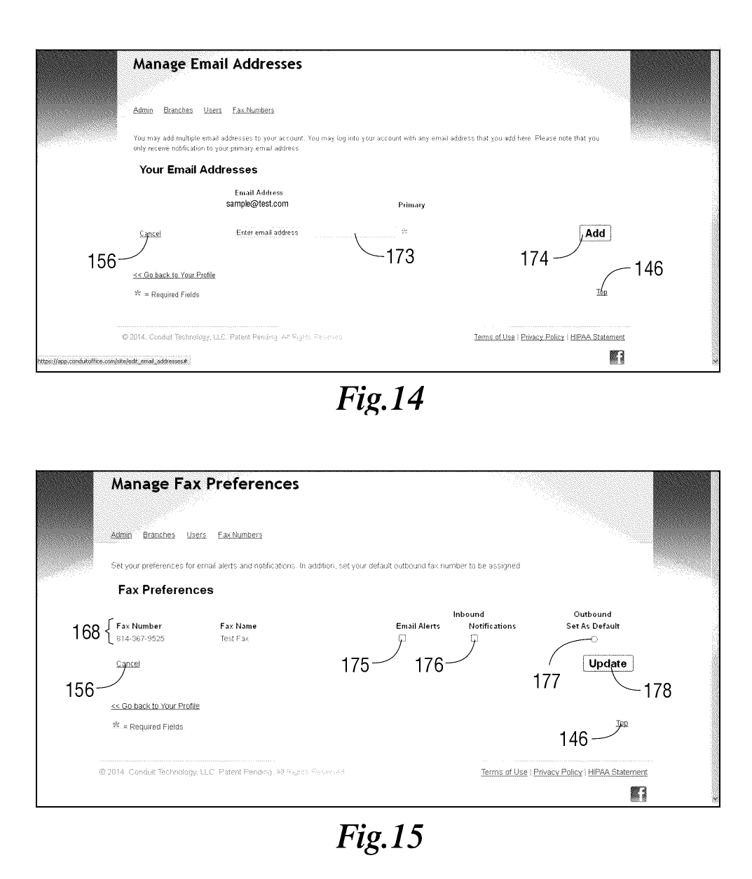

Returning to FIG. 11, selecting the password change option 160 brings up a password modification interface illustrated in FIG. 12. The exemplary interface in FIG. 12 can utilize an updated user password 53 and a password update confirmation indicator 55. Selecting the email address management option 162 in FIG. 11 can bring up the email address management interface in FIGS. 13-14. In FIG. 13, an email address and its type (e.g., primary, secondary, etc.) are displayed, along with options to add one or more additional email addresses 172. FIG. 14 depicts the email address management interface with an additional email address input field 173 associated with the account as well as an email management confirmation indicator 174.

Returning to FIG. 11, selecting the manage fax preferences option 164 brings up the interface depicted in FIG. 15. As part of the listed fax preference information 168, the user can select an option to receive email alerts 175 when a fax is received at the listed fax number. The user can also select an option to receive notifications 176 when a fax is received at the listed fax number. Other embodiments include any other type of alert, including but not limited to text message, internet/IP-based messaging, phone call, pager, etc. Any alert or email based upon a received fax can attach a copy of the received fax, which may optionally include a text version derived from optical character recognition. Embodiments can use image files that contain at least some selectable text within an image file based on optical character recognition. Other options may include compressed and/or thumbnail versions of the received fax, or only a subset of the pages in the received fax. Additionally, the user can designate which fax number is designated as the default outbound fax number 177 when a fax is received at the listed fax number. The fax preference settings can be confirmed with a fax setting confirmation indicator 178.

Returning to FIG. 11, selecting the manage data sources option 166 brings up the manage data sources interface depicted in FIG. 16. BRIGHTREE® or any other suitable data source(s) or external database(s) can be utilized. Here, for example, the user utilizes an enable checkbox 179 to enable access to BRIGHTREE® for external data, along with a username 181 and a password 183 each associated with a BRIGHTREE® account, with some embodiments requiring the user retype these fields to provide confirmation of the input. The manage data sources interface can also utilize an external data source setting confirmation indicator 185. Other embodiments may use any other suitable indicator type to enable access, or none at all. Still other embodiments may not require authentication into an external data source or external database, or may store such required data within the user's instant account described herein.

Returning to FIG. 11, selecting the user management option 182 can bring up the user management interface depicted in FIG. 17. This interface can include user filtering options 186 that allow users to be filtered according to a branch location and/or user status. In some embodiments, user status types can include online, offline, new, deleted, and locked. Each user listed has a user action 188 and a user status 190, wherein the user action 188 that can correspond to a user's current status 190. For example, a user with an online status 190 may have a user action 188 to edit the user. A user with an offline status 190 can have a user action 188 to either edit or remove the user. A user with a status 190 of deleted can have a user action 188 of restore. A user with a status 188 of locked can have a user action 190 of unlock. In some embodiments, any field in a table of results can serve as a basis for sorting records in the table, wherein one criterion (such as name 102 or email address 50) can serve as the basis of the sorting, wherein the sorting order can be reversed each time the criterion is reselected. This can also include the option to have sorting by any number of any number of fields (1, 2 . . . n) utilized as sorting criteria, such that records in a table could be first sorted by name 102, then by email address 50, and so on, according to any other fields in the table.

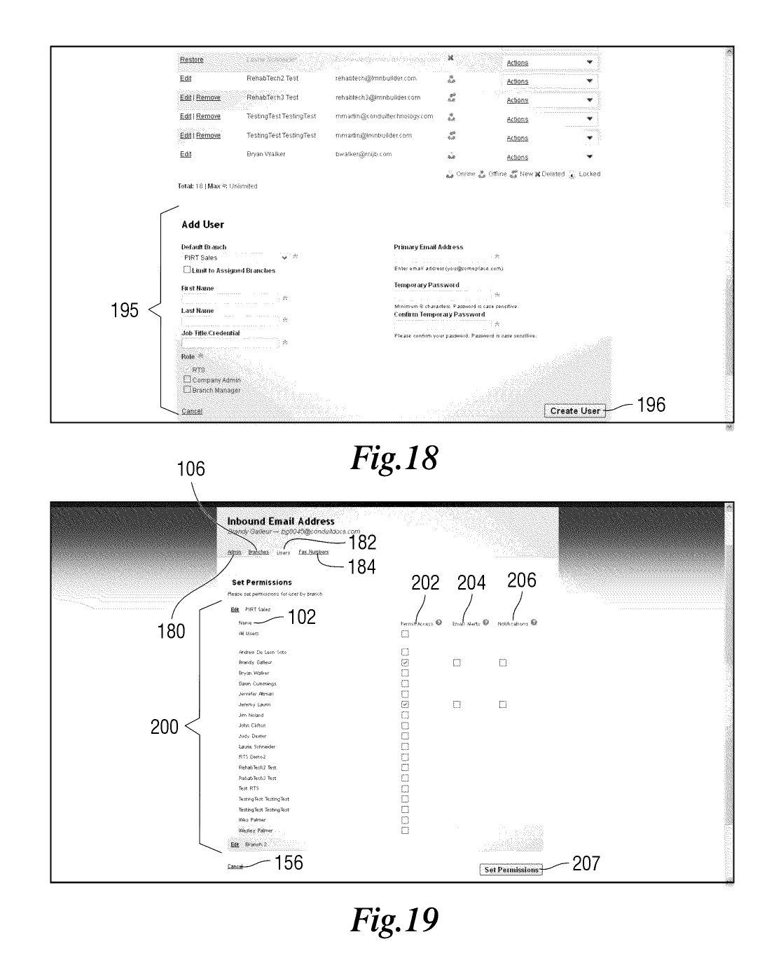

Each user can also be displayed by their name 102 and/or email address 50. Each user also can also have a menu of user actions 192, which may include, for example, resetting the user's password 197, logging the user off 104, setting branch user permissions 198, and disabling the user's account 199. There is also an option to add a new user 194. FIG. 18 depicts an add new user interface 195 and a new user confirmation indicator 196. Returning to FIG. 17, selecting the set branch user permissions option 198 can bring up the branch user permissions interface depicted in FIG. 19. For each branch, such as the ‘PIRT Sales’ branch, each user's name 102 can be listed, along with options associated with the branch to permit access 202 for the user to branch emails, to allow the user to receive email alerts 204, and to allow the user to receive notifications 206 of branch emails. In some embodiments, denying access 202 to a user can preclude options to permit the user access to email alerts 204 and/or notifications 206. The branch user permissions interface can also utilize a set permissions confirmation indicator 207.

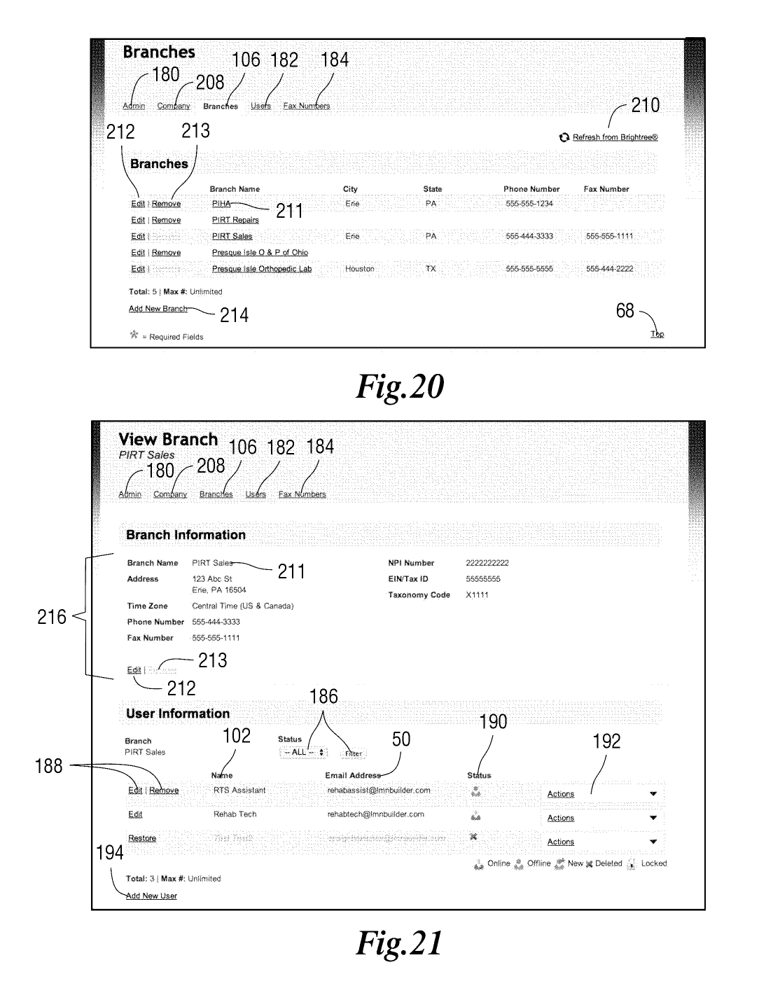

In some embodiments, the branch administration option 106 can be selected at any time to bring up the branch management interface depicted in FIG. 20. Some interfaces, such as FIG. 20, can include menu options such as the admin option 180, company option 208, branch administration option 106, user management option 182, and fax number management option 184. A listing of branches which can be associated with a particular company's account is displayed. Such a listing can be refreshed at any time from BRIGHTREE® or any other suitable external data source or external database. Any interface described herein can utilize a suitable external data source or external database to import/refresh data. Embodiments can utilize any suitable data migration/facilitation technique, such as ETL (Extract-Transform-Load′), which can be utilized to facilitate data between any databases and/or data sources. For example, data can be extracted from a BRIGHTREE® database, transformed from any form utilized in the BRIGHTREE® database into any format utilized by any destination database utilized by any embodiment described herein, and then loaded into the destination database. ETL can utilize data from any number of databases and/or data sources, implementations of which can be. for example, relational, object-oriented, schema-based (e.g., star, snowflake. OLAP-cube), unstructured, etc. Embodiments can utilize parallel processing with ETL. with types including data parallel processing, component parallel processing (running multiple threads/processes), and pipelining (running a plurality of components with respect to a data stream). Some embodiments can have a virtual ETL implementation, which can utilize metadata for abstract object representation.

Each branch listing has branch options to edit 212 or remove 213 the branch from the listing. Each listing also displays the branch name 211, city, state, phone number, and fax number, although any other known information can also be displayed. There is also an option to add a new branch 214.

Selecting a branch name 211 in FIG. 20 can bring up branch information as depicted in 216 of FIG. 21. Selecting the branch edit option 212 in FIG. 20 or 21 can bring up editable versions similar to the branch information fields 216 in FIG. 21. The branch removal option 213 may be unavailable for some branches. In FIG. 20, selecting an option to add a new branch 214 can also bring up editable versions similarly to the branch information fields 216 in FIG. 21. FIG. 21 also includes a branch user management interface similar to FIG. 17, except the users are already filtered according to the instant branch.

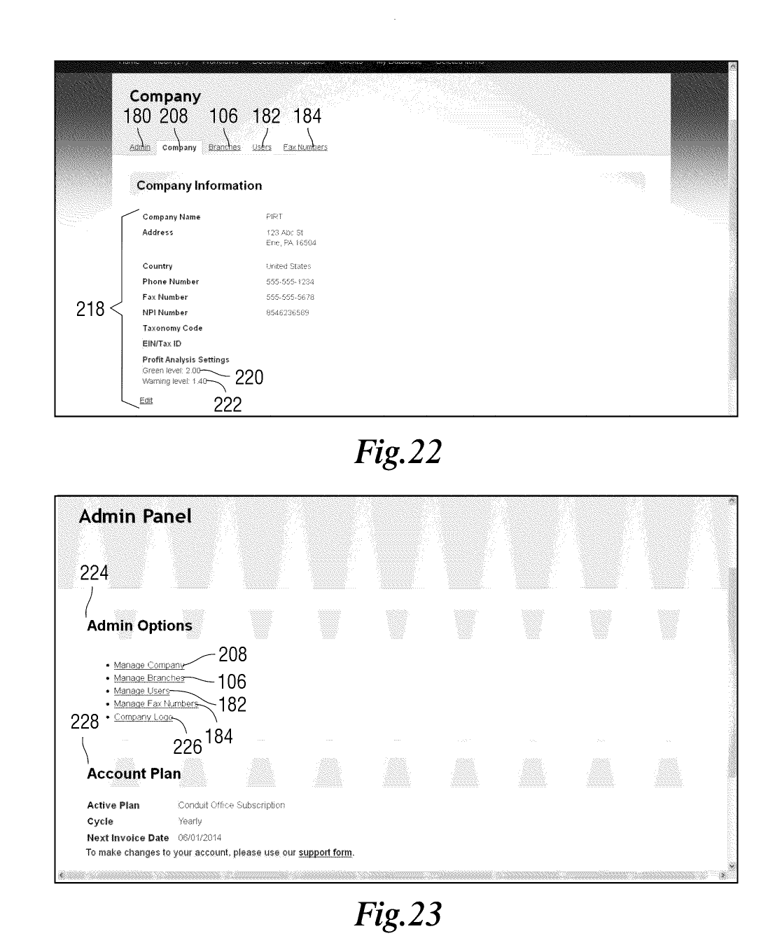

By selecting the company options 208 in an interface such as that depicted in FIG. 20, the company management interface depicted in FIG. 22 can be utilized. The company information 218 includes Profit Analysis Settings, which can include a desirable (e.g., green) level profit index 220 and a minimum threshold for a warning-level (e.g., yellow) profit index 222. By selecting to edit the company information, all company information 218, including the desirable (e.g., green) level profit index 220 and a minimum threshold for a warning-level (e.g., yellow) profit index 222, are modifiable.

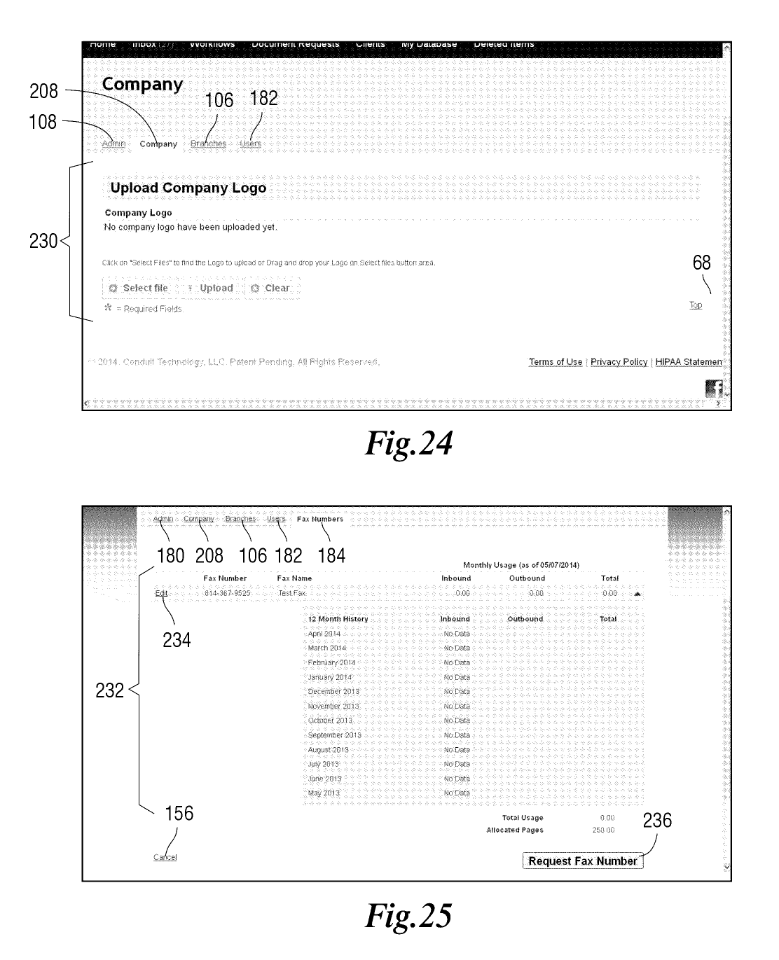

By selecting the admin option 180 in an interface as depicted in FIG. 22, an admin panel is presented as shown in FIG. 23 with an admin options menu 224 and account plan details 228. The admin options menu 224 can include the company option 208, the branch administration option 106, the user management option 182, the fax number management option 184, and a company logo management option 226. Selecting the company logo management option 226 can bring up the logo management interface depicted in FIG. 24. The logo management options 230 allow an image to be uploaded or imported through drag-and-drop or any other suitable interface.

Returning to FIG. 11, selecting the fax number management option 184 can produce the fax number management interface depicted in FIG. 25. This interface can display fax data 232 containing a record for each fax number listed that includes the fax number, a fax name, inbound monthly usage, outbound monthly usage, and a total (inbound and outbound) monthly usage. The term usage as related to a fax number can relate to any suitably measurable quantity, such as time usage, cost usage (in any currency/denomination), or page count, for example. The interface can also display a fax history for any fax number, such as the 12-month history depicted. Total usage and page allocations can also be displayed. A new fax number request 236 can be submitted that can integrate the fax number into all fax functionality described herein.

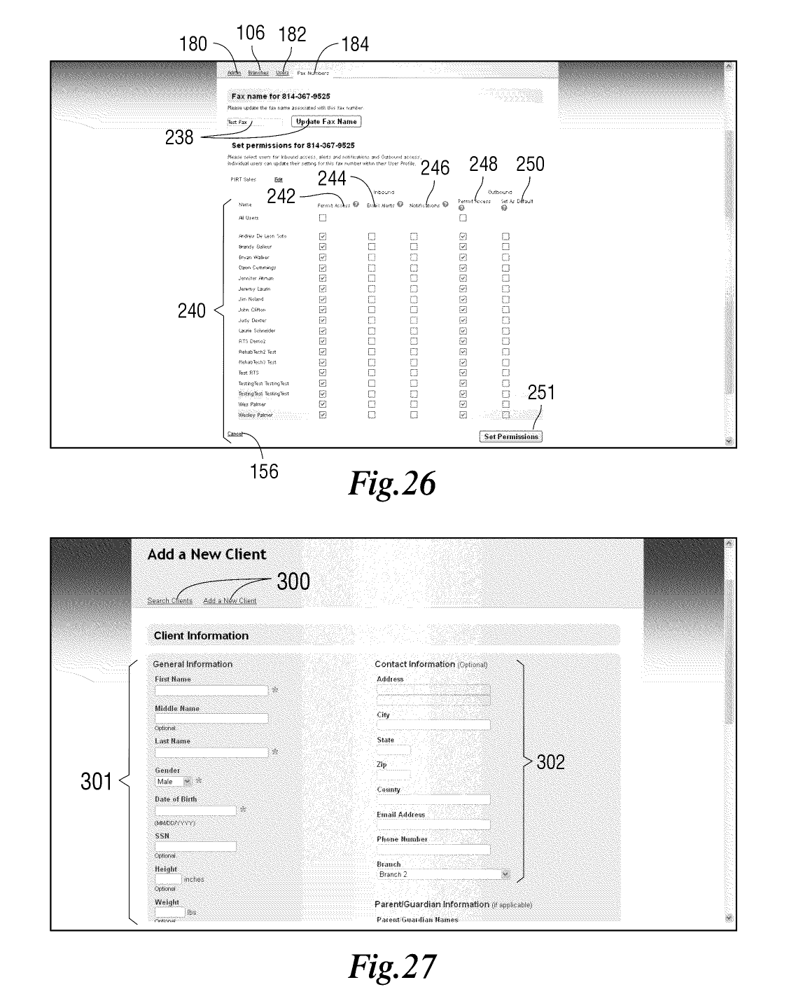

A fax edit option 234 can bring up the fax number permissions management interface depicted in FIG. 26. In this interface, there is an option to update the fax name 238 associated with the fax number. Further, fax permissions 240 associated with users at a given branch or company can be edited. Fax permissions 240 can include permitting access for a user to the branch's inbound faxes 242, which allows the user to optionally receive email alerts 244 and/or user notifications 246 when a fax has been sent to the fax number. Fax permissions 240 can further include outbound fax options, which include outbound faxing access 248 that permits the user to send faxes using the fax number and a set-as-default option 250 which sets the fax number as the user's default for outgoing faxes. The fax number permissions management interface can also utilize a fax options permission confirmation indicator 251.

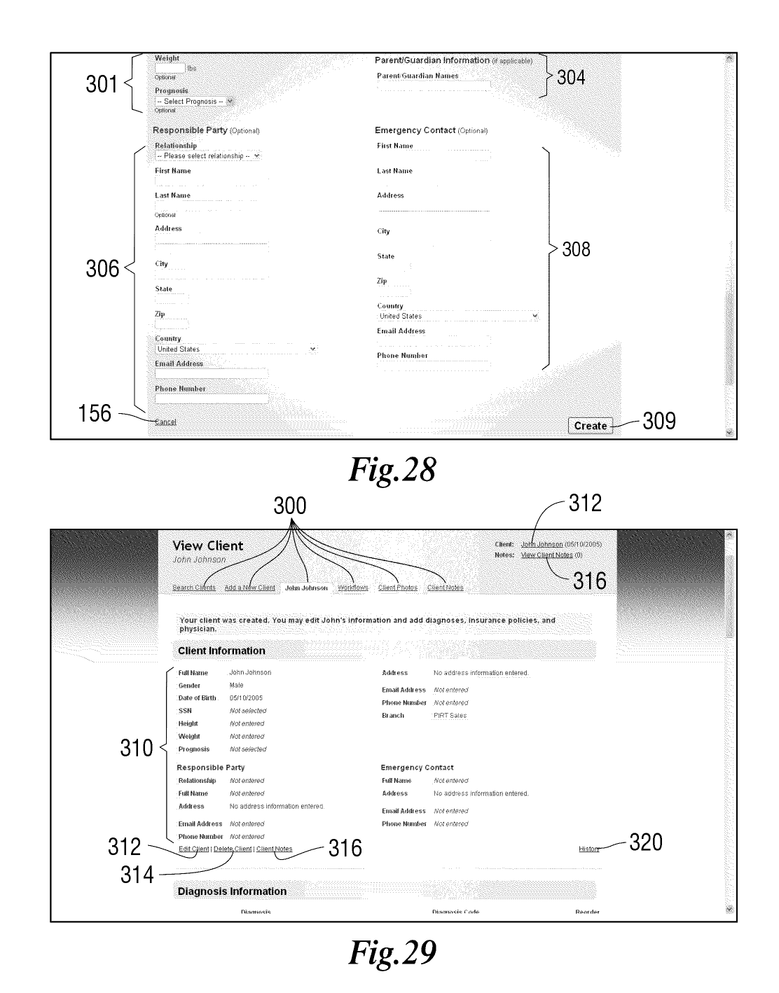

Returning to FIG. 8, selecting the option to create a new client 142 can bring up the add client interface depicted in FIGS. 27-28 or any other suitable interface to receive client data, wherein some or all fields can be required. The add client interface depicted in FIGS. 27-28 may include client interface options 300 such as searching clients, adding a new client (presently depicted), and other options depicted below (for example, the client's name, workflows associated with the client, client photos, and client notes). In FIG. 27, client information 301 can be entered, such as client biographical and physical information. The add client interface can further utilize client contact information 302, including the branch with which the client is associated. In FIG. 28 the interface can utilize optional parent/guardian contact information 304 (such as name(s)), responsible party contact information 306 (such as relationship to client, first name, last name, address, and contact information), and emergency contact information 308 (such as relationship to client, first name, last name, address, and contact information), although other embodiments can make such information mandatory. The add client interface can further utilize a new client confirmation indicator 309.

FIG. 29 shows a client information interface that, in some embodiments, creates objects that can be associated with a new workflow. Client information 310 can be displayed, corresponding to client-related data 300, 302, 304, 306, and 308 that what was previously entered in FIGS. 27-28. The client information interface can present an option to edit the client 312, which may present a client information interface similar to that discussed above with respect to FIGS. 27-28. The client information interface in FIG. 29 can also present an option to delete the client 314, which may result in a deletion confirmation being present prior to deletion of client information.

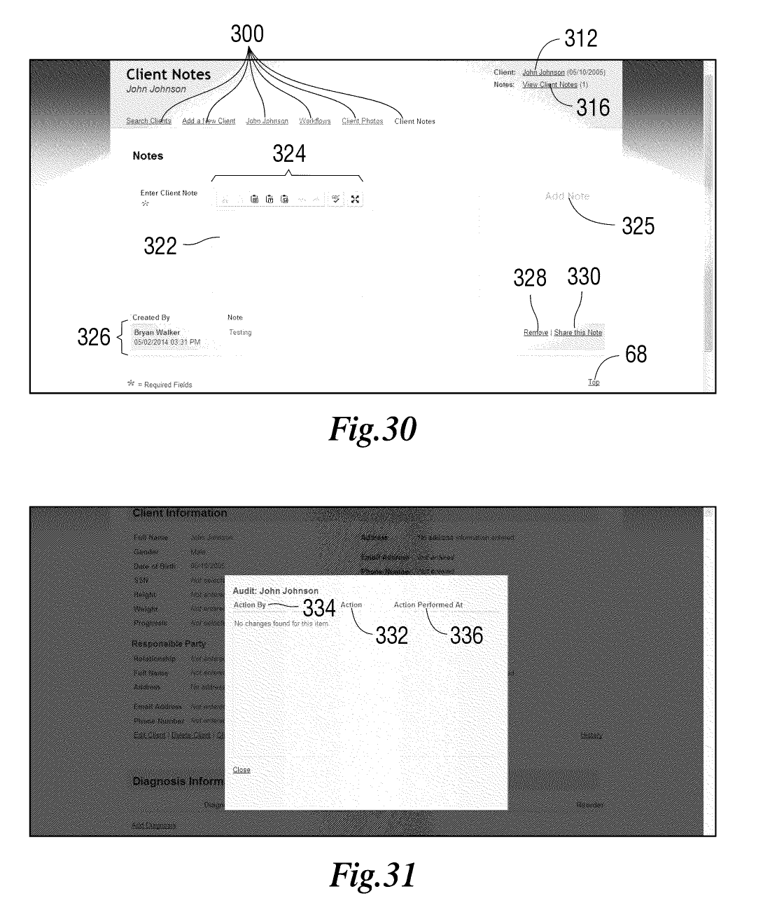

The client information interface can also present an option to view notes associated with the client 316, which can bring up a client notes interface as illustrated in FIG. 30. The client notes interface contains a client note field 322, which in some embodiments can be a text field. In other embodiments, the client note field 322 can be a customized comment field, as will be discussed below. Any interface described herein can present any number of text editing options 324 for any textual field disclosed throughout. Text editing options 324 can be presented as icons or as any other type of suitable selectable options, and can include, for example: cut, copy, paste, paste as plain text, text color, text size, subscript, superscript, paste from another program such as WORD®, font, special characters, paste with source formatting, paste with destination formatting, paste with mixed formatting, undo, redo, spell-check (occurs upon user request), bold, italicize, underline, strike-through, highlighting, bullet-points, line spacing, text justification/alignment, text tables, and/or text field size modification. In some embodiments, such as disclosed in text editing options 422 of FIGS. 39-41, a real-time spell-check feature 424 can be utilized.

The client notes interface can also display notes previously created regarding the client 326. Each note has options to be removed 328 and to be shared 330. Some embodiments permit such sharing to include any other user, whereas other embodiments can restrict sharing by any appropriate criteria, such as (by way of non-limiting examples) user accounts associated with the client, user account type, or office branch. The client notes interface can also utilize an add note confirmation indicator 325.

Returning to FIG. 29, the client information interface further provides an option to view an audit history 320 related to the client. FIG. 31 shows an exemplary client audit interface, which can display, for example, information relating to the instant client's information regarding the actions performed 332, who performed the action 334, and when the action was performed 336.

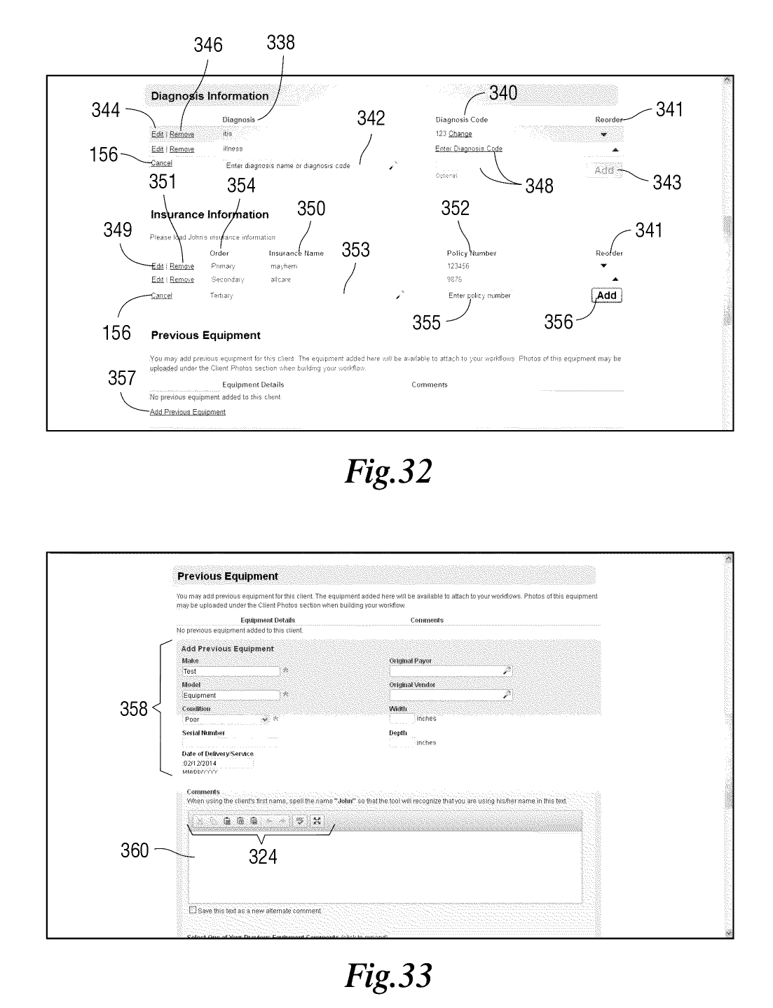

The client information interface of FIG. 29 continues in FIG. 32 with client diagnosis information, which can be utilized to create diagnosis objects associated with the current workflow. Client diagnosis information can be updated at any time. Client diagnosis records can include a diagnosis name 338 and an optional diagnosis code 340 and a diagnosis code input field 348, although some embodiments may have a mandatory diagnosis code. A diagnosis record, once completed, can be added 343. Additional diagnoses can be added through a diagnosis search field 342 where any appropriate information can be utilized, such as a diagnosis name or code. Any interface described herein that displays multiple records can utilize reorder options 341, which can utilize arrows to move an individual record up or down, as well as being draggable, wherein a user can drag-and-drop a record to another position within a listing of records. Any other type of reordering interface can be utilized. Any multi-record interface herein, such as client diagnosis information, can utilize options for each record to edit 344 the record, remove 346 the record, and to cancel 156 the creation of a new record.

The client information interface in FIG. 32 further utilizes client insurance information, which can be utilized to create workflow objects related to insurance. The insurance information can include the insurance provider's name 350, the policy number 352, and the insurance order 354 (primary, secondary, tertiary, etc.). In some embodiments, modifying the order changes which insurance provider is considered primary, for example, so that the “top” insurance provider in the listing is always the primary provider, and the affected insurance records are updated automatically. In other embodiments, such automatic updating does not occur. Any input field herein, such as the policy number 352, can be restricted by data type (character, integer, etc.), a specified length or range, complexity, or any other suitable field definition properties. An insurance record can be edited 349 and deleted 351. Insurance providers are searchable in an insurance name search field 353. A corresponding insurance policy number can be added in a policy number input field 355. An insurance record, once completed, can be added 356.

FIG. 32 continues with information regarding the client's previous equipment, which can be utilized to create workflow objects related to equipment. As illustrated, there is an option to add previous equipment 357. FIG. 33 provides a previous equipment interface. Previous equipment data 358 can be entered, which can include, for example, the equipment's make, model, condition, serial number, date of delivery/service, original payor, original vendor, width, and depth. Any unit of measurement described herein can be of any appropriate unit type of measurement, such as metric or English units of measure. Additionally, the user can be presented with a comment text field 360 to create a customized comment field.

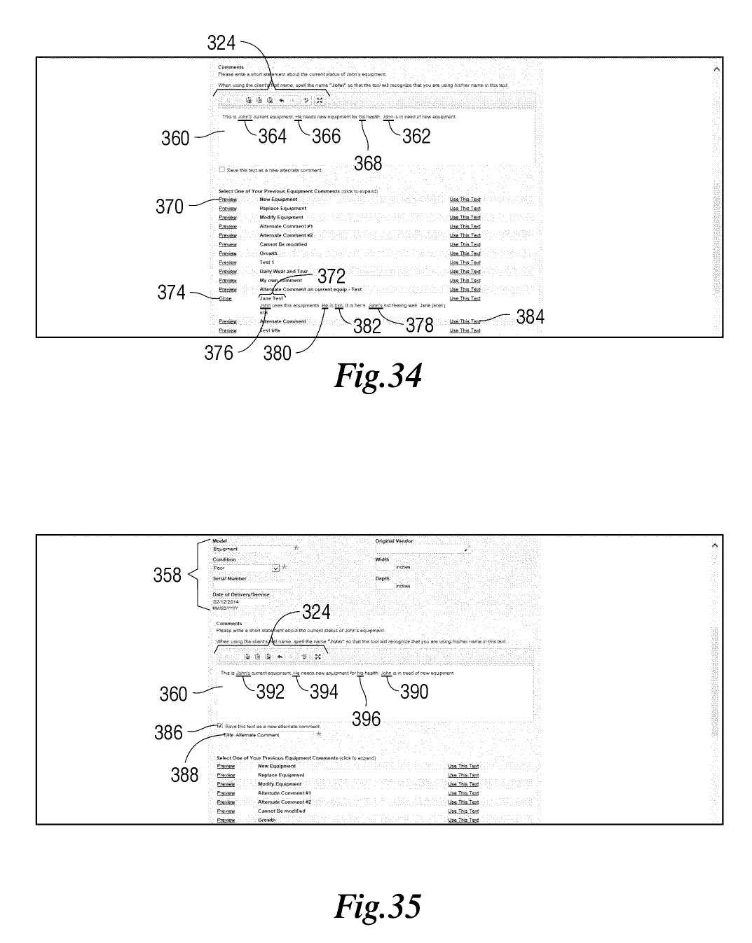

FIG. 34 depicts a comment field 360 containing textual input from a user. Text entered into the comment field 360 can be parsed in real-time, periodically, or based upon input received from the user to indicate that the text is ready to be parsed and/or saved. Parsing is performed when creating a template version of the text within the comment text field 360. Parsing comment field text involves identifying, for example, instances of the client name 362 that match what was previously entered by the user as previously shown in 310 of FIG. 29, or as identified by the user through a search of existing client records 122, as previously shown in FIG. 9. Returning to FIG. 34, the client's name ‘John’ 362 has been entered by the user within the comment field text 360. Based upon the stored client name, each instance of the client's name 362 within the comment field text 360 is automatically replaced with a name placeholder (not shown).

Any type of placeholder described herein can be either visible or invisible to users. In this embodiment, the text is not visibly modified to display or indicate any type of placeholder, but such visibility can be utilized in other embodiments. In this embodiment, each instance of the client's first name is replaced with a name placeholder denoting that the client's first name was utilized within a particular location within the body of text as entered by the user. In some embodiments, each instance of a possessive version of the client's first name 364 can also be replaced with a possessive name placeholder denoting that a possessive version of the client's first name was utilized in a particular location within the comment field text 360. As an illustration, within the comment text field 360 in FIG. 16, the user has entered a possessive version 364 of the client's name, here ‘John's.’ A possessive placeholder can be utilized regardless of whether the possessive version of a name is possessive or a contraction of the client name combined with ‘is.’

With respect to name placeholders and/or possessive name placeholders as described herein, such placeholders are utilized for instances of the client's first name and/or possessive instances of the client's first name. In other embodiments, with respect to name placeholders and/or possessive name placeholders, any combination(s) of first, middle, and/or last name(s), along with prefix(es), suffix(es), and/or title can be utilized and analyzed for any parsing, analysis, and/or text replacement features described herein. The utilization of a name placeholder and/or possessive name placeholder can be either case-sensitive or non-case-sensitive.

With respect to this embodiment, parsing the comment field text 360 can further involve identifying instances of pronouns 366 and 368 that match the stored client gender, either as previously entered by the user as previously shown in 310 of FIG. 29, or as identified by the user through a search of existing client records 122, as previously shown in FIG. 9. Based upon the stored client gender, pronouns 366 and 368 that corresponds to the client's gender, within the user's text in the comment field 360, can also be replaced with a placeholder (not shown). In other embodiments, placeholders can also be applied to pronouns 366 and 368 within the comment field text 360, regardless of the gender of the pronoun, wherein a placeholder can be applied by storing the grammatical pronoun type. The utilization of a gender-specific pronoun can be either case-sensitive or non-case-sensitive. In any event, the grammatical pronoun type is also stored within a pronoun placeholder. If a subject pronoun, such as ‘he,’ appears within the comment field text, the placeholder will store the grammatical pronoun type. Any appropriate grammatical pronoun type can be utilized, such as subject pronouns, object pronouns, possessive pronouns, and reflexive pronouns.

If the user selects a preview option 370 to preview template text, the user can view how the template text will appear with the current client's information applied. Here the user has chosen to view the template preview text 372 titled ‘Jane Test,’ which then displays a modified template. At any time the user can choose a ‘close’ option 374 to hide or collapse the preview text. In this embodiment the user can have as many template previews open as desired, although the number of preview templates open simultaneously can be restricted in other embodiments. The template preview text applies the current client's name, possessive name, gender, and grammatical pronoun type to placeholders (not shown) with respect to client name, possessive client name, and pronouns. For example, the first word in this modified template utilizes the current client's name of ‘John’ 376 where a name placeholder had been utilized. The name ‘John’ 376 is displayed in the location within the text where a name placeholder was located. Similarly, this modified template utilizes a possessive form of the client's name, so that ‘John's’ 378 is displayed in the location within the text where a possessive name placeholder was located. The pronouns ‘he’ 380 and ‘him’ 382 are also displayed within this modified template. Here, the client's gender is male, which when combined with a pronoun placeholder designating a subject pronoun, produces the pronoun ‘he’ 380. Similarly, combining a pronoun placeholder designating an object pronoun with the same client's male gender information produces the pronoun ‘him’ 382. In this embodiment the interface presents a ‘Use This Text’ 384 option, which places the textual template in the comment field 360. In some embodiments, multiple textual templates can be placed in the comment field 360 in this way.

In FIG. 35, regardless of whether the user uses template text or writes entirely new text, there is a template save option 386 which can cause a title field 388 to appear, where the user can then input a title for this comment field text 360. In some embodiments, the title field 388 is present regardless of whether the template save option 386 is selected. If the user selects the option to save this comment field text 360 as a template, placeholders (as described above) will be placed in the specific locations of the text they replace, if and/or where appropriate. Here this customized textual comment utilizes the client's name ‘John’ 390, a possessive version of the client's name ‘John's’ 392, a subject pronoun ‘he’ 394, and a possessive pronoun ‘his’ 396.

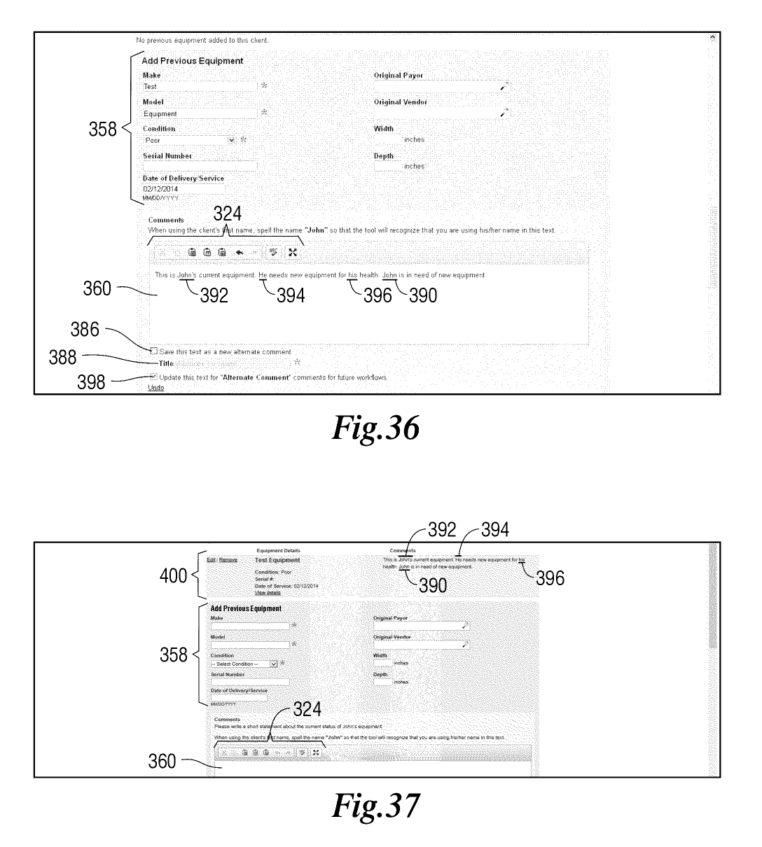

FIG. 36 depicts a comment update option 398 which, in some embodiments, appears in response to selecting the ‘Use This Text’ option 384 discussed above in FIG. 34.

FIG. 37 depicts a completed current equipment item 400 including a customized comment from the user, along with options to edit and remove the client equipment item. Additionally, the comment text has placeholders (not shown) associated with words in the comment text corresponding to elements 390, 392, 394, and 396.

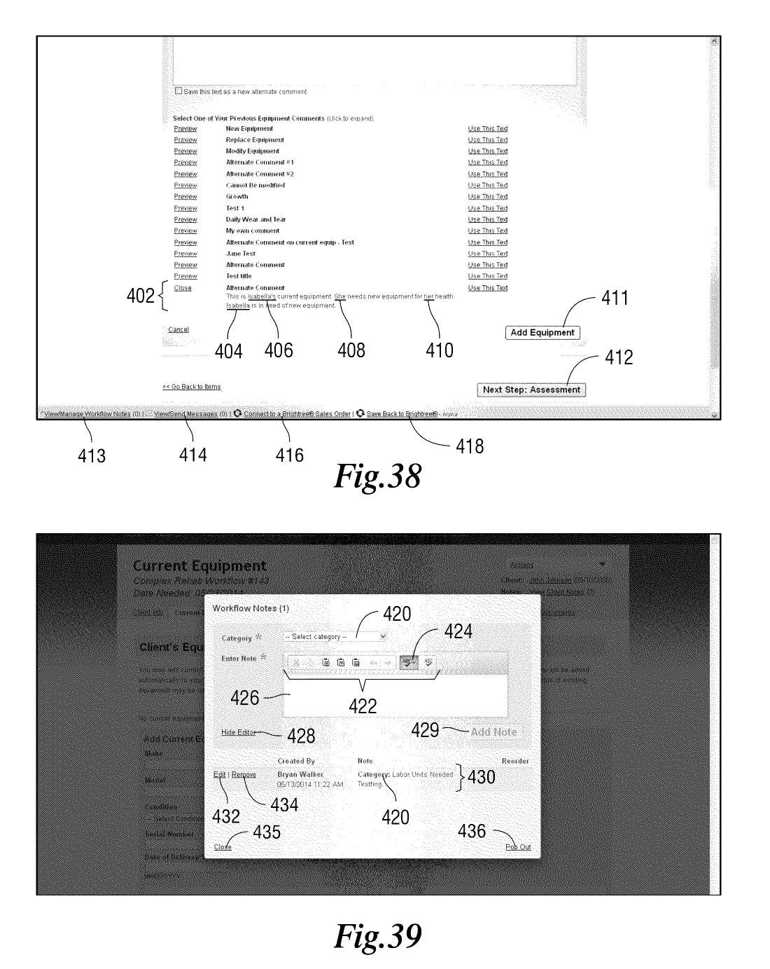

FIG. 38 depicts the comment text that a user previously created in FIGS. 34-36 now being used as a modifiable template 402 for a different client. Instead of being just a static textual comment for client John, here the template is shown being subsequently utilized for another client, Isabella. Here, the client's name, Isabella 404, has been applied to the name placeholder that based on the utilization of John's name 390. This generates Isabella's name 404 in the same location where John's name 390 originally was within the customized template. Similarly, Isabella's name is applied to a possessive name placeholder to generate a possessive version of her name 406 where a possessive version of John's name 392 was originally located. Moreover, Isabella's specified gender, female, is combined with pronoun placeholders in this same modified template. Where the subject pronoun ‘he’ 394 was originally located for John, the pronoun placeholder combines the fact that this was a subject pronoun with Isabella's specified gender to generate a more appropriate object pronoun, ‘she’ 408. Similarly, where the possessive pronoun ‘his’ 396 was originally located for John, the pronoun placeholder combines the fact that this was a possessive pronoun with Isabella's specified gender to generate a more appropriate possessive pronoun, ‘her’ 410. In this embodiment, a user can utilize any template text associate with their user account, regardless of whether the template was based on text utilized for the same client or a different client. Moreover, placeholders can be generated for any type of third-person pronouns, including possessive pronouns and reflexive pronouns. At any time (in some embodiments) the user can utilize an add equipment indicator 411. Additionally, at any time (in some embodiments), the user can utilize an equipment completion indicator 412 to proceed to another interface, such as the assessment interface discussed below.

FIG. 38 also provides options to view/manage workflow notes 413, view/send message 414, connect to a BRIGHTREE® sales order 416, and save back to BRIGHTREE® 418. Any interface described herein can provide these options, and in some embodiments that can be selected at any time. Selecting view/manage workflow notes 412 can bring up a workflow notes interface such as depicted in FIG. 39. To add a workflow note, a user can select a workflow note category 420 as well as enter text into a text field 426, which can be a customized comment field as described above. There can be options to hide the editor 428 and to add the note 429 to the workflow. Text can be modified using text editing options 422, which is another embodiment of the text editing options 324 discussed above. Here, there is an additional real-time spell-check option 424 that can utilized, although any other text editing options embodiment can it as well. Some embodiments of the workflow notes interface display previously-entered workflow notes 430, with options to edit 432 or delete 434 a workflow note. Options are also available to ‘Pop Out’ 436 of the current window and to close 435 the current window.

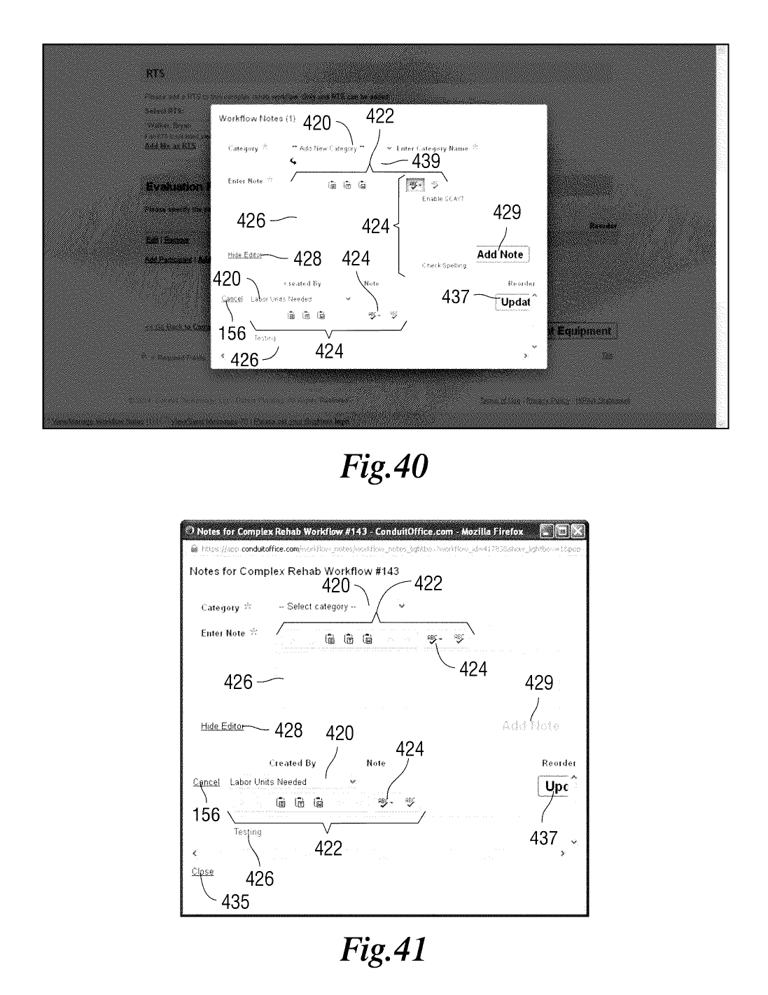

FIG. 40 depicts options from FIG. 39 having been selected. Selecting certain categories for the workflow note category 420 can trigger an additional category field 422 to enter or select a new or different type of workflow category. In some embodiments, the additional category field 422 may always be present, and may not be an option in other embodiments. In some embodiments, selecting the real-time spell-check option 424 in FIG. 39 can bring up a menu of spell-check options, which are readily known in the art and do not warrant further discussion. Selecting to edit 432 a workflow note in FIG. 39 can open the note to editing as depicted in the bottom of FIG. 40, wherein the editing of the pre-existing workflow note can utilize its own editable workflow note category 420 field, text editing options 422 that can include a realtime spell-check option 424, and an editable text field 426 (that can be a customized comment field in some embodiments). In some embodiments, the user can update the workflow note 437 at any time, whereas other embodiments may require criteria be satisfied prior to being able to update this text.

FIG. 41 depicts the result of selecting the ‘Pop Out’ 436 option in FIG. 39. This option can open the current interface screen in a separate window, while the previous interface screen remains open in the original window.

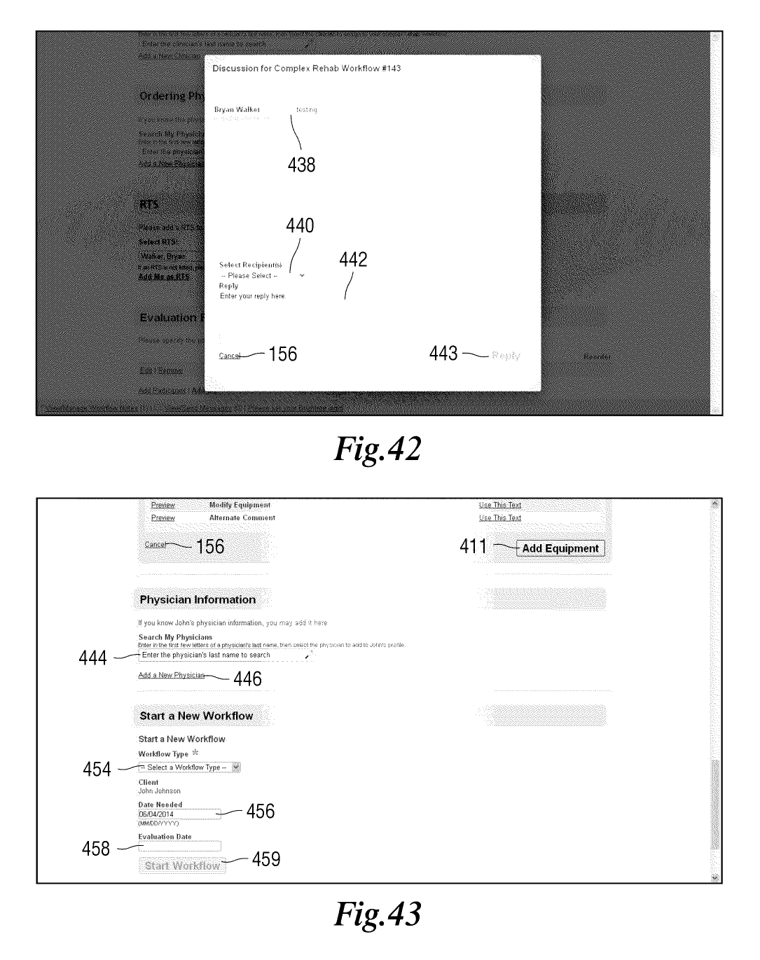

Returning to FIG. 38, a user can select an option to view/send workflow messages 414, which can bring up a workflow messaging interface as depicted in FIG. 42. Options can include viewing workflow messages 438 and composing a new workflow message comprising selecting one or more recipients 440 and drafting a message 442 in a text field. In some embodiments, the message field 442 can be a customized comment field, as described above. In some embodiments, there is a reply indicator 443 utilized to send the message 442 to the specified recipient(s) 440.

Returning to FIG. 38, a user can connect to a sales order 416 from BRIGHTREE® or any other suitable data sources or external databases, which may require separate authentication. This can pull or import any suitable data into the current (or any designated) workflow. Additionally, a user can save (or export) workflow data 416, for example workflow object data, into BRIGHTREE® or any other suitable data sources or external databases.

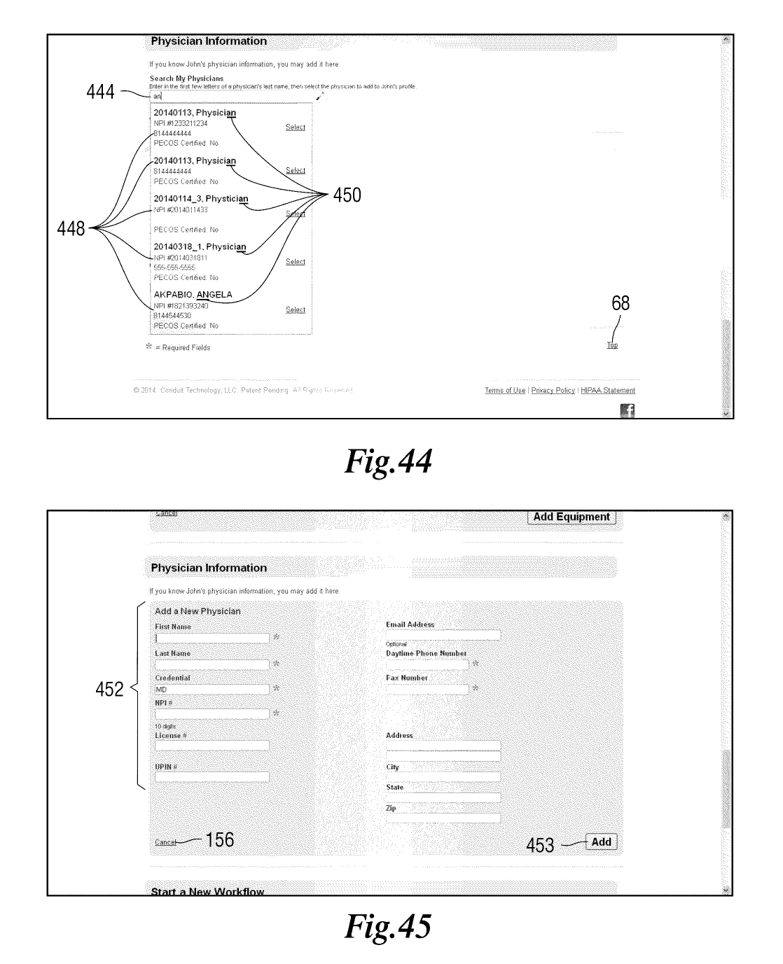

Continuing with the exemplary interface depicted in FIG. 38, FIG. 43 provides options to search for a physician 444 and/or add a new physician 446. By searching for a physician in the physician search field 444 in FIG. 44, some embodiments may present suggested search results of known physician records 448. For example, by entering the search string ‘an’ into the physician search field 444, each result can differentiate the string ‘an’ within the name of each physician by way displaying the string ‘an’ as a different font color than the rest of the physician's name 450. Here, the physician in the last record 448 has the name ‘ANGELA.’ The first two letters AN′ are displayed in a different font color than the remaining (non-matching) letters ‘GELA.’ Other embodiments may utilize other suitable techniques for textual differentiation, such as bolding, underlining, italicizing, etc. Here, the search results are updated in realtime as search input is modified. Some embodiments may only update their search results based upon an input indicating that new results are desired.

Returning to FIG. 43, a user can also add a physician record 446. FIG. 45 depicts an exemplary interface for adding physician information 452, including (but not limited to) name, credential, NPI number, license number, UPIN number, phone/fax number(s), email address(es), and mailing address(es). An add physician indicator 453 can also be presented.

Returning to FIG. 43, a user can also start a new workflow. A workflow type 454 is selected. Workflow types can include, for example, a basic order, a complex rehab workflow, and a general document workflow, with other workflow types being possible as well. A workflow deadline date 456 and a client evaluation date 458 can also both be entered, in some embodiments, along with a start workflow option 459.

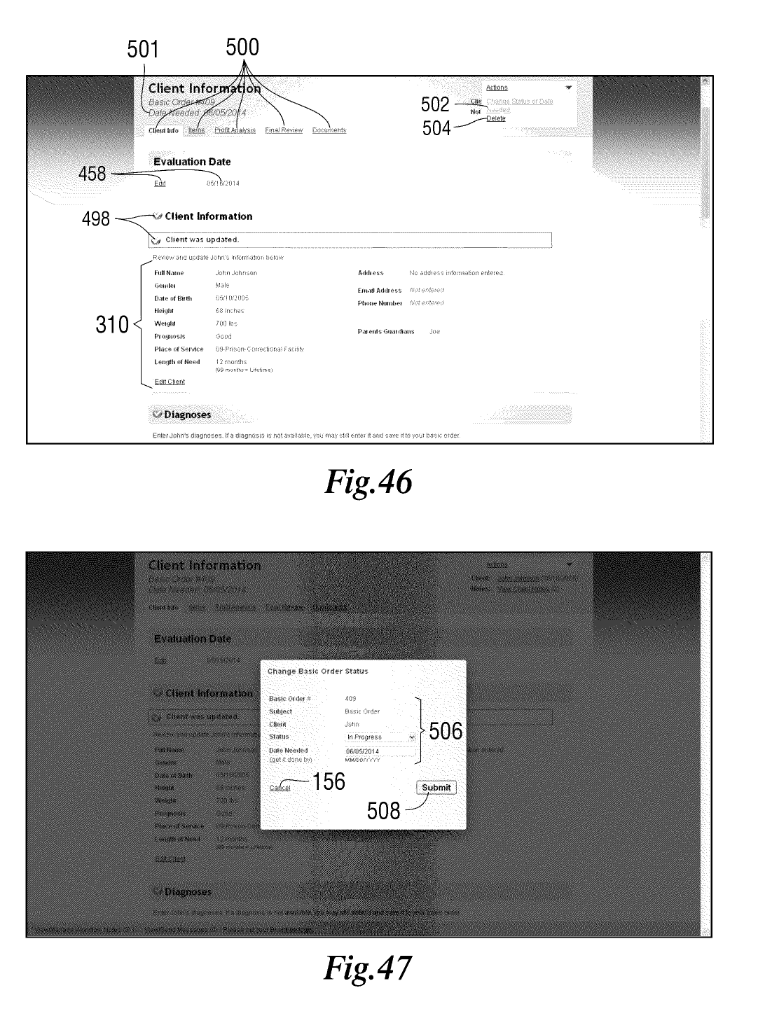

FIG. 46 depicts an exemplary workflow creation interface. Workflow interface options 500 can include, for example, accessing client info, items, profit analysis, final review, and documents, each having its own interface to be discussed in detail below. Workflow interface options 500 can be implemented utilizing hyperlinks or any access mechanism. A deadline date 501 can be displayed, along with a notice (such as ‘overdue’) when the deadline date has been exceeded. Some embodiments can have various notifications (regarding an approaching deadline and/or an exceeded deadline), along with user-definable notifications and notification threshold values. Workflow actions can include changing the workflow status or date needed 502 as well as an option to delete the current workflow 504. Selecting the option to change the workflow status or date needed 502 can bring up an interface such as what is shown in FIG. 47. Here, a user can view workflow information 506 which may include an order number, client name (any suitable client identifier), a modifiable workflow status (e.g., in progress, completed, cancelled), and a modifiable date needed (get-it-done-by date). The user can also utilize workflow information update indicator 508.

Returning to FIG. 46, the exemplary workflow creation interface can include an editable evaluation date 458 and editable client information 310. Various data described herein can be derived from previously entered or retrieved data (whether from an internal or external database/data source). For example, the evaluation date 458 depicted here utilizes the evaluation date entry previously received and discussed above with respect to FIG. 43. Likewise, the client information 310 in FIG. 46 utilizes the client information previously discussed above with respect to FIG. 29, which itself was previously entered in 301, 302 of FIG. 27. As utilized throughout, a completion icon (such as a check-mark 498) can indicate that one or more data fields meet one or more requirements placed upon the data they contain. This can be utilized in form validation, for example. Any type of indicator can be utilized to represent a completion icon 498.

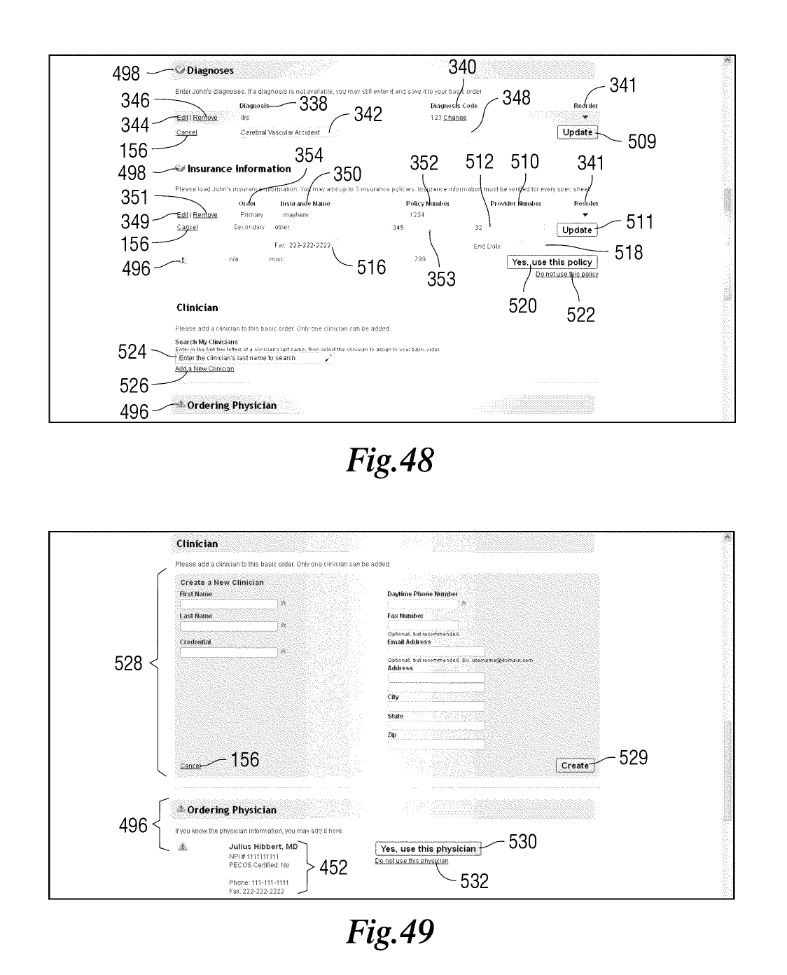

Turning to FIG. 48, editable diagnosis information is utilized that can be based on the diagnosis data previously entered in FIG. 32. Client diagnosis records can include a diagnosis name 338 and an optional diagnosis code 340 and a diagnosis code input field 348, although some embodiments may have a mandatory diagnosis code. Additional diagnoses can be added through a diagnosis search field 342 where any appropriate information can be utilized, such as a diagnosis name or code. Additionally, some embodiments allow new diagnoses can be added (not shown). A diagnosis record update option 509 can be presented for a presently edited diagnosis record. Some embodiments may restrict when the diagnosis record update option 509 is usable.

Editable insurance information is utilized that can be based on the insurance data previously entered in FIG. 32. The insurance information can include the insurance provider's name 350, the policy number 352, the insurance order 354 (primary, secondary, tertiary, etc.), and provider number 510. In some embodiments, modifying the order changes which insurance provider is considered primary, for example, so that the “top” insurance provider in the listing is always the primary provider, and the affected insurance records are updated automatically. In other embodiments, such automatic updating does not occur. Any input field herein, such as the policy number 352, can be restricted by data type (character, integer, etc.), a specified length or range, complexity, or any other suitable field definition properties. An insurance record can be edited 349 and deleted 351. Insurance providers are searchable in an insurance name search field (not shown). A corresponding insurance policy number can be added in a policy number input field 353. Other insurance data can include an insurance fax number 516, an insurance provider number 512, and an insurance end date 518. An insurance record update option 510 can be utilized for a presently edited insurance record. Some embodiments may restrict when the insurance record update option 510 is usable. For any insurance record, there can be options to use the insurance policy 520 or not to use the insurance policy 522. In some embodiments, the user must select to use the insurance policy 520 or not to use the insurance policy 522 to satisfy the criterion associated with an alert indicator 496 (which can utilize any suitable alert or graphical icon). An alert indicator 496 can be utilized throughout to indicate that one or more fields does not meet one or more requirements placed upon the data they contain. This can be utilized in form validation, for example. Any type of indicator can be utilized to represent an alert indicator 496. An insurance record, once completed, can be added 356.

Continuing with FIG. 48, the workflow creation interface can receive input that searches for a clinician 524 as well as adding a new clinician 526. The clinician search option 524 can, in some embodiments, resemble the physician search described above with respect to FIG. 44. If a new clinician is added 526, a clinician creation interface 528 depicted in of FIG. 49 can be utilized, which can include a clinician creation option 529. The clinician creation interface 528 can receive data regarding, for example, a clinician's name(s), credentials, phone number(s), fax number(s), email address(es), and mailing address(es). The workflow creation interface can also provide an interface regarding physician information 452 that could previously have been collected as illustrated above with respect to FIG. 44-45. The physician information interface in FIG. 49 can provide options to use the instant physician 530, or not use the instant physician 532.

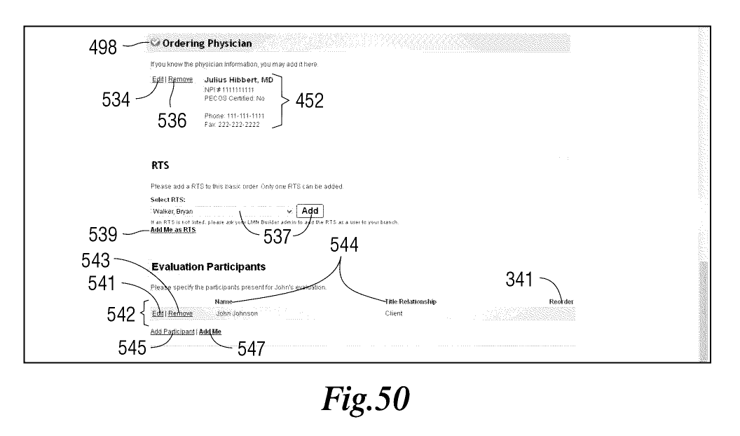

FIG. 50 depicts an example of using the option to use the instant physician 530, wherein physician information 452 is displayed, along with options to edit the physician 534 and delete the physician 536.

Regarding choice of vendor, a user can add a vendor from a list of available vendors 537 or self-select 539 (if they are utilizing a vendor-type account). In other embodiments, the vendor list can be searchable as described above with respect to physicians and clinicians. In some embodiments, the functionality regarding vendors can be attributed to other roles (such as physicians or clinicians) and vice-versa, depending upon the type of account the user is utilizing.

Regarding individuals designated to be client evaluation participants, each participant can be listed as a participant record 542. Participant record fields 544 can include the participant's name, title/relationship to the client, and a reordering option 341 as discussed above, and which can be utilized for any multi-record interface described herein. Each participant record can also have options for editing 541 and deleting 543. Additionally, there can be options to add another evaluation participant 545 as well as the user being able to self-select with an ‘add me’ option 547.

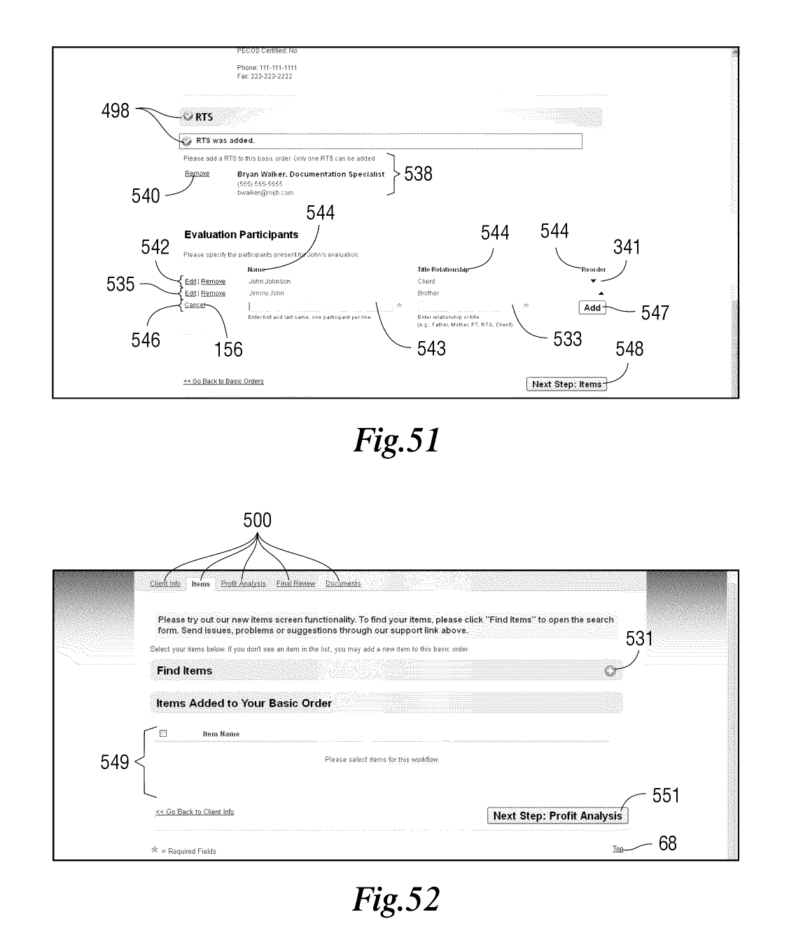

FIG. 51 subsequently depicts the addition of a vendor and an additional evaluation participant. Now that a vendor has been specified by the user (in this example the self-selection option 539 depicted FIG. 50 was utilized), the vendor's information 538 (which is also the instant user) is displayed for review along with a vendor removal option 540. Further, an additional evaluation participant record 535 has been added from FIG. 50. Additionally, FIG. 51 also displays an example of a new evaluation participant record 546 being added in response to the add participant option 545 being selected in FIG. 50. A new evaluation participant record 546 can include fields to enter the participant's name 543 and their title/relationship to the client 533, wherein an option to add the evaluation participant 547 can be available at any time, or in some embodiments, once certain criteria have been satisfied. A currently edited record can be subject to input requirements in order to add the evaluation participant 547. Further, in some embodiments, a client information completion indicator 548 now appears in FIG. 51 once all required fields have been completed, wherein the user can then be directed (for example) to an items interface.

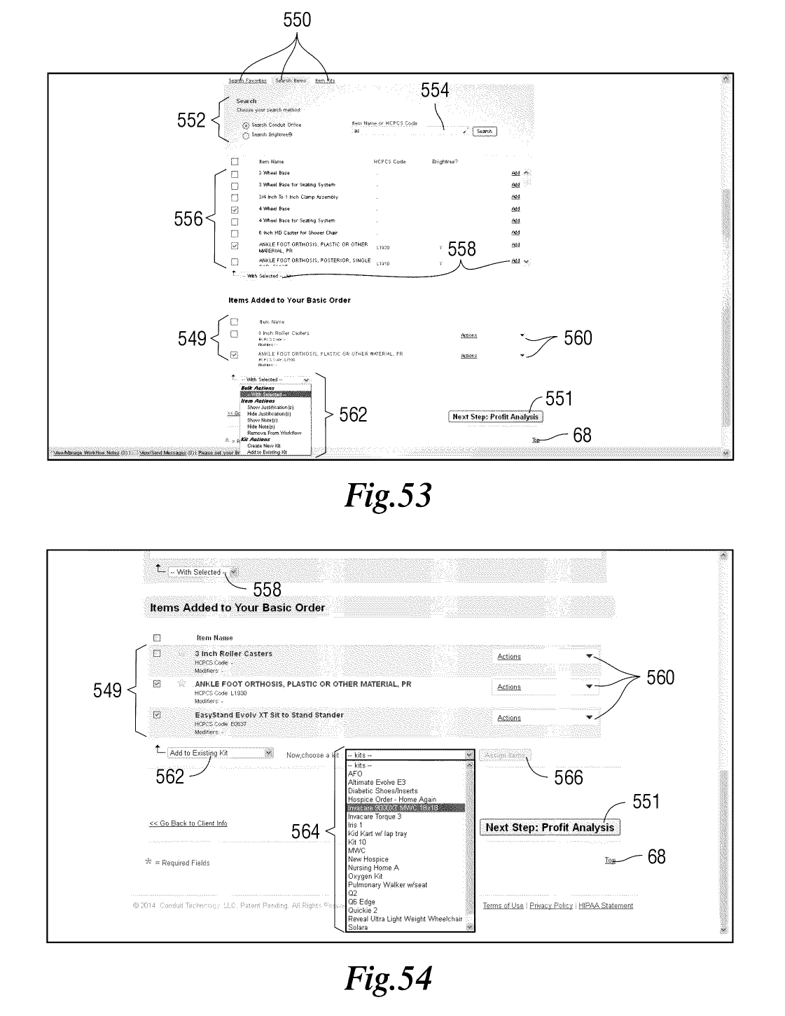

FIG. 52 depicts an example of an item information interface with options to find items 531 and manage added workflow items 549. A user can utilize an item completion indicator 551 to proceed to a profit analysis interface, depicted below in FIG. 54. In some embodiments, utilizing the find items option 531 brings up an item adding interface as illustrated in FIG. 53. The exemplary item adding interface may utilize search type options 550 that can include, for example, search favorites, search items, and/or item kits. Search favorites can be items that were previously indicated as a favorite by one or more users, which may or may not include the same user. Frequency of selection or viewing of items can also form the basis of which items are designated as favorites, although any suitable criteria can be utilized. Item kit search options 550 can be based on, for example, pre-defined or user-defined groupings of items, although any appropriate grouping criterion/criteria can be utilized. Regarding the search item option 550, item search method choices 552 can include searching internal data sources/databases and/or external data sources/databases such as BRIGHTREE®. The search items interface can further receive search item input 554 specifying (at least part of) an item name or code, such as an HCPCS (Healthcare Common Procedure Coding System) code. Item search results 556 can be displayed in any appropriate manner, such as a list of checkable items that display an HCPCS code and an indicator of whether an item is available for importation from an external data source/database such as BRIGHTREE®. Any data listing herein having checkboxes can utilize a check-all/check-none master-type checkbox, located in any appropriate location in its respective interface. Here, each item in the exemplary item search results 556 further includes the ability to add an item 558. In the example depicted in FIG. 53, each item has its own selectable ‘add’ option, along with an add option to add all items that are checked.

Added items 549 can have selectable item actions 560 such as editing and deletion. Each added item can also have an associated checkbox, with a master-type checkbox to select/de-select all added items 549. Added item options 562, which can be applied to those added items that are checked/selected, include item actions and kit actions. Item actions can include (for checked/selected added items) showing/hiding item justification(s), showing/hiding item note(s), and removing the item(s) from the instant workflow, as discussed below.

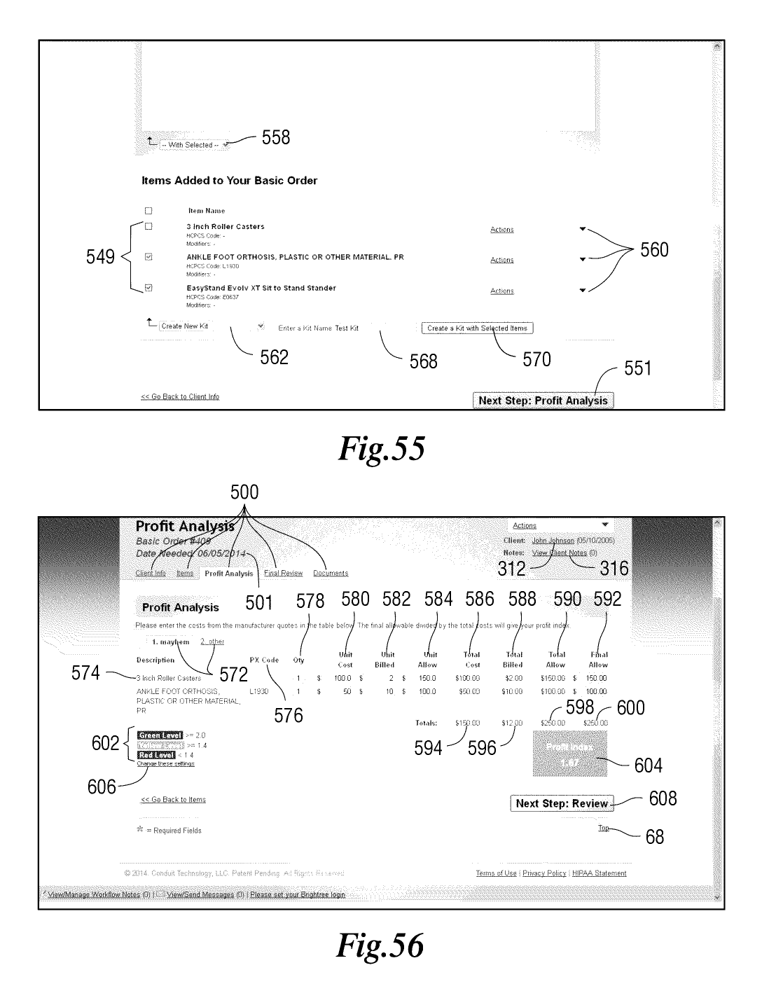

Kit actions can include (for checked/selected added items) adding items to an existing item kit and creating a new item kit. FIG. 54 depicts the selecting of items that were previously added to a workflow 549, where the selected items are designated to be added 562 to an existing item kit 564, here illustrated as a drop-down list of item kits. Other embodiments can use a text search field (as discussed above) or any other suitable search and/or selection interface(s). Once the proper items have been designated for addition to the specified item kit, an item kit assignment indicator 566 can be utilized for confirmation. FIG. 55 depicts the creation of a new item kit 568 based on specified items among items previously added to a workflow 549. Returning to FIG. 53, once items and/or item kits have been indicated, a profit analysis indicator 551 can be selected.

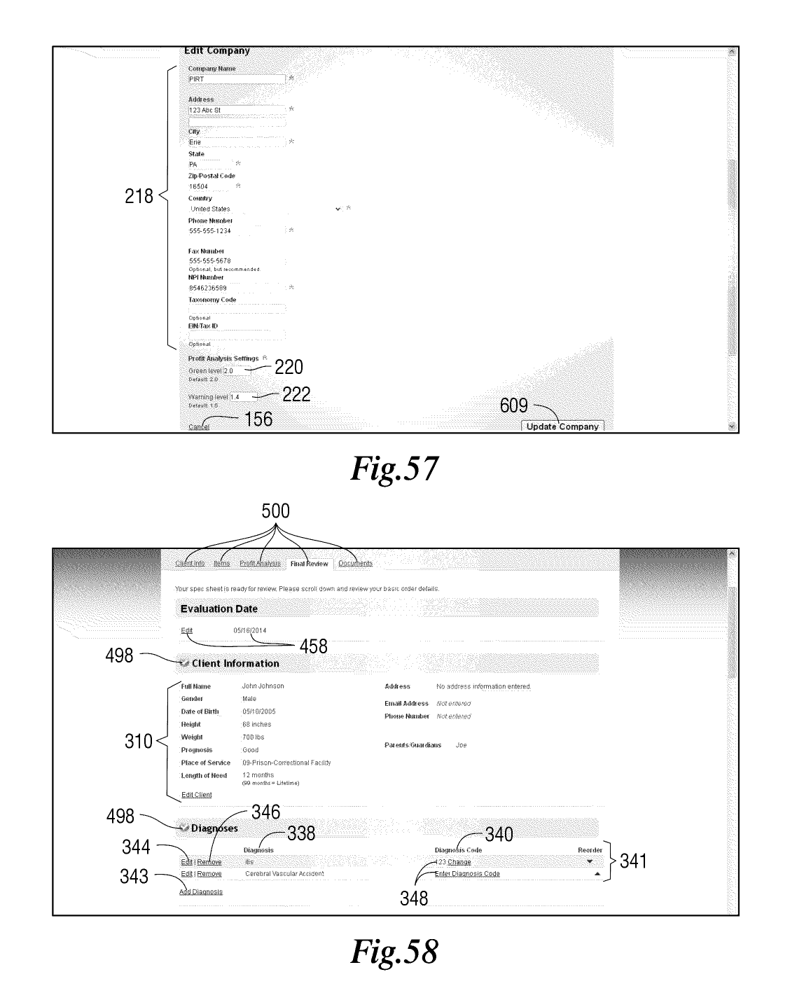

FIG. 56 illustrates an exemplary profit analysis interface. One or more insurance policies/providers 572 can be selected for analysis, here utilizing respective graphical tabs, based on insurance information received in the interface depicted in FIG. 32. Other embodiments can receive insurance input within the exemplary profit analysis interface depicted in FIG. 56. Each item 574 can be analyzed for a given insurance provider/policy 572, with an optional code 576 (such as a PX code or prescription code), an item quantity 578, a unit cost 580, a unit billed amount 582, a unit allowance amount 584, a total cost amount 586, a total billed amount 588, a total allowance amount 590, and/or a final allowance amount 592. Here, the item quantity 578, unit cost 580, unit billed amount 582, unit allowance amount 584, and final allowance amount 592 can be specified. The total cost amount 586 for an item is determined by multiplying the item quantity 578 by the unit cost amount 580. The total billed amount 588 for an item is determined by multiplying the item quantity 578 by the unit billed amount 582. The total allowance amount 590 for an item is determined by multiplying the item quantity 578 by the unit allowance amount 584. A summed cost total 594 is calculated by adding together the total cost amount 586 for each item 574 listed. A summed billed total 596 is calculated by adding together the total billed amount 588 for each item 574 listed. A summed allowance total 598 is calculated by adding together the total allowance amount 590 for each item 574 listed. A summed final allowance total 600 is calculated by adding together the final allowance amount 592 for each item 574 listed. A profit index 604 is calculated as a ratio of the summed cost total 594 to the summed final allowance total 600. As shown, for example, the final allowance total 600 of $250 is divided by the summed cost total 594 of $150 to give a profit index 604 of 1.67. Profit index range thresholds 602 can also be utilized, for example, to make feasibility projections, among other purposes. As illustrated, a desirable profit index 604 could be at a ratio of 2.0 or above, and could be indicated by displaying the profit index 604 as green. A cautionary profit index 604 could be at a ratio of at least 1.4 but less than 2.0, and could be indicated by displaying the profit index 604 as yellow. A warning-level profit index 604 could be at a ratio of less than 1.4, and could be indicated by displaying the profit index 604 as red. Any color, or any other type of indicator, could be used to signify each range threshold 602. Moreover, although three range thresholds 602 are depicted, any quantity of range thresholds 602 can also be utilized. A range threshold modification option 606 can provide an interface as shown in FIG. 57, which can correspond to data in the interface illustrated in FIG. 22. For example, FIG. 57 can present editable company information 218, as well as receive input specifying a minimum threshold for a desirable (e.g., green) level profit index 220 and a minimum threshold for a warning-level (e.g., yellow) profit index 222. Some embodiments can present a default value (as shown), as well as a revert-to-default option (not shown). Completion of the editing in FIG. 57 can be signified with an update company indicator 609, for example. When the profit analysis is complete in FIG. 56, a review indicator 608 can be utilized to conduct a review of workflow data.

FIG. 58 depicts an exemplary interface to review client information and workflow objects. The client evaluation date 458 and an edit option are present, along with editable client information 310 that was previously entered. Additionally, client diagnosis objects can also be presented for review and modification. Client diagnosis records (and thus diagnosis workflow objects) can include a diagnosis name 338 and an optional diagnosis code 340 and a diagnosis code input field 348, although some embodiments may have a mandatory diagnosis code. A diagnosis record, once completed, can be added 343. Additionally, any diagnosis can be edited 344 or removed 346.

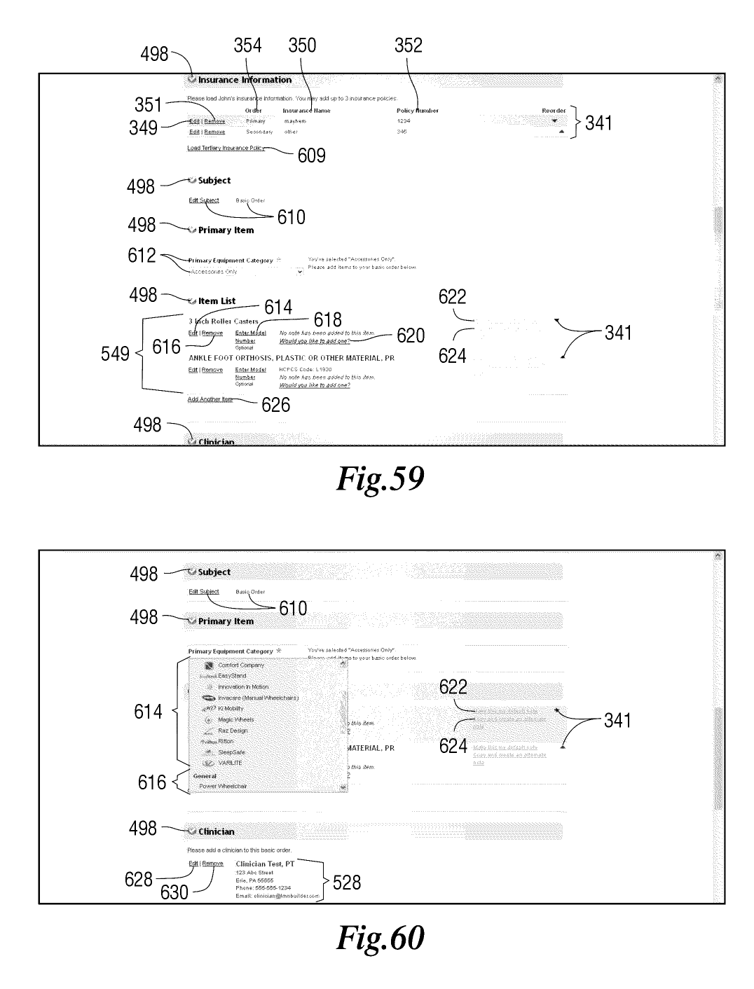

FIG. 59 continues with the exemplary client information interface to review client information and workflow objects. Client insurance information can include the insurance provider's name 350, the policy number 352, and the insurance order 354 (primary, secondary, tertiary, etc.). In some embodiments, modifying the order changes which insurance provider is considered primary. For example, the “top” insurance provider in the listing may always be the primary provider, and the affected insurance records are updated automatically. In other embodiments, such automatic updating does not occur. Any input field herein, such as the policy number 352, can be restricted by data type (character, integer, etc.), a specified length or range, complexity, or any other suitable field definition properties. An insurance record can be edited 349 and deleted 351. There is also an option to add an additional insurance policy 609, for example a tertiary insurance policy as shown.

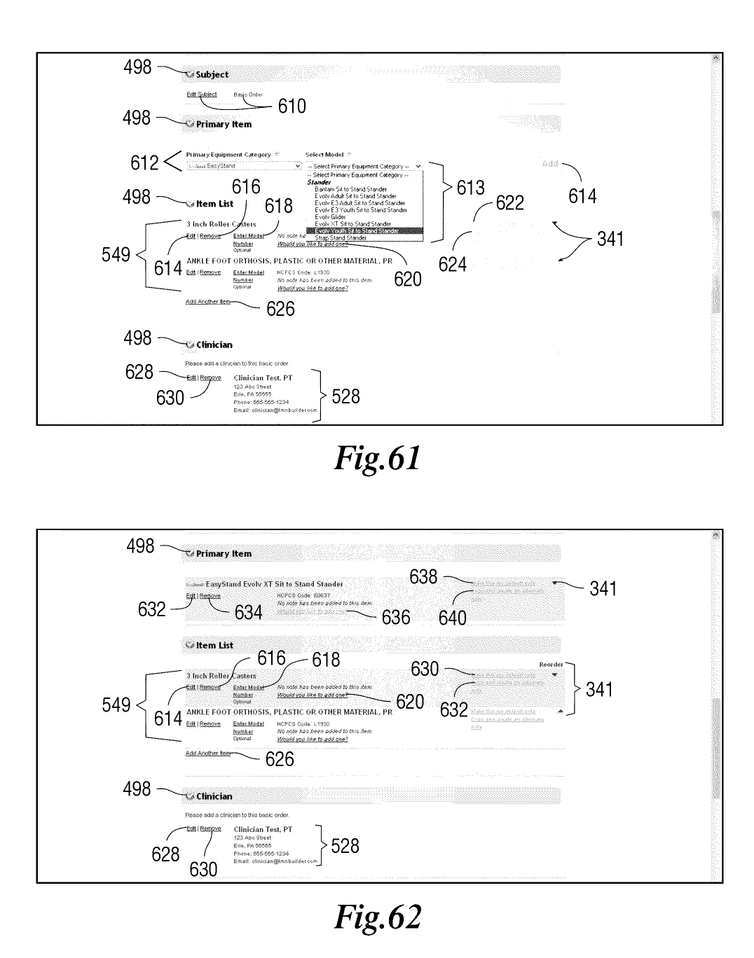

An editable subject 610 can be presented, along with a primary item which may have a primary equipment category 612. FIG. 60 depicts an example of selecting a primary equipment category 614, although a custom-creation primary equipment category option (not shown) is available in some embodiments for a user to create their own primary equipment category. FIG. 61 depicts an example of a primary equipment model selection option 613 in response to a primary equipment category 612 having been selected. A custom-creation primary equipment model option (not shown) is available in some embodiments for a user to create their own primary equipment category. An add primary equipment confirmation option 614 can also be presented upon satisfaction of conditions such as selecting a primary equipment category 612 and a primary equipment model 613. In other embodiments, the option to add primary equipment confirmation 614 can always be available.

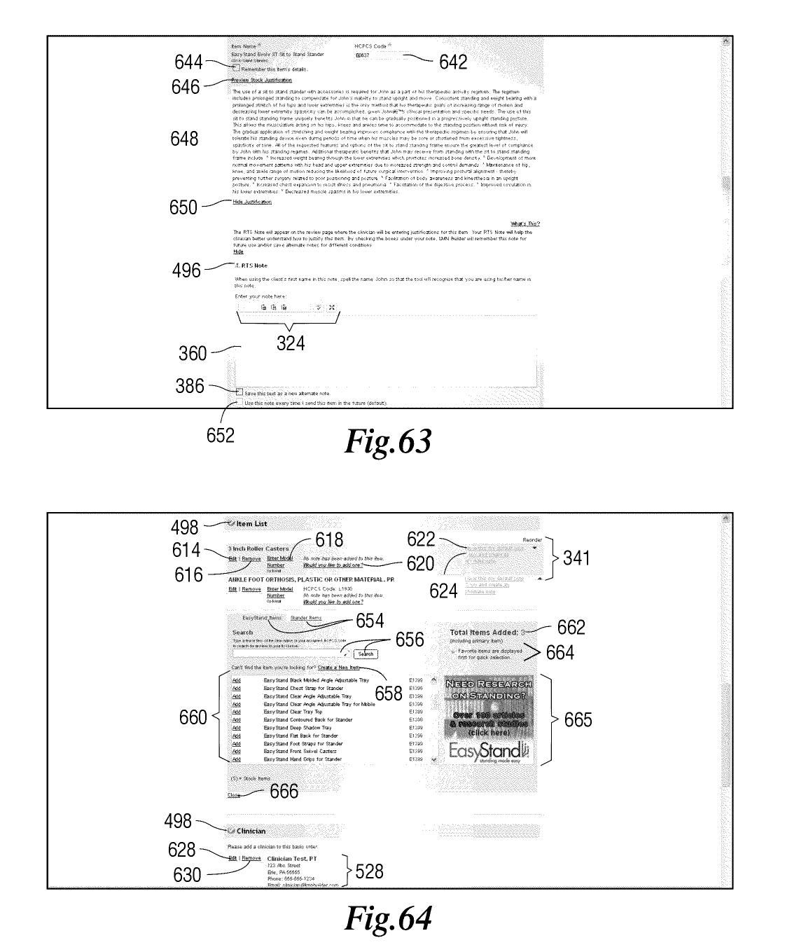

In FIG. 62, a primary equipment item can be presented with options to edit 632 or remove 634 it. A primary equipment note 636 can be added, which can be in the form of a customized comment field, as discussed above in FIGS. 33-38. Accordingly, there are options to make a note the user's default note 638 as well as to copy the note and create an alternate note 640 with the contents. There are also re-ordering options 341 as more than one primary item can be utilized in some embodiments. Utilizing the option to edit a primary item 632 (or other items) can bring up the edit primary equipment interface, an example of which is illustrated in FIG. 63. A code input field 642 can be utilized to receive an HCPCS (or any other appropriate) code. A remember item details option 644 can be utilized, here in the form of a checkbox, although any suitable indicator can be utilized in various embodiments. An option to preview a stock justification 646 can reveal stock justification text 648, which can be specific to the item or utilized for other items as well. A hide option 650 for the stock justification can be utilized as well. An equipment note 360 which utilizes a customized comment field (discussed above with respect to FIGS. 33-38) can be utilized, along with options to its text as a new alternate note 386 as well as an option to designate the instant note by default 652 for the item. Various embodiments may more broadly apply default note options to an equipment brand, or even across all items, for example.

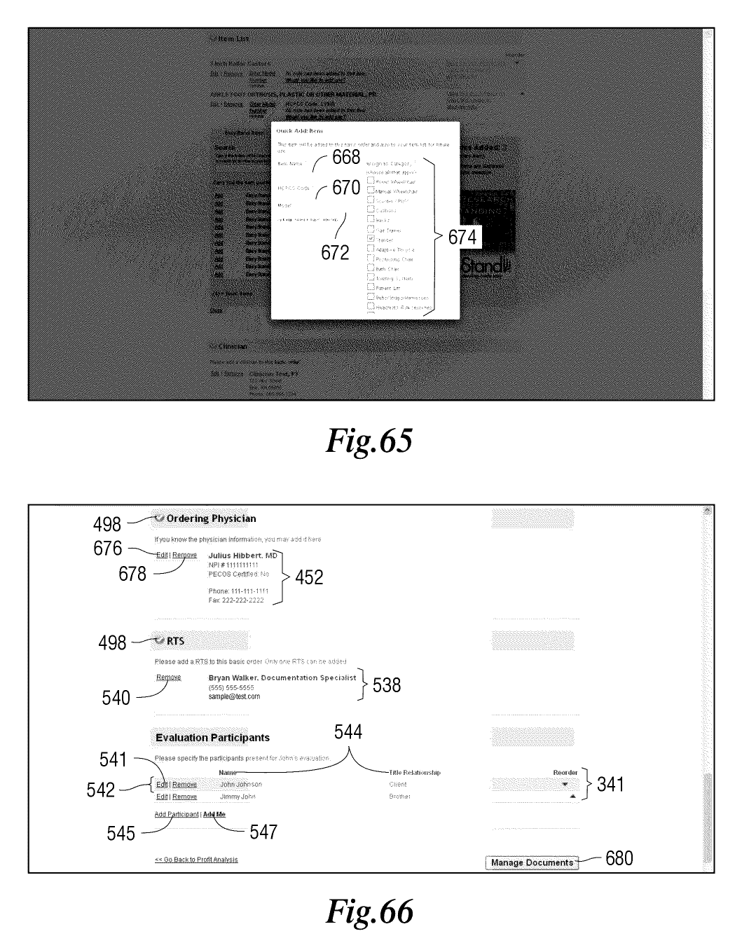

Returning to FIG. 59, an item list can utilize one or more equipment item records 549. Each item record can display an edit option 614 and a delete option 616, as well as either a model number or an option to enter a model number 618. For each item, an item note 620 can be added, which can be in the form of a customized comment field, as discussed above in FIGS. 33-38. Accordingly, there are options to make an item note the user's default note 622 as well as to copy the note and create an alternate item note 624 with the contents. There can also be an option to add another item 626, which can bring up an interface to add another item, an example of which is depicted in FIG. 64. Such an interface can present options to select categories of items according to equipment tabs 654, for example, which can be by equipment brand or equipment type. Any suitable interface can be utilized to group equipment items in this manner. An item search option 656 can be presented, utilizing any search techniques/interfaces presented herein. An option to create a new item 658 can be presented to bring up an interface to quick-add a new item, such as depicted in FIG. 65. This quick-add interface may include, for example, fields for the item's name, item code (such as an HCPCS code), and a model number. Additionally, equipment categories 674 can be presented as checkboxes (or any other suitable input fields) allowing one or more categories to be chosen. Some embodiments can restrict a new item to a single equipment category. Any or all of the quick-add interface fields can be optional or required.

Returning to FIG. 64, the exemplary interface to add an item can further display a listing of items according to a criterion, such as the equipment tab 654 discussed above. A numeric total of items 662 (which includes primary item(s) here, but not in other embodiments) can be presented. Items that have been designated as a favorite 664 can have an indicator, such as a star. In some embodiments, such designation can be exclusive to a particular account or accounts within a company or branch (or other affiliation). In other embodiments, favorites can be designated by any user, with all other users subsequently seeing such designation. All such possibilities can also be utilized to un-designate an item as a favorite as well. An advertisement 665 can be utilized as shown, or utilizing any other suitable technique that is known in the art. Some embodiments may not utilize advertisements. Other embodiments can utilize advertisements anywhere described herein.

Returning to FIG. 60, clinician information 528 can be presented with options to edit the clinician 628 or to delete the clinician 630. Turning to FIG. 66, the exemplary interface to review client information and workflow objects can further include physician data 452, with options to edit 676 or delete 678 the physician. Editing physician information can bring up an interface, such as depicted above in FIG. 45. The instant interface can also present vendor data 538, with an option to remove the vendor 540. Some embodiments may utilize an edit feature, and/or more than one vendor with search and/or sorting options. The instant interface can also provide individuals designated to be client evaluation participants, wherein each participant can be listed as a participant record 542. Participant record fields 544 can include the participant's name, title/relationship to the client, and a reordering option 341 as discussed above, and which can be utilized for any multi-record interface described herein. Each participant record can also have options for editing 541 and deleting 543. Additionally, there can be options to add another evaluation participant 545 as well as the user being able to self-select with an ‘add me’ option 547. There is also an option to complete the exemplary client information interface to review client information and workflow objects 680, which in the instant embodiment is only accessible when specified criteria are satisfied. Other embodiments can permit it to be utilized at any time.

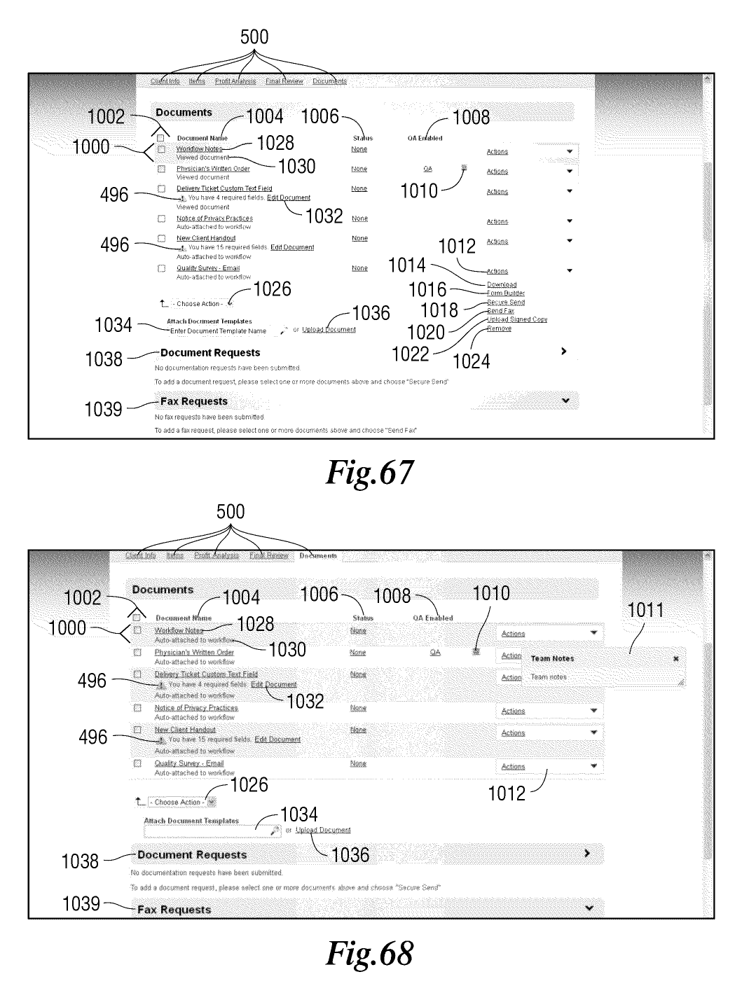

Utilizing the complete final review option 680 can bring up a workflow template management interface, as in the exemplary interface depicted in FIG. 67. Template records 1000 can be presented, with selection options 1002 (such as the exemplary checkboxes) to select some, all, or none of the available template records, along with a master checkbox able to select all/none of the template records 1000. Each template record 1000 may include (for example) a template name 1004, a template status 1006, a QA (quality assurance) option 1008, a team notes indicator 1010, and template actions 1012 (e.g., download 1014, template builder 1016, secure send 1018, send fax 1020, upload signed copy 1022, remove 1024, etc.). A group template action 1026 can provide all or some of the template actions 1012 that can also be utilized with the selection options 1002 to apply a group template action 1026 to each selected template 1002. Each template record may also provide a selectable template name 1028 and a template status indicator 1030. Some templates may have a template edit option 1032, which may be triggered (for example) by required template fields not having been completed, and causing a message stating such.

Templates can also be managed by searching for an existing template 1034 or uploading a document template 1036 utilizing any suitable upload interface and any suitable file type. Template requests 1038 can be displayed based on templates received from a secure send 1018 request. Fax requests 1039 can be displayed based on faxes received from a send fax 1020 request.

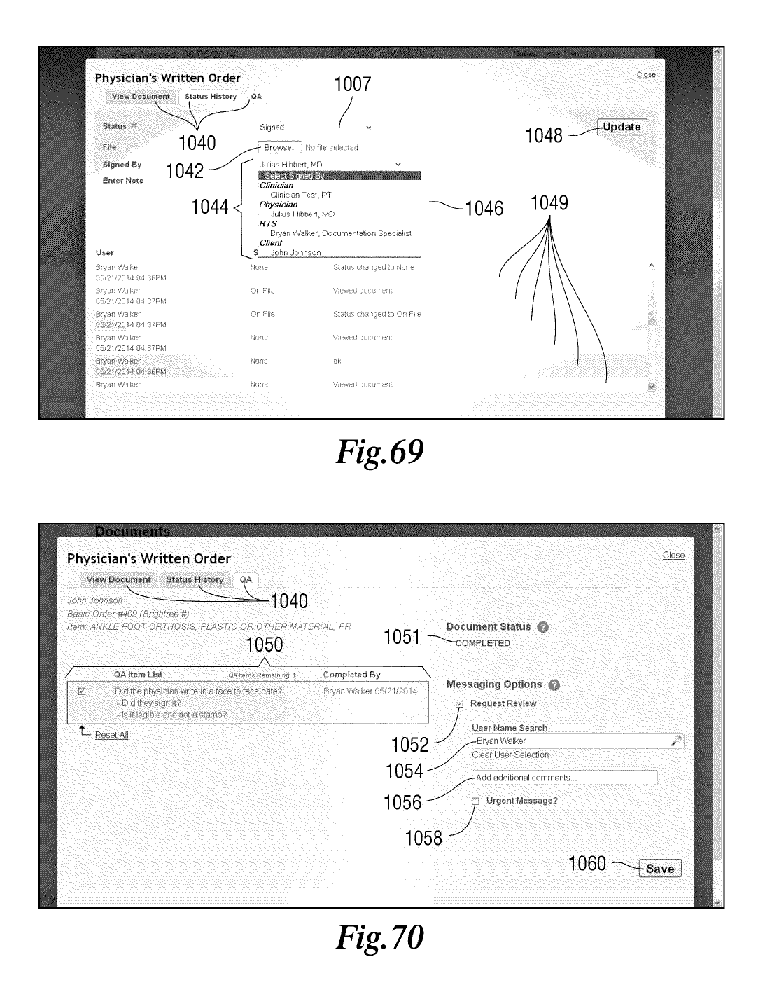

FIG. 68 shows an example of team notes content 1011 in response to receiving a selection of a team notes indicator 1010. By selecting a template's status 1006 in FIGS. 67-68, such as ‘Physician's Written Order’, a status history interface can be presented, as shown in FIG. 69. This interface can have template management tabs 1040 which may include, for example, a view template interface, a template QA interface, and the instant exemplary status history interface. A status history interface can include a status option 1007 (which can include options such as ‘signed’ and ‘recalled’) and a file selection/upload option 1042. A ‘Signed By’ input field 1044 can provide selection (or input) of a user (such as the client, clinician, vendor, or physician) associated with the instant workflow. A template note 1046 may be entered as well, which in some embodiments can be a customized comment field 360. The template's status can be updated 1048, which may result in the updating of status updates 1049 associated with the template.

Selecting the template QA option of the template management tabs 1040 (or the QA option 1008 depicted in FIGS. 67-68) can bring up the QA interface depicted in FIG. 70. The template's QA interface can include a QA item list 1050, which can include a listing of QA items, a quantity of QA items remaining, who completed each QA item listing with a date/time stamp, and an option to reset some/all QA items. A template status indicator 1051 can be utilized (which may correspond in some embodiments to the template status indicator 1006 in FIG. 67). QA messaging options can include a request for review 1052, which may trigger options to specify a user to perform the review 1054 along with comments 1056 (such as further instructions) to the specified user. An option to designate the QA message as urgent 1058 can also be selected, wherein some embodiments can use any number of levels of priority. When ready, a QA save option 1060 can save data in the QA interface.

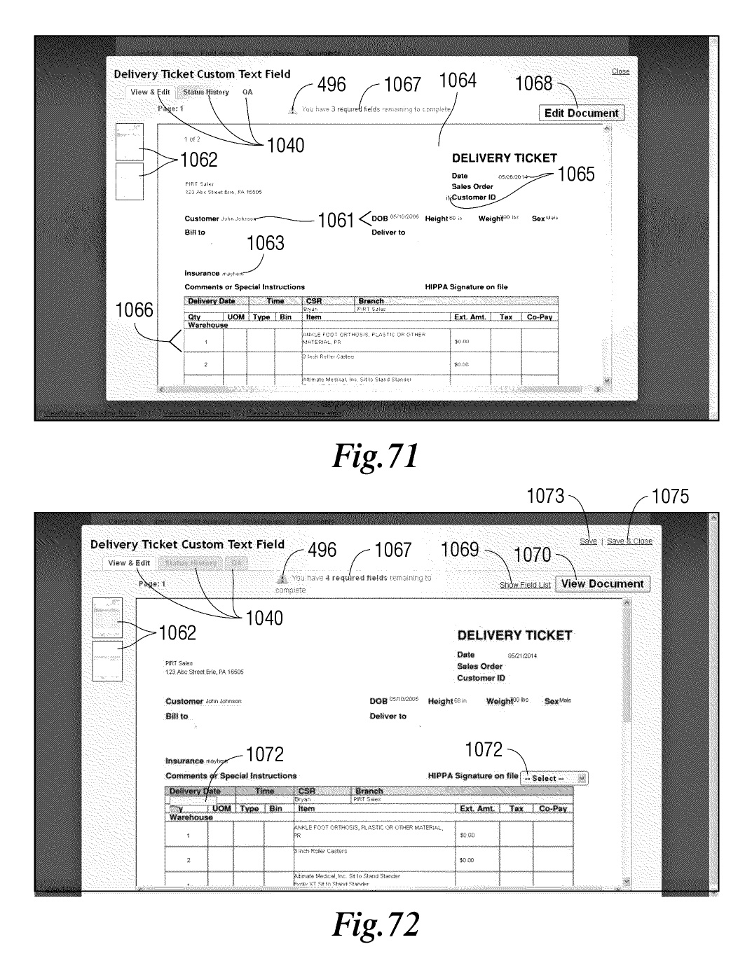

A rendered template preview interface is illustrated in FIG. 71, which can be selected (for example) by choosing the ‘View Document’ in the template management tabs 1040 or selecting a template name 1028 (as depicted in FIGS. 67-68). Here, a different exemplary template (Delivery Ticket Custom Text Field) is utilized. A template thumbnail 1062 for each page can be displayed in any area of the template preview interface, with a larger view of the rendered document 1064 (based on the instant template) that populates the rendered document with workflow object data such as the instant workflow's client information 1061, the instant workflow's insurance information 1063, the instant workflow's diagnosis information 1065 and date information, and the instant workflow's equipment data 1066. An edit template option 1068 can also be presented to bring up a template editing interface. Any field can be encrypted (at any level, including at the application level and/or database level), wherein a field can be decrypted for rendering purposes, while remaining encrypted in the database. Some embodiments can encrypt all fields, with as many levels of encryption as desired.

An exemplary template editing interface is illustrated in FIG. 72, which corresponds to the ‘Delivery Ticket Custom Text Field’ template in FIGS. 67-68 having an ‘Edit Document’ option 1032. Here, there are four required fields awaiting completion, which may trigger a corresponding notice 1067 in the template editing interface. A show/hide field list option 1069 can be selected to show/reveal fields utilized in the template. A view document option 1070 can bring up the rendered document preview interface (previously discussed above for FIG. 71). Required fields 1072 can be displayed on the template (such as a delivery date and specifying whether a HIPPA signature is on file). Required fields 1072 may utilize textual input, selectable options, or any other suitable type of input mechanism. The template editing interface may also have options to save the template 1073 as well as to save and close the template 1075. In some embodiments, an item or group of fields that exceed a rendered page can be rendered across subsequent rendered pages as needed.

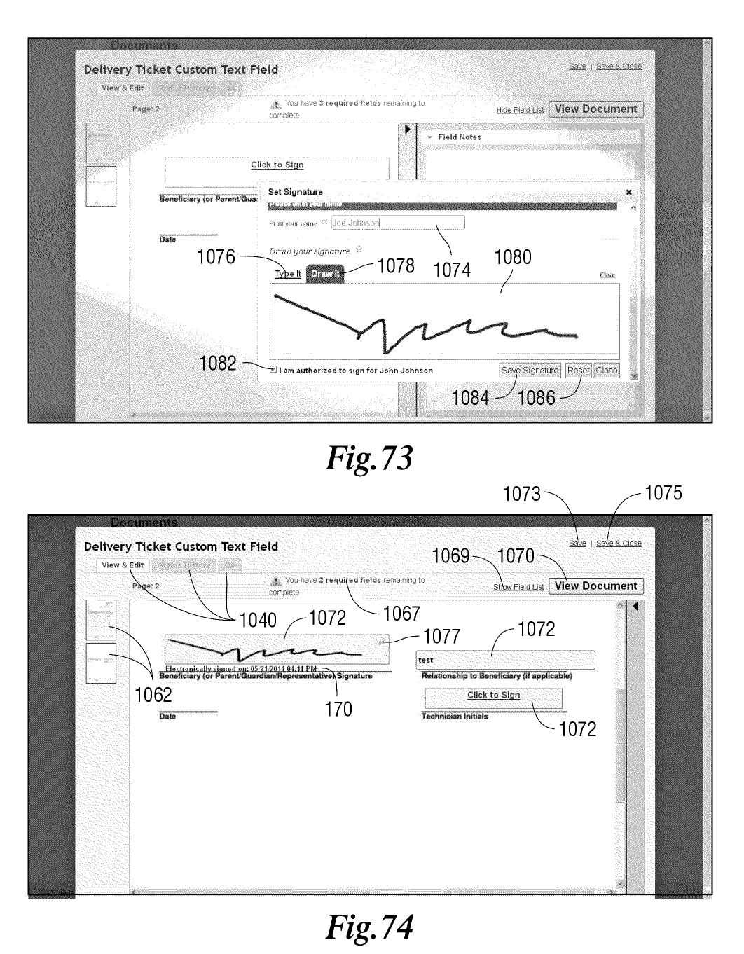

FIG. 73 depicts a signature field from the last page of the ‘Delivery Ticket Custom Text Field’ template, the first page having been discussed above with respect to FIG. 72. Here, this exemplary signature field can utilize a print name field 1074 to receive the name of the signatory, along with options to type a signature 1076 or to draw a signature 1078. In accordance with the signature drawing option 1076, a user can draw or click to generate a signature by any suitable interface, such as with a mouse, a touch-screen, stylus/pen, biometric interface (eye/head/limb/digit movement), etc. If the signatory differs from the client, an authorization option 1082 can be utilized to signify that the signatory is authorized to sign for the client. The signature (in either drawn 1076 or typed 1078 form) can be cleared/reset 1086, as well as be saved 1084 and reused for other forms and/or workflows.

Saving a signature 1084 can result in the signature being displayed in the template editing interface illustrated in FIG. 74. Required fields 1072 can display current values (if any), such as a smaller/preview version of the drawn signature described above in FIG. 73. In some embodiments, an actively-selected field 1072 (which may or may not be required) can display an active field edit option 1077, which can bring up a field edit interface such as described above in FIG. 73. Another required field 1072 in FIG. 74 that has been completed displays the text value ‘test’ and deemed completed. Another required field 1072 displays a default value ‘Click to Sign’ indicating that it is not yet completed, as indicated in the template editing interface notice 1067 that two required field still remain to be completed. Some embodiments can tally required fields per template and/or per page in a template.

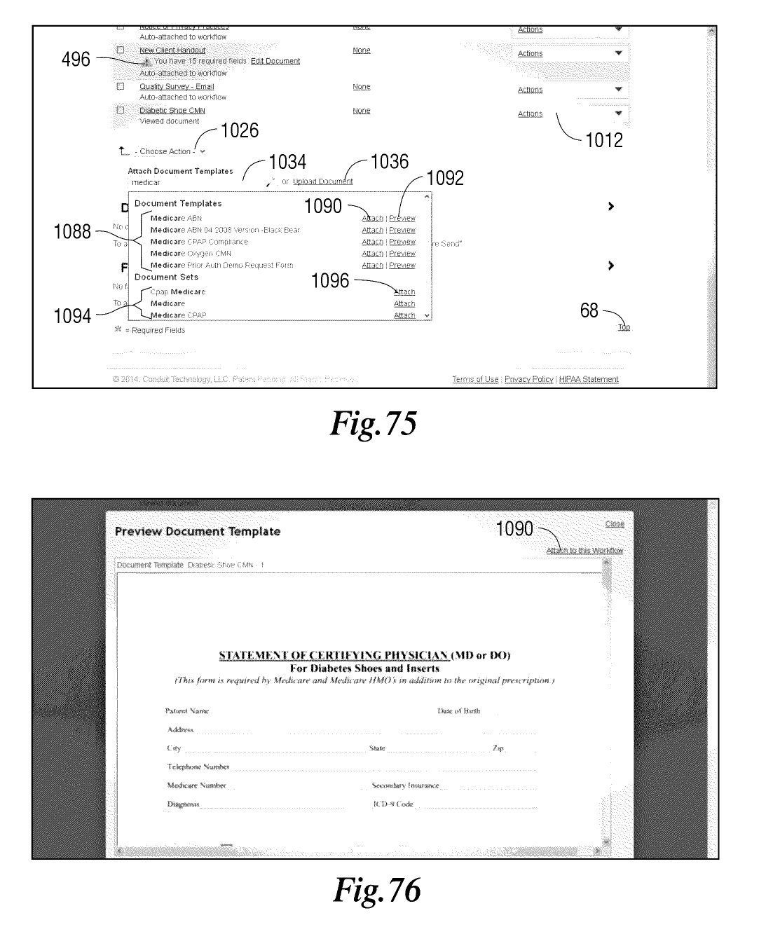

FIG. 75 further depicts the workflow template management interface discussed above with respect to FIGS. 67-68. Here, a search is being conducted based on a portion of text entered 1034 to search both templates 1088 and template sets 1094. There can be options to attach a selected template search result 1090 to the instant workflow and/or preview 1092 the selected template search result. There can also be an option to attach 1096 a template set search result 1094 to the instant workflow, as well as to preview the selected template set (not shown). An example of a previewed template 1092 is depicted in a template preview interface in FIG. 76, which presents an option to attach 1090 the previewed template to the instant workflow.

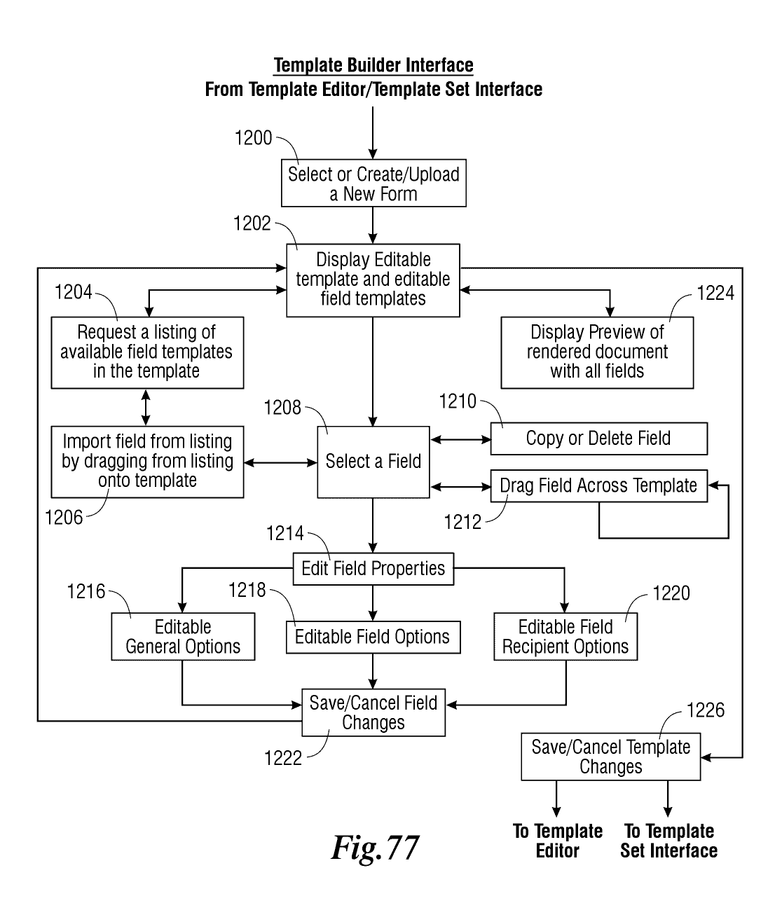

FIG. 77 is a flowchart depicting an example of a template builder interface. In 1200, a user selects an existing form, or creates or uploads a new form. In 1202, the template builder interface displays an editable template with editable field templates. In 1204, a user can request a listing of available field templates in the template. In 1206, a user can import fields from the listing of available field templates by dragging a field template from the listing onto the template. Once a field is dragged onto the form, it can be a currently-selected, or active, field 1208. Some embodiments can present currently-selected field-type options while hovering over a field (without actually selecting the field). In some embodiments, dragging a field onto a form does not by itself designate the field as currently-selected. A currently selected field can present copy and delete field options 1210. Any field can be dragged to change its location 1212 as well as having its borders dragged to affect its size. In some embodiments, a field can be dragged from one template page onto another page in the template. A currently selected field can also present edit field properties 1214, which can include (for example) editable general options 1216, editable field options 1218, and editable field recipient options 1220. Editable general options 1216 can include field name, geographic/pixel position, field size, font size, a flag to copy field to other pages in form, required-field flag, team-notes text field, for example. Edit field properties 1218 can include render options such as dropdown choices utilizing delimited input, unit type (weight units, time units, depth/width/height units), split-value (specifying a quantity of fields), value check (utilizing comparison value), draw circle (utilizing comparison value), character limit, a default value, and whether a default value is optional or mandatory, for example. Editable field recipient options 1220 may include recipient role selection type (e.g., clinician, physician, client, vendor) as well as a recipient-note text field. Only users of the selected recipient role type can see/utilize the instant field when the recipient receives the instant form. In some embodiments, a recipient can be entered instead of selected from a searchable listing. Once field properties 1218 have been modified the instant field can be saved/updated. In some embodiments, a field can be saved/updated even without changes being made. At any time, a preview view 1224 can be selected to show a rendered version of the template with all modifications, even those that have not been saved. At any time, a user can exit the template builder interface by cancelling or saving changes 1226.

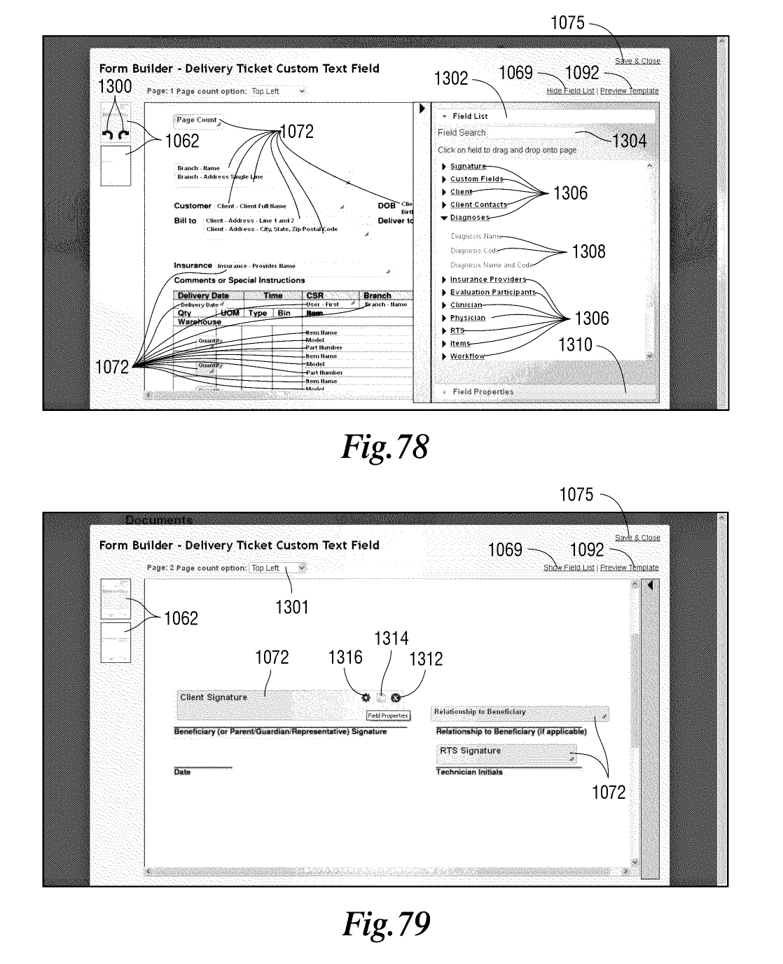

FIG. 78 depicts an example of the template builder interface. A template thumbnail 1062 for each page in a template can be displayed in any area of the view interface, along with rotation options 1300 to rotate a page clockwise or counter-clockwise by, for example, 90 degrees. Some embodiments also allow a user to specify the amount of rotation in terms of degrees, radians, or any other suitable angular distance. Template page order can be modified in some embodiments utilizing arrows (other other indicators) on template page thumbnails and/or drag-and-drop. A page count option 1301 can be utilized to specify a page counter to appear on all or specified pages. Page count options can include choices such as ‘Top Left,’ ‘Top Right,’ ‘Bottom Left,’ and ‘Bottom Right,’ for example. Selecting the page count option 1301 can produce a field 1072 labeled (for example) ‘Page Count’ which can be dragged like any other field. Some embodiments may include page count options that include displaying the page number by itself, page number of total number of pages (i.e., page x of y), first page different/omitted, etc. In response to selecting the show/hide field list option 1069, a field list 1302 can be displayed. The field list 1302 may include a field search option 1304 along with a listing of selectable field types 1306 that can each include an expandable/collapsible listing of fields 1308 corresponding to their respective field types 1306. For example, field types 1306 such as ‘Client Contacts’ and ‘Diagnoses’ are selectable, with ‘Diagnoses’ being selected/expanded to reveal fields 1308 such as ‘Diagnosis Name,’ ‘Diagnosis Code,’ and ‘Diagnosis Name and Code.’ Additionally, field properties 1310 relating to a currently selected field are also selectable. Additionally, some embodiments allow users to create new fields and/or field types in accordance with the field properties described herein.

FIG. 79 depicts options available on a currently selected (or hovered-upon) field 1072, here the ‘Client Signature’ field. There are options to remove/delete the field 1312 from the current template and to copy/duplicate the field 1314. Additionally, there is an option to display the field's properties 1316.

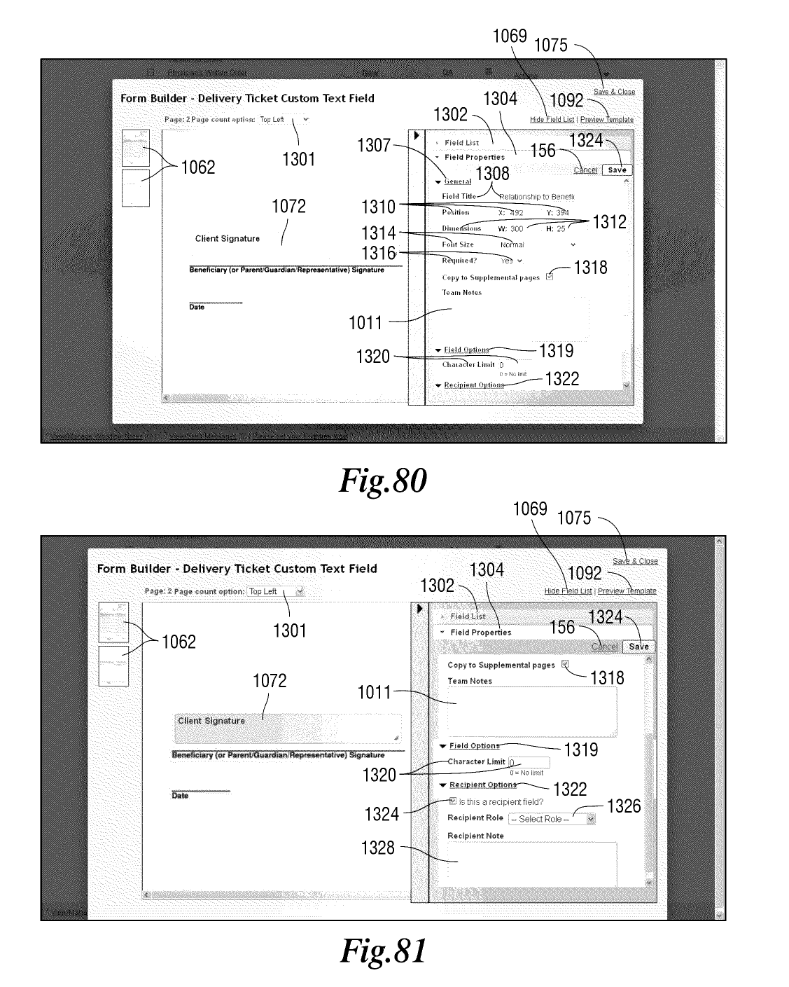

FIG. 80 illustrates field properties 1304 that can be brought up by selecting a field's properties 1316, as discussed above. Field properties can include general properties 1307, such as field title 1308, field position 1310 (which can be in x-axis/y-axis horizontal/vertical pixel coordinates, percentages, or any other suitable position/geographic measurement/indicator), field dimensions 1312 (height/width in pixels, percentages, or any other suitable unit of measurement/distance), field font size 1314 (e.g., really small, small, normal, large, really large, and/or numerical values), field required flag 1316 (for example, see required field notice 1067 in FIG. 72), an option to copy the field to supplemental pages in the template 1318 (which can include some, all, or specified pages in some embodiments), and team note text 1011 (which can be in the form of a customized comment field in some embodiments). Field options 1319 can include, for example, a character limit 1320 (with an option to specify no limit).

FIG. 81 further illustrates field properties 1304 for a currently selected field 1072. Recipient options 1322 can include a recipient field indicator 1324 which can allow a user to specify which user-type role(s) 1326 (such as clinician, physician, vendor, client, etc.) will be able to view the instant field (and/or any contents) upon receipt of the template. In some embodiments, a user of the selected role type will see a placeholder for the field, such as the field title 1308, and not the field's contents, with users of non-specified role types not seeing any indication of the field. Specifically, if a recipient user not of the specified role type(s) 1326, they will not be able to see/utilize/complete the instant field. In some embodiments, if a recipient user is not of the specified role type 1326, they may see a placeholder/generic indicator of the field but not its contents. Another recipient option 1322 is a recipient note 1328 that can be in the form of a customized comment field in some embodiments, wherein only the specified recipient will be able to see the recipient note 1328.

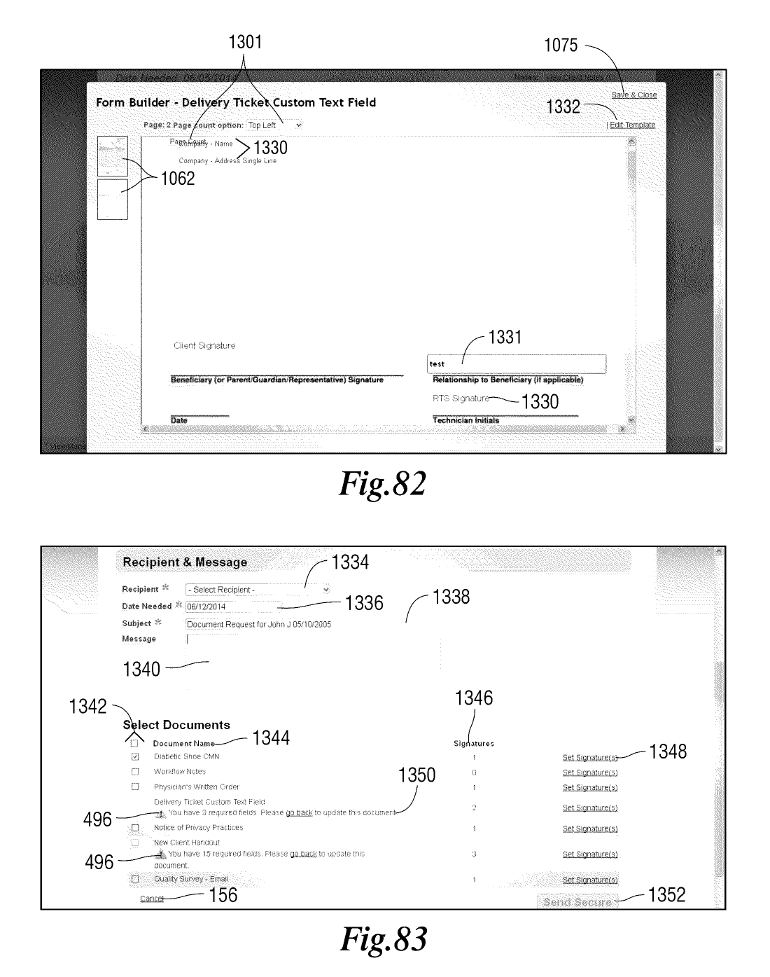

FIG. 82 depicts a template preview, which can correspond to the template preview option 1092 in FIG. 81. Here, the page count field 1301 is displayed as text indicating the location it will appear in on a rendered version of the instant previewed template. Similarly, field titles 1330 representing company name and address information fields, along with a vendor signature field, are displayed. Another field, ‘Relationship to Beneficiary,’ is displayed in the template preview in a form that accepts textual input 1331. Here, the user has entered the text ‘test’ into the ‘Relationship to Beneficiary’ field in the template preview. This provides the user with a view of what this field will look like for the intended recipient (or other users of the specified role-type in some embodiments). The text (here ‘test’) entered into the template preview of the textual input field 1331 has not yet been saved, although some embodiments can record a log of template preview textual entries for each textual input field 1331.

Returning to FIG. 67, selecting the secure send option 1018 can bring up a secure send interface as depicted in FIG. 83. This secure send interface allows a user to select a recipient 1334 (other embodiments allow a recipient to be entered manually and/or select/enter multiple recipients), specify a deadline date 1336, enter a secure message subject 1338, and enter secure message text 1340, which in some embodiments can utilize a custom comment field interface. Additionally, templates within a listing, associated with the instant workflow, are selectable 1342 with each template's name 1344 and with a number of signatures needed 1346 being displayed for each template. Additionally, there can be an option to set the user's signature 1348 to a template. Some embodiments allow users to set signatures for any user within the chain of delegation. Templates having fields requiring completion by the instant user (prior to the secure send) may cause the display of a pre-send required field notification 1350, which indicates the quantity of required fields remaining before a template can be sent. Some embodiments utilize a recall-message feature to remove note/message from the recipient's inbox (which may or may not be restricted based upon whether the note/message has already been read/accessed). In some embodiments this required field notification 1350 can be satisfied by utilizing the option to set the user's signature 1348 to that template. Some embodiments allow templates needing signatures from other role-types to be sent, wherein such signatures can be completed later. Some embodiments can loosen signature restrictions based upon time-based thresholds with respect to the deadline of a template and/or workflow. When the selected templates are ready, a secure message can be sent 1352 to the selected recipient 1334 including a date needed 1336, a subject 1338, message text 1340, and all selected workflow templates 1342.

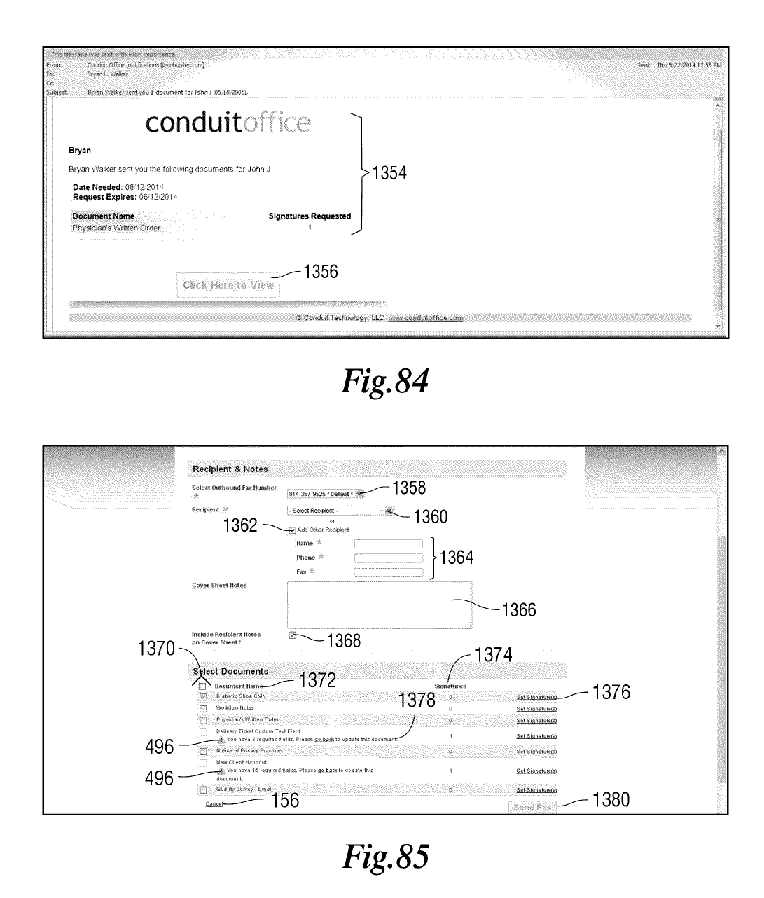

FIG. 84 shows a sample email as viewed by the designated recipient. The secure email contents 1354 include, for example, the recipient's name, the sender's name, the deadline date (date needed), the request expiration date, the templates accompanying the request, and the number of signatures needed for each template. The secure email can also include an indicator (link, icon, button, etc.) that leads the recipient to log in to their own account (or to create a new account) to begin working on the request described in the secure message. In this embodiment, the associated documents are not attached to the secure message, but are instead accessible only after the recipient logs into their account (clinician, physician, vendor, client, etc.). Other embodiments can send the associated documents as attachments within any type of appropriate, secure communications system (such as a secure email system).

Returning to FIG. 67, selecting the send fax option 1020 can bring up a send fax interface as depicted in FIG. 85. This send fax interface can provide options to select an outbound fax number 1358, in accordance with an outbound fax number being associated with a user account, branch, company, etc. In some embodiments, an outbound fax number can also be manually entered. A fax recipient 1360 can be selected from users associated with the instant workflow, with one or more users (each with an associated fax number) being listed per role where available. In some embodiments, an e-fax number, email address, or other communications interface can be used to send/receive a fax and/or e-fax, which may also utilize encryption. A new recipient can be added 1362, which can entail adding the recipient's contact information 1364, including their name, phone number, and fax number. Cover sheet notes 1366 can be added (which in some embodiments utilizes a customized comment field) with an option to include recipient notes on a fax cover sheet 1368. Additionally, templates in a listing associated with the instant workflow are selectable 1370 with each template's name 1372 and number of signatures needed 1374 being displayable for each template. Additionally, there can be an option to set the user's signature 1376 to a template. Templates having fields requiring completion by the instant user (prior to being faxed) may cause the display of a pre-send required field notification 1378, which indicates the quantity of required fields remaining. In some embodiments this required field notification 1378 can be satisfied by utilizing the option to set the user's signature 1376 to that template. When the selected templates are ready, a fax can be sent 1380 from the selected recipient's fax number 1358 (or other appropriate information in other embodiments) with all selected workflow templates 1370. Some embodiments can include a date needed, a subject, and/or fax message text. Some embodiments can utilize optical character recognition (OCR) for faxes and/or scanned documents. Any suitable OCR techniques can be utilized, such as intelligent character recognition, intelligent word recognition, pre-processing, and/or post-processing, wherein any implementation may use a neural-network (which can be limited to the systems described herein or encompass external systems as well) implementation to improve OCR accuracy with time and usage. OCR pre-processing techniques used in embodiments can include de-skewing (automatic rotation of a tilted image/fax), layout analysis (such as columns of text), and/or binarizing/despeckling (which can remove noise and/or pixelation commonly associated with lossy compression techniques such as JPEG compression), to help isolate individual letters and their constituent lines/curves). OCR post-processing techniques utilized in embodiments can include, for example, constraining by lexicon (such as a list or dictionary of known/expected words/characters) and/or near-neighbor analysis (probability-based analysis to determine which possible OCR matches are more likely to be correct). For example, utilizing a neural-network implementation as described above, any suitable algorithm can be utilized, such as the k-Nearest Neighbors algorithm, wherein an analyzed object can be classified according to its closest neighbors that themselves were obtained from previous classification iterations. Any resulting faxed or scanned document can utilize a searchable/selectable/editable textual representation within the document, wherein questionable OCR results can automatically be flagged (similar to how a spell-check program flags mistakes).

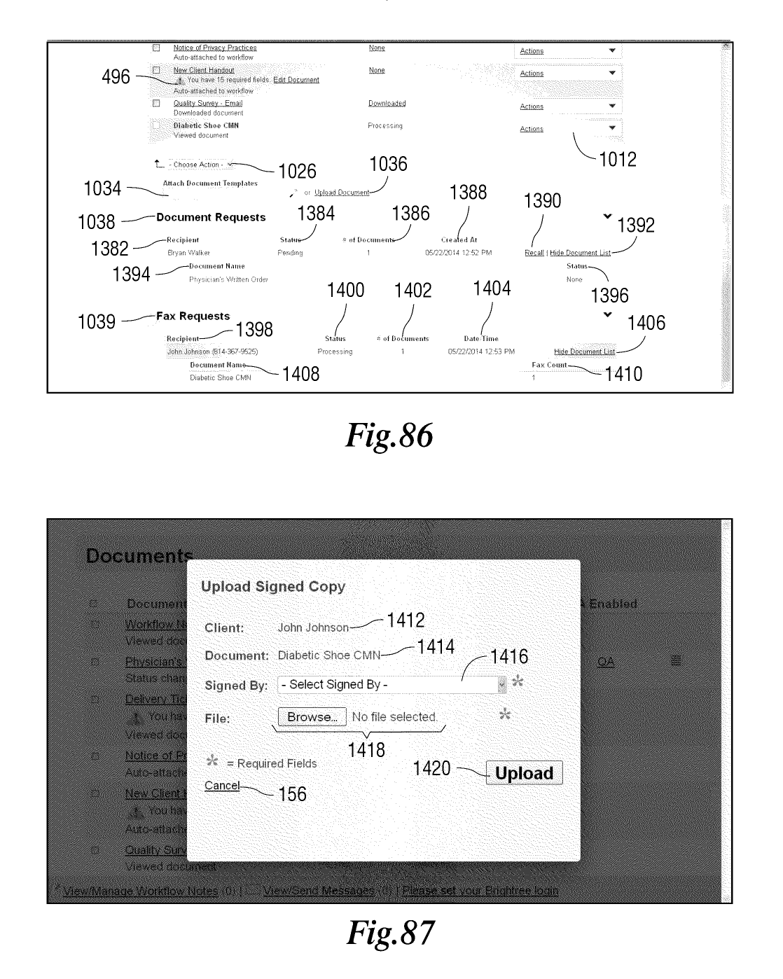

Continuing with the workflow template management interface discussed above with respect to FIGS. 67-68, a template request 1038 is depicted in FIG. 86. By expanding the collapsible template requests interface (some embodiments do not utilize a collapsible interface), a record is displayed for each template request with a recipient name 1382, a template request status 1384, the number of templates in the template request 1386, a template request creation timestamp 1388, an ability to recall the template request 1390 from the recipient, and an option to show/hide the template list 1392. By showing the template list 1392, each template's name 1394 and status 1396 are displayed. Fax requests 1039 are also displayed in a collapsible interface (although some embodiments do not utilize a collapsible interface). A record is displayed for each fax request with a recipient name/fax number 1398, a fax request status 1400, the number of templates in the fax request 1402, a fax request creation timestamp 1404, and an option to show/hide the template list 1406. Some embodiments can utilize an ability to recall the fax request from the recipient in an e-fax setting. By showing the template list 1406, each template's name 1408 and fax count 1410 are displayed. Some embodiments can display a template status indicator.

Returning to FIG. 67, selecting the upload signed copy option 1022 can bring up a signed template copy upload interface as depicted in FIG. 87. This signed template copy upload interface can present the subject's name (such as a client's name) 1412 and the name of the template being uploaded (or other identifier) 1414. In some embodiments, the subject's name 1412 and/or template's name 1414 can be selectable or may be manually entered. A signed-by field 1416 can be presented to users associated with the instant workflow (such as one or more clinicians, physicians, vendors, clients, etc.). A standard browse and upload interface 1418 can be utilized, as can any other appropriate type of upload interface. When ready, an upload confirmation indicator 1420 can either be presented at all times, or after completion of required fields in the instant interface.

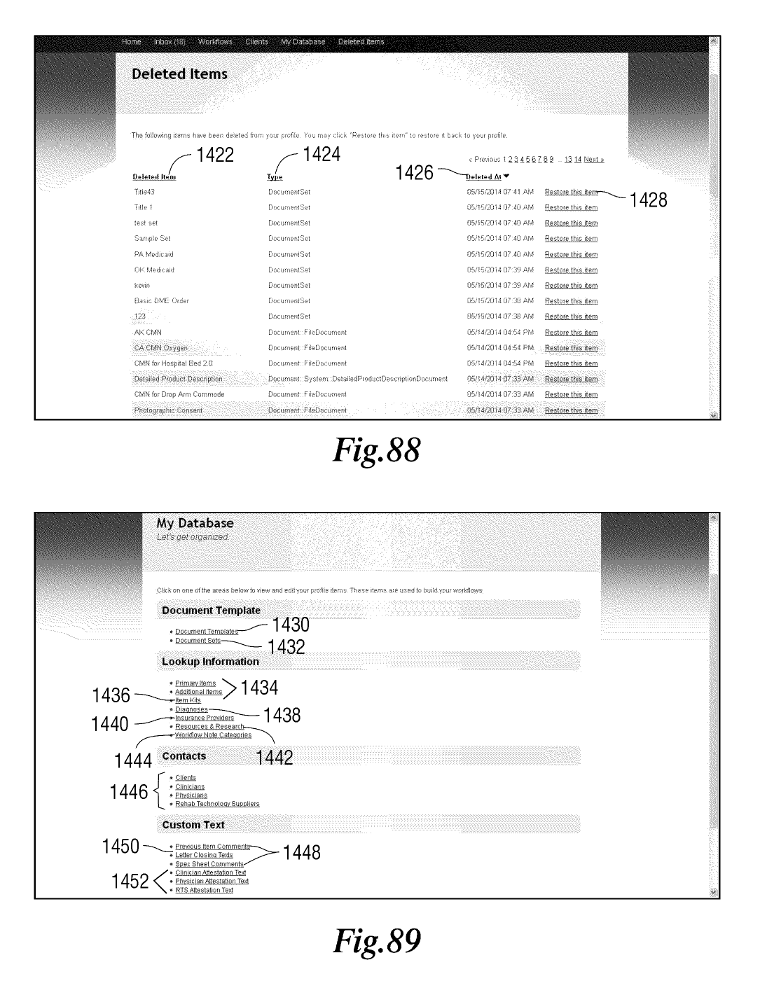

Returning to FIG. 67, selecting the remove option 1024 can bring up a deleted items interface as depicted in FIG. 88. This deleted items interface can present records of deleted items that include, for example, the item's name 1422, the item type 1424 (such as a template set, template, workflow, or rendered document template), the deletion timestamp 1426, and an item restoration option 1428.

Selecting ‘My Database’ from the heading links 100 discussed above can bring up a My Database interface, an example of which is illustrated in FIG. 89. Template management can include template management options 1430 and template set management options 1432. Lookup information can include item management options 1434 relating to primary items and additional items, item kit management options 1436, diagnosis management options 1438, insurance provider management options 1440, resource and research management options 1442, and workflow note categories management options 1444. Contact options 1446 can be utilized for any role (clinician, physician, vendor, client, etc.). Custom text options can include previous item comment and spec sheet comment management options 1448, letter closing text management options 1450, and attestation text management options 1452.

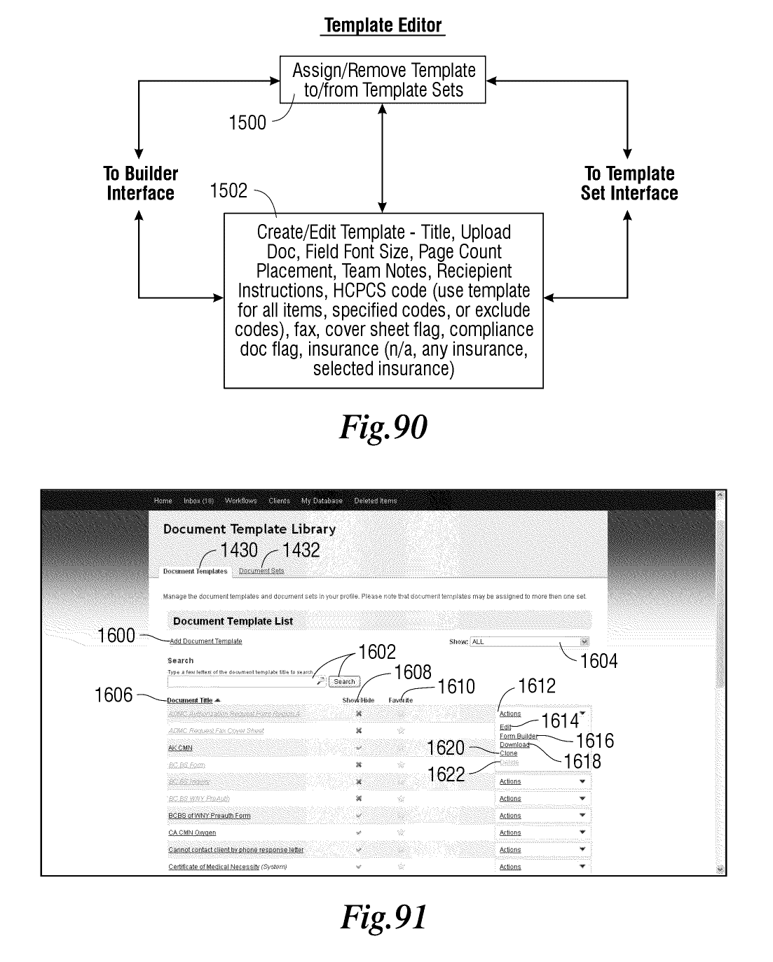

FIG. 90 is a flowchart depicting exemplary functionality of a template editor interface. In 1500, a template can be added to and/or removed from any number of template sets. In 1502, template modification options can include template title, template upload doc, template field font size, template page count placement, template team notes, template recipient instructions, template HCPCS code(s) (use template for all items, specified codes, or exclude codes), template fax cover sheet flag, template compliance doc flag, and template insurance (n/a, any insurance, selected insurance) options, for example.

FIG. 91 illustrates an exemplary template listing management interface, which can correspond to the template management options 1430 discussed above, and is presented here as a corresponding selectable tab 1430. Options include adding a new template 1600, a template search option 1602, template viewing criteria 1604 (such as enabled, disabled/hidden, or all templates), and a listing of template records. A template records listing can include a template name 1606 and a show/hide template option 1608, which in this example makes the template name 1606 appear greyed-out when the hide option (here indicated by an ‘X’) is selected. A template favorites indicator 1610 can be selected, along with template options 1612, which can include a template editing option 1614, template builder options 1616 (which can utilize, for example, any embodiment of the template builder interface discussed above), a template download option 1618, a clone/copy template option 1620, and a template deletion option 1622, which in some embodiments can be restricted based on various criteria. Templates in this interface are not necessarily affiliated/assigned to any particular workflow(s).

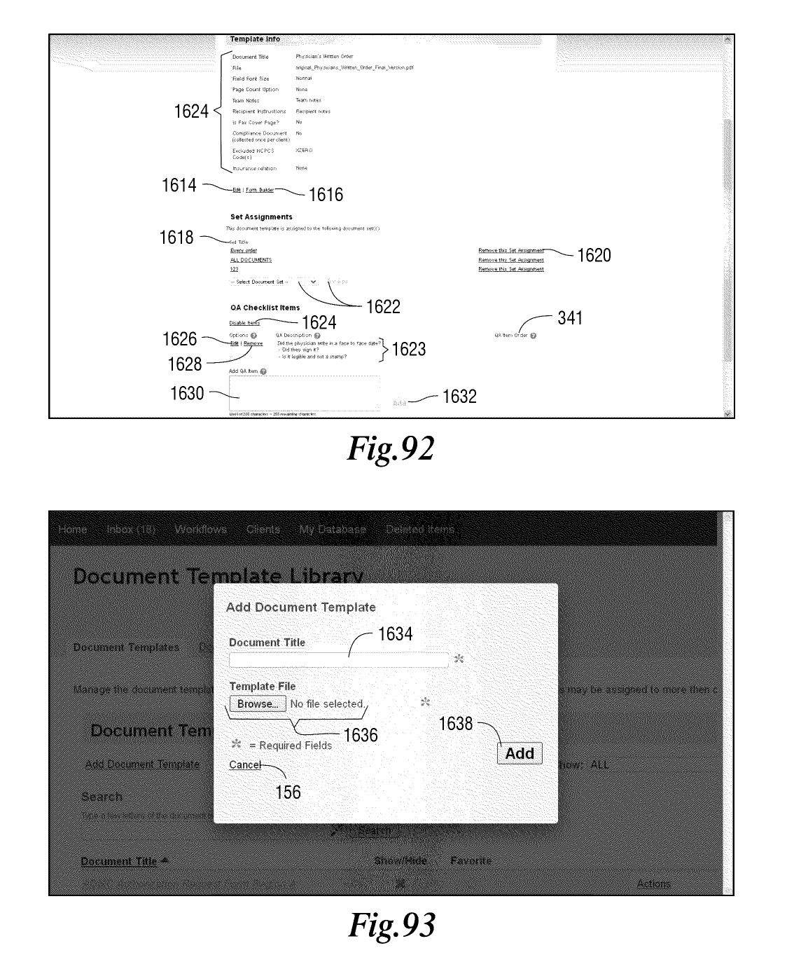

Selecting the template editing option 1614 can bring up a template management interface as depicted in FIG. 92. Template information 1624 (template title, file name, template field font size, template page count options (none, top left, top right, bottom left, bottom right, with some embodiments including ‘page x’ and/or ‘page x of y’ options), recipient instruction text, fax cover page options (yes/no), compliance document options (yes/no, collected once per client in some embodiments), item/HCPCS code options (include all items, include/exclude certain codes), and insurance relation options (none, any, or selected/specified insurance provider(s))) can be edited 1614, or the template can be brought up in any embodiment of the template builder interface discussed above.

Further options can include set assignments, where the instant template can be removed 1620 from a template set to which it currently belongs 1618. Additionally, the instant template can be assigned to a template set to which it has not been assigned 1622. A template can belong to any number of template sets, although some embodiments can limit/restrict access to which template sets a user can assign a template and/or have access, which can be affected by their account. QA template items can be disabled 1624, edited 1626, removed 1628, and reordered 341, with a QA description 1623 provided for each QA item. QA item text 1630 can be utilized to create a new QA item 1632, wherein a customized comment field can be utilized.

Returning to FIG. 91, selecting the add new template option 1600 can bring up an add template interface, such as the depiction in FIG. 93. A template title 1634 can be added, with a browse/upload option 1636 (or any other suitable type of upload interface). When ready, a template upload confirmation indicator 1638 can be utilized either at any time, or once for validation criteria have been satisfied.

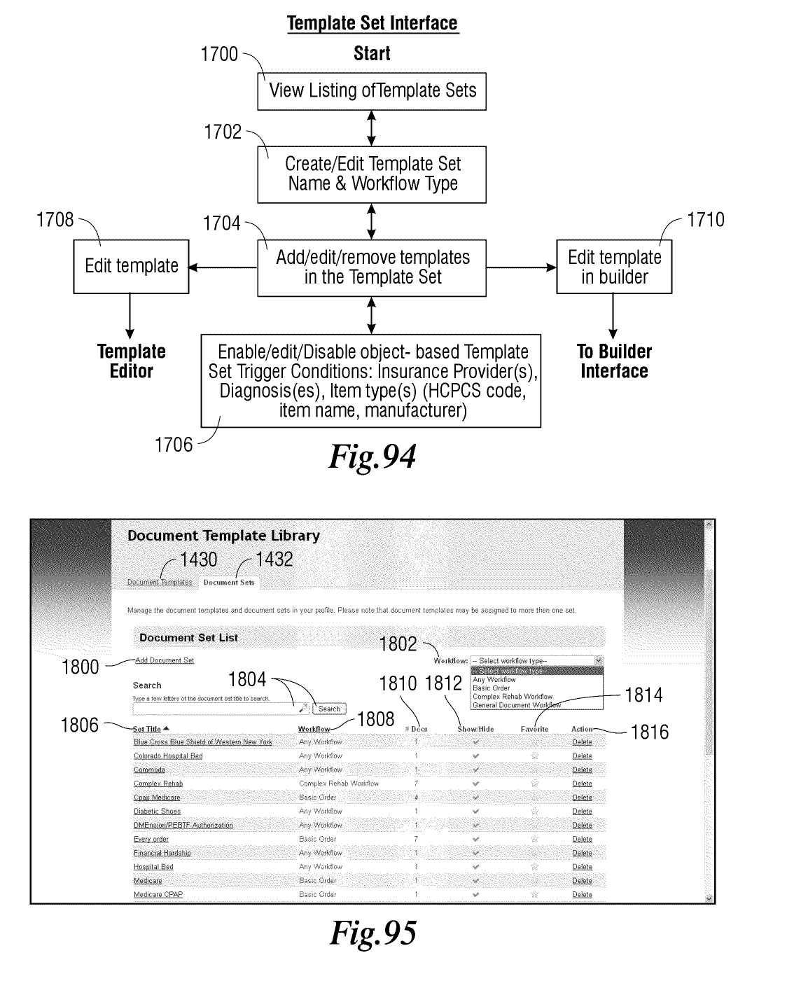

FIG. 94 is a flowchart depicting a template set interface. In 1700 a listing of template sets can be viewed, which in 1702 can lead to options to create/edit a template set name and workflow type. In 1704 templates can be added to, edited within, and removed from the instant template set. In 1706, object-based template set trigger conditions can be enabled, edited, and disabled. Template set trigger conditions can be based on objects such as include insurance providers, diagnoses, and item types (HCPCS code, item name, manufacturer), for example. Any template in the template set can be opened within the template editor interface 1708 (discussed above) and/or the template builder interface 1710 (discussed above).

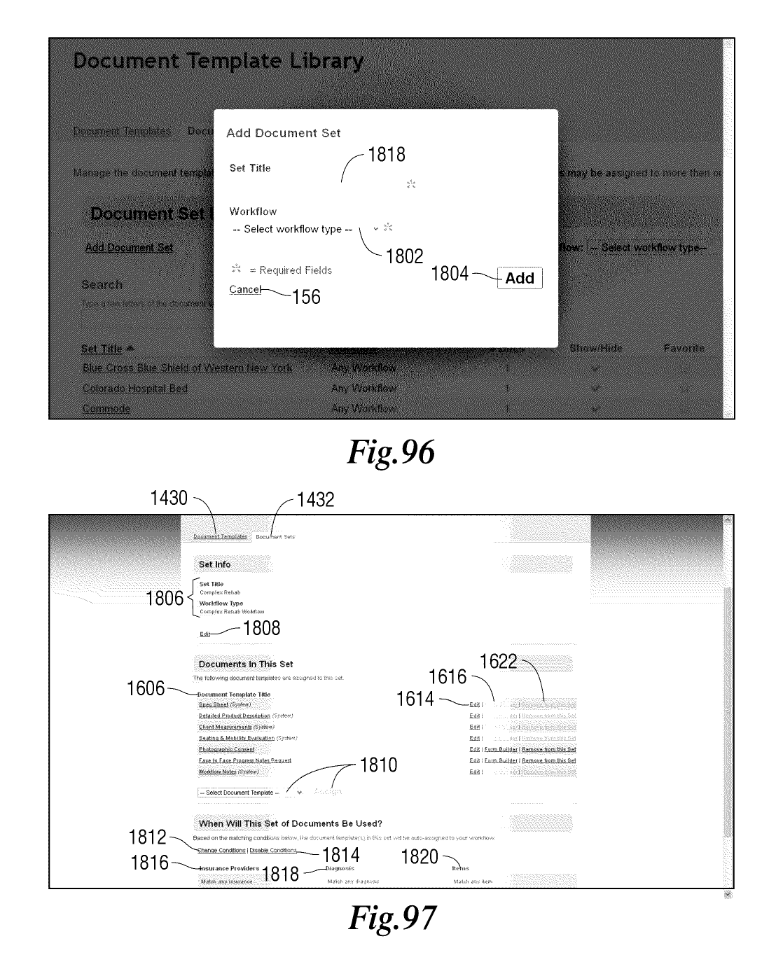

FIG. 95 illustrates an example of a template set listing management interface, which can correspond to the template management options 1432 discussed above, and is depicted here as a corresponding selectable tab 1432. An option to add a document set 1800 can bring up an interface, as illustrated by FIG. 96. A template set title can be entered (or selected in some embodiments) with a workflow type being entered or selected (e.g., basic order, complex rehab workflow, general document workflow, seating and evaluation, specification sheet assessments, repairs, respiratory, and O & P (orthodontics and prosthetics)). An add template set indicator 1804 can be either always available or be subject to form validation criteria.

Returning to FIG. 95, document templates in this interface are not necessarily affiliated/assigned to any particular workflow(s). Template sets are listed and can be filtered according to workflow type (such as basic order, complex rehab workflow, general document workflow, seating and evaluation, specification sheet assessments, repairs, respiratory, and O & P). Template set records can display each template set's name/title 1806, workflow type 1808, number of assigned/affiliated templates 1810, whether to show/hide the template set 1812 (which in this example makes the template name 1806 appear greyed-out (note shown) when the hide option (such as an ‘X’) is selected), a template set favorites indicator 1814 (such as a star), and a deletion option 1816. In some embodiments, a template set restoration option can be used to restore a template set that was previously deleted.

Selecting a template set 1806 can bring up a template set management interface, as illustrated by example in FIG. 97. The template set's info 1806 (such as title and workflow type) can be edited 1808. A listing of the template set's templates can be presented with records displaying each template's title 1606, with a template editing option 1614, template builder options 1616 (which can utilize, for example, any embodiment of the template builder interface discussed above), and a template deletion option 1622, which in some embodiments can be restricted based on various criteria (such as a ‘system’-type template indicator next to some template titles that inactivates options to utilize a template builder and/or remove the template from the template set). Some embodiments may include a template download option and/or an option to clone/copy the template. There can also be an option to select a template for assignment to the instant template set 1810, or in some embodiments, search for an item utilizing any search techniques described herein.

Template set assignment conditions can also be presented, with options to change assignment conditions 1812 and/or disable assignment conditions 1814. A listing of a template set's assignment conditions can display, for each assignment condition, insurance provider conditions, diagnosis conditions, and item conditions, for example.

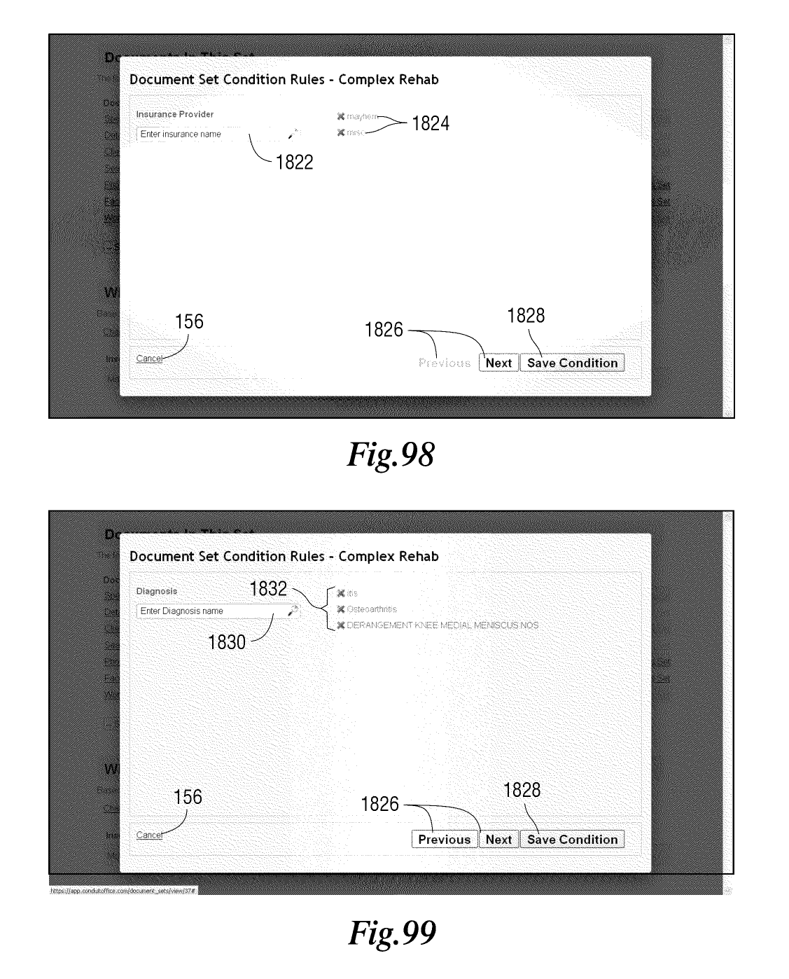

FIG. 98 is an example of an insurance object trigger interface. Here, the various trigger type conditions (insurance, diagnosis, item, etc.) are each part of the same trigger. Some embodiments may treat each trigger type as its own discrete trigger, independent of other trigger types. An insurance provider can be searched 1822 (or entered/created in some embodiments) and selected. Any number of insurance provider objects can be utilized for a given trigger. Two insurance providers are listed as current insurance provider triggers 1824 with options to remove each as a trigger. Some embodiments may have an option to clear all insurance provider trigger choices at once. Navigation options 1826 include moving to the next trigger (if available as an option) and going back to the previous trigger (if available as an option). At any time a trigger can be saved 1828, although some embodiments may utilize form validation to restrict access to the save option 1828. Some embodiments can display a listing of all insurance objects and allow selection and/or drag-and-drop to select/deselect insurance objects.

FIG. 99 is an example of a diagnosis object trigger interface. A diagnosis can be searched 1830 (or entered/created in some embodiments) and selected. Any number of diagnosis objects can be utilized for a given trigger. As illustrated, three diagnoses are listed as current diagnosis triggers 1832 with options to remove each as a trigger. Some embodiments may have an option to clear all diagnosis trigger choices at once. Some embodiments can display a listing of all diagnosis objects and allow selection and/or drag-and-drop to select/deselect diagnosis objects.

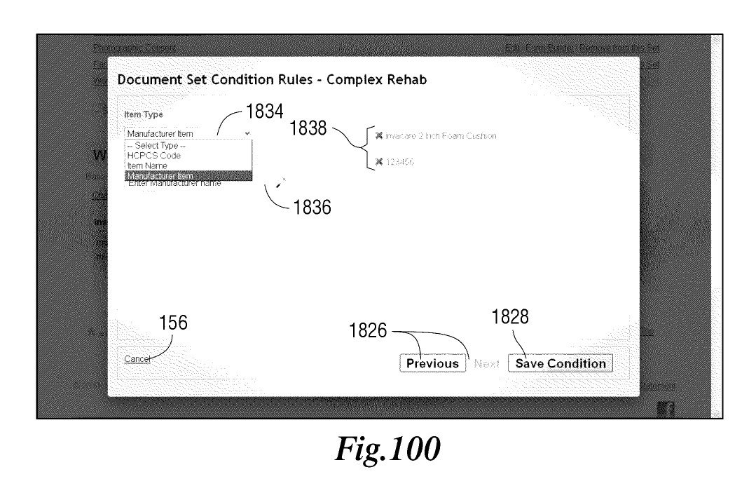

FIG. 100 is an example of an item object trigger interface. An item search criteria type 1834 (e.g., item/HCPCS code, item name, manufacturer) can be selected. Based upon the item search criteria type selected 1834, an item can be searched 1836 (or entered/created in some embodiments) and selected according the selected criterion (or any other appropriate criteria), here the manufacturer name. Any number of item objects can be utilized for a given trigger. Two items are listed as current item triggers 1838 with options to remove each as a trigger. Some embodiments may have an option to clear all item object trigger choices at once. Some embodiments can utilize all or some of the features of the item adding interface described above. Some embodiments can display a listing of all item objects and allow selection and/or drag-and-drop to select/deselect item objects.

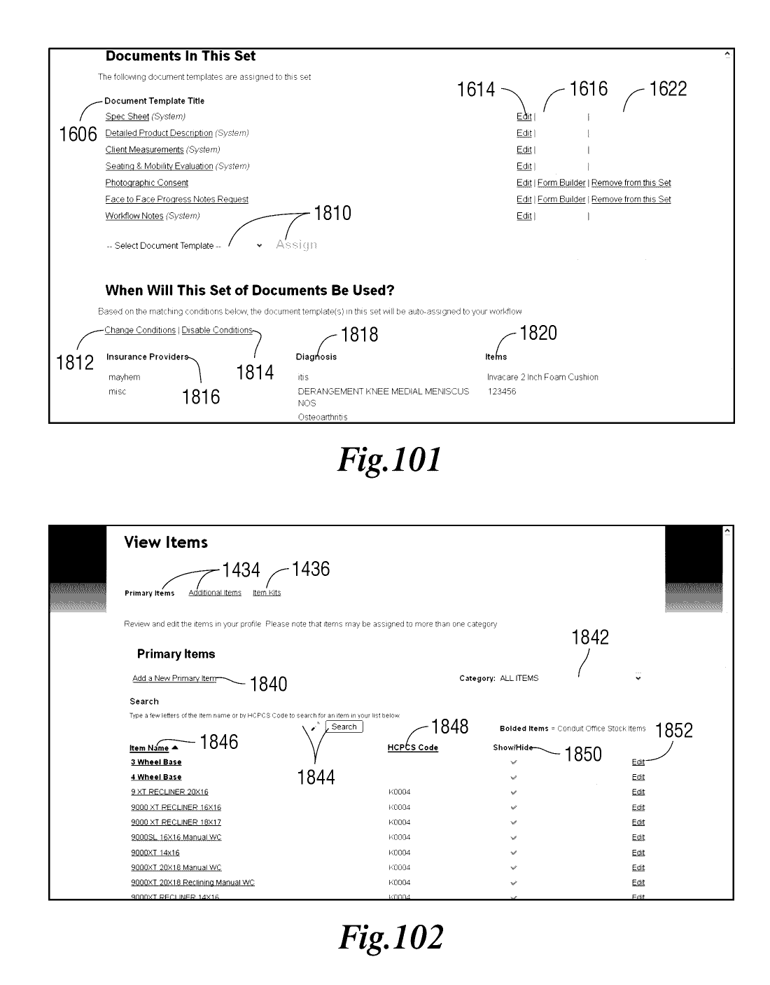

FIG. 101 further depicts the template set management interface embodiment from FIG. 97. The new/updated insurance providers 1816, diagnoses 1818, and items 1820 are now reflected in the instant trigger record. An occurrence of any of these insurance provider objects 1816, diagnosis objects 1818, or item objects 1820 can trigger the appending of all the templates in the instant template set to the workflow to which these workflow objects (e.g., insurance providers 1816, diagnoses 1818, and items 1820) belong. In some embodiments, triggers can also be utilized in the same manner for each template, irrespective of whether a template belongs to any template sets. In some embodiments, when a template set is appended to a workflow (such as by satisfying one of its triggers), this can cause a check to be conducted, which can prevent the appending of any of the template set's templates that are already in the instant workflow.

In some embodiments, template set (or template) triggers are compared continuously (substantially in real-time/live) or periodically, wherein the frequency/periodicity of such checks can be user and/or administrator defined. In some embodiments, if none of a workflow's objects satisfies any of a template set's trigger conditions, the template set's templates are removed from the instant workflow, as they are no longer needed. Similarly, in some embodiments, if none of a workflow's objects satisfies any of a template's trigger conditions, the template is removed from the instant workflow, as it is no longer needed.

Returning to FIG. 89, selecting item management options 1434 (relating to primary items and additional items) can bring up the exemplary global item listing management interface depicted in FIG. 102, with such options being presented here as corresponding selectable primary and additional item tabs 1434. Reviewable items can be restricted with respect to the instant user's/administrator's profile (i.e., the user/administrator cannot view/edit items whose permissions restrict access, based on rights associated with the user's/administrator's profile, to the item's access rights, or both) in some embodiments. In other embodiments, a user/administrator may have unfettered access to all items. As shown, a new item can be added 1840. An item listing can be filtered 1842 by any suitable criterion, such as item category. Item categories can include, for example, all items, power wheelchair, manual wheelchair, scooter/power operated vehicle (POV), gait trainer, stander, adaptive tricycle, position chair, bath chair, toileting system, patient lift, adapted bed, bathroom equipment, or other equipment, which can serve as a miscellaneous category, or (in some embodiments) generate a prompt to create a new equipment item category.

Items can also be searched 1844, with search suggestions and/or search results being made in some embodiments based on each character received (as discussed above). Any search interface described herein can utilize auto-complete search suggestions, which can be based on frequently or recently used queries or from external data sources/databases such as BRIGHTREE®, or be based on web-based data, wherein such auto-complete suggestions and/or search results can be utilized across all users/administrators or restricted to a particular user account and/or role. Each item record can display the item name 1846 (with some embodiments denoting stock items, such as with bold font), item/HCPCS code 1848, an item show/hide option 1850 (which in this example can make item names 1846 appear greyed-out if the hide option (such as an ‘X’) is selected), and an item edit option 1852.

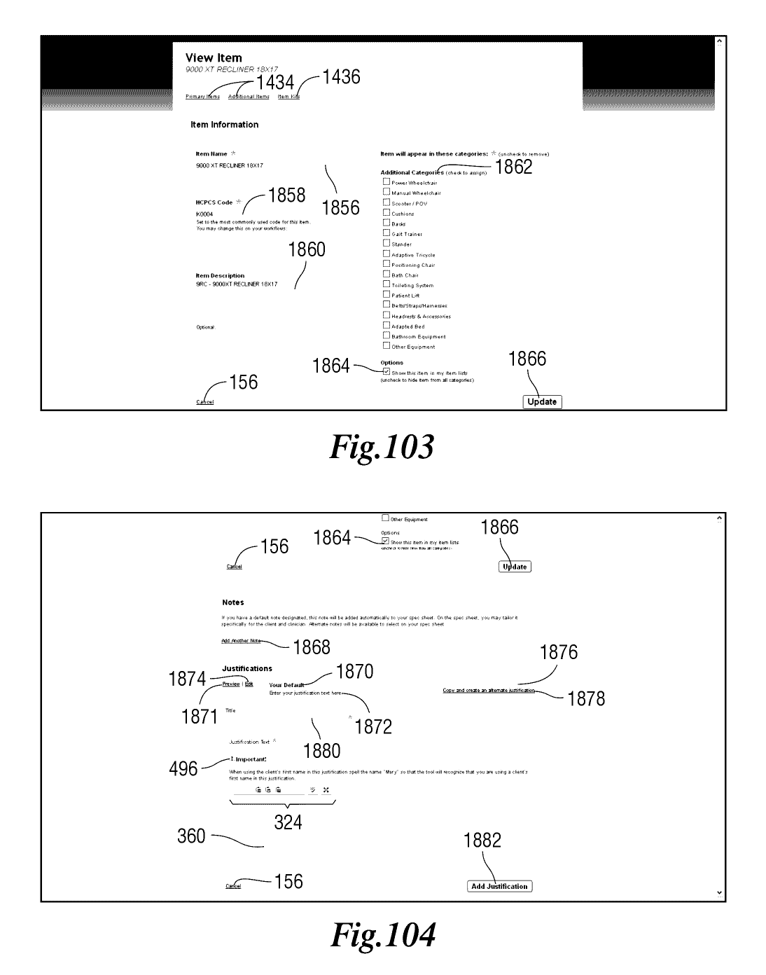

Selecting an add new item option 1840 or edit item option 1852 can bring up an item management interface as illustrated in FIG. 103. Here, an item name 1856 and an item/HCPCS code 1858 can be entered (or selected in some embodiments, such as re-using the name of a previously-deleted item). An optional (or mandatory in some embodiments) item description 1860 can be entered, which in some embodiments utilizes a customized comment interface (wherein some embodiments may use an interface similar to that depicted above for FIG. 64). An item can be assigned to one or more item categories 1862, along with an option to associate the item with the instant user's/administrator's item list 1864, where unchecking this option can unassociate the item from all categories. An update/create option 1866 can be utilized at any time (or be subject to from validation requirements in some embodiments). Additionally, a history option (not shown) allows an audit-type view of the item, an example being described above with respect to FIG. 31.

Continuing with the item management interface, FIG. 104 provides an item note text option 1868 that utilizes a customized comment field. Item justifications can display a title 1870, utilize an edit option 1874, and may have a preview option 1871 that can display the item's justification text 1872. There can also be options to make the current item justification text 1872 the default item justification 1876 (which can be deactivated in some embodiments), and to copy and create a new item justification from the current item justification text 1878. Additionally, an item justification title text field 1880 is presented, along with an embodiment of a customized comment field 360 for the new item justification, and an option to add the new item justification 1882.

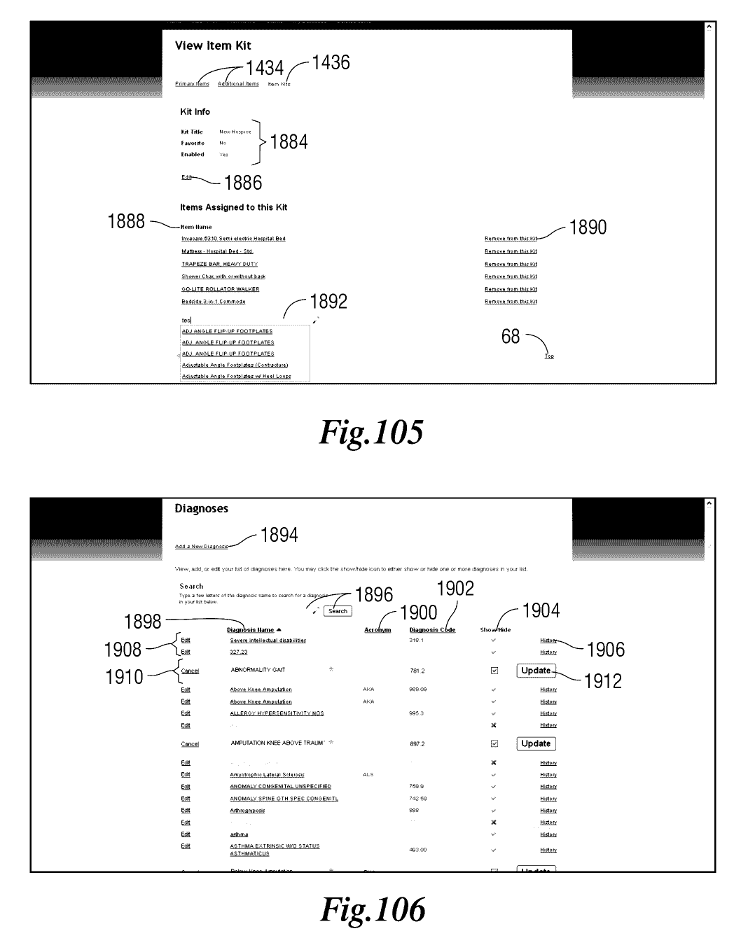

Returning to FIG. 89, selecting item kit management options 1436 can bring up an item kit management interface such as depicted in FIG. 105, which are presented here as a corresponding item kit tab 1436. The item kit's info 1884 (such as kit title, favorite status (yes/no), enabled (yes/no)) can be edited 1886. A listing of the item kit's constituent items can be presented with records displaying each item's title 1888, and an item deletion option 1890, which in some embodiments can be restricted based on various criteria (such as the ‘system’ indicator next to some items that inactivates options to remove the item from the item kit) and/or role-based restriction. Some embodiments may include an item download option and/or an option to clone/copy the item. There can also be an option to select an item for assignment to the instant item kit (not shown) based upon an item search option 1892, which can utilize any search techniques described herein.

Returning to FIG. 89, selecting diagnosis management options 1438 can bring up a diagnosis management interface as shown in FIG. 106, which can allow global (or group and/or role-based) management of available diagnoses. An option to add a new diagnosis 1894 can be utilized, along with a diagnosis search option 1896, which can utilize any search options discussed herein. Each diagnosis record can be displayed by diagnosis name 1898, diagnosis acronym 1900, diagnosis code 1902, and show/hide flag/option 1904 (wherein access to making/viewing modifications can be restricted in some embodiments). Each diagnosis record can be displayed in view mode 1908 (with an option to view an audit history 1906) or edit mode 1910 (with an option to update the diagnosis record 1912).

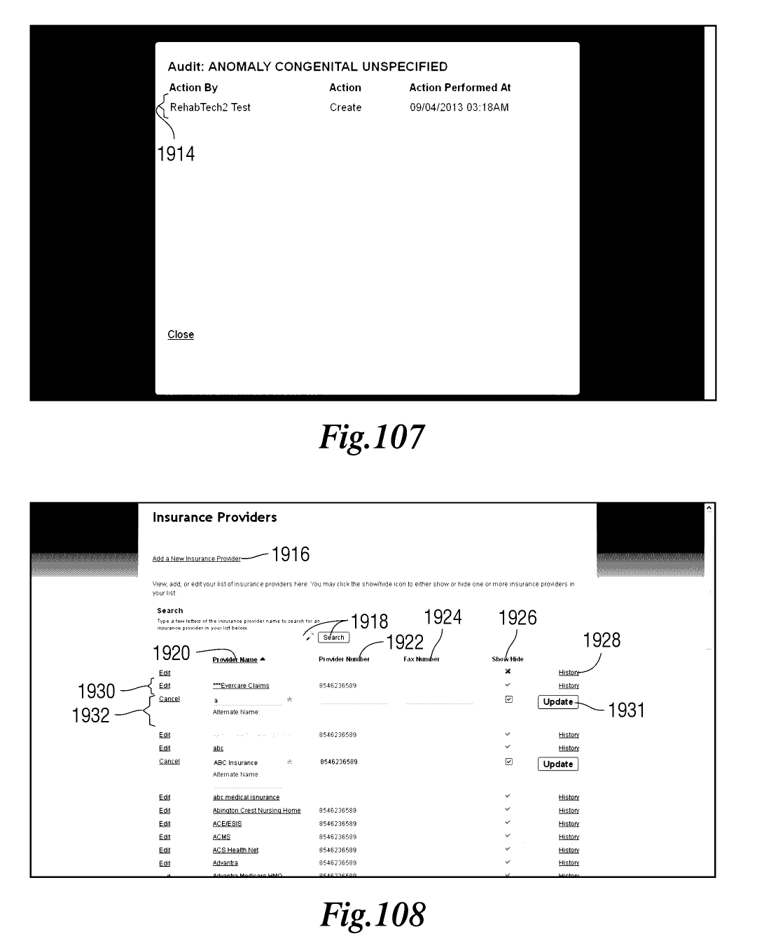

FIG. 107 depicts an example of a diagnosis record audit interface. An audit record 1914 here is shown as a result of selecting the audit history option 1906 of a viewed diagnosis record 1908 in FIG. 106. Some embodiments include options to view all data associated with a diagnosis record, such as clients, workflows, equipment, insurance providers, and any other data with which a diagnosis record can be utilized/analyzed.

Returning to FIG. 89, selecting insurance provider management options 1440 can bring up an insurance provider management interface as shown in FIG. 108, which can allow global (or group and/or role-based) management of available insurance providers. An option to add a new insurance provider 1916 can be utilized, along with an insurance provider search option 1918, which can utilize any search options discussed herein. Each insurance provider record can be displayed with an insurance provider name 1920, an insurance provider number 1922, an insurance provider fax number 1924, and a show/hide flag/option 1926. Some embodiments utilize an insurance provider email address. Each insurance provider record can be displayed in view mode 1930 (with an option to view an audit history 1928) or edit mode 1932 with an option to update the insurance provider record 1931.

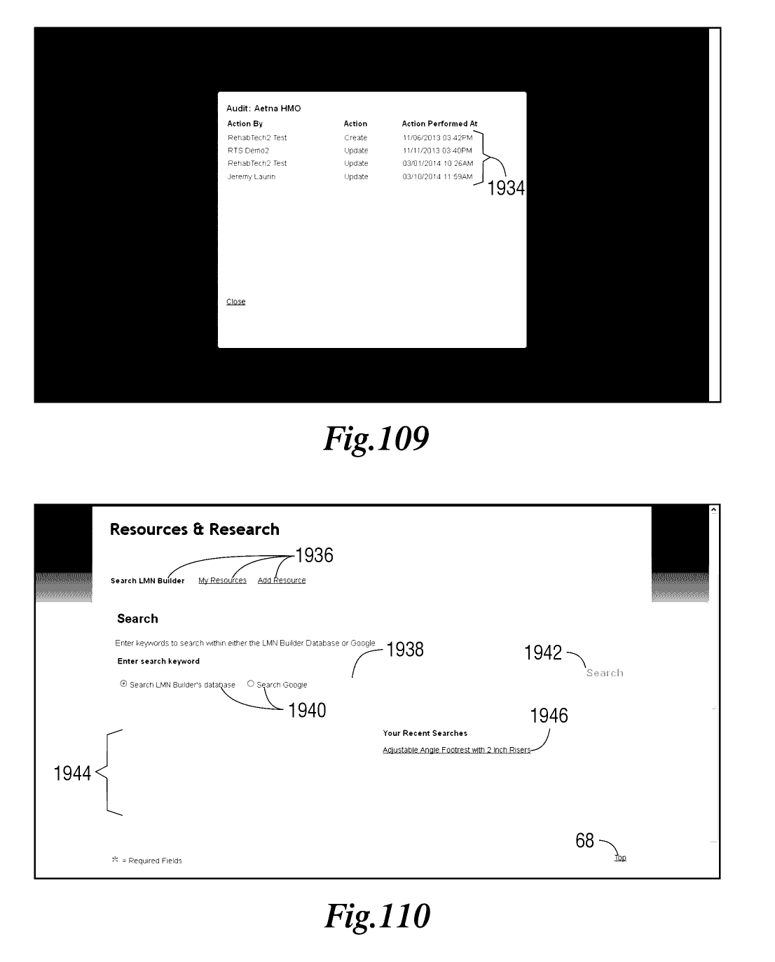

FIG. 109 depicts an example of an insurance provider audit interface. Audit records 1934 here are shown as a result of selecting the audit history option 1928 of a viewed insurance provider record 1930 in FIG. 108. Some embodiments include options to view all data associated with an insurance provider record, such as clients, workflows, equipment, diagnoses, and any other data with which an insurance provider record can be utilized/analyzed.

Returning to FIG. 89, selecting resources and research options 1442 can bring up a resource search interface as shown in FIG. 110. Resources can be any information in any form, such as a hyperlink or file. Resource options 1936 can include, for example, options to search for a resource, to access the user's own resources (e.g., ‘my resources’), and to add a resource. A resource search option 1938 can utilize any search techniques discussed herein. Search features 1940 can include searching within a user's account, or globally across all user accounts, as well as searching the web via internet search engines. Some embodiments can include searching capabilities linked to external data sources/databases, such as BRIGHTREE®, where searches may be specific to data within a user's account in such external data sources/databases, or searches may be global within such external data sources/databases. A search confirmation indicator 1942 may be utilized to search. Alternatively, a user can utilize/select search suggestions 1944 as well as the user's own recent searches 1946 and/or associated search results (not shown), any of which may be cached for quick retrieval.

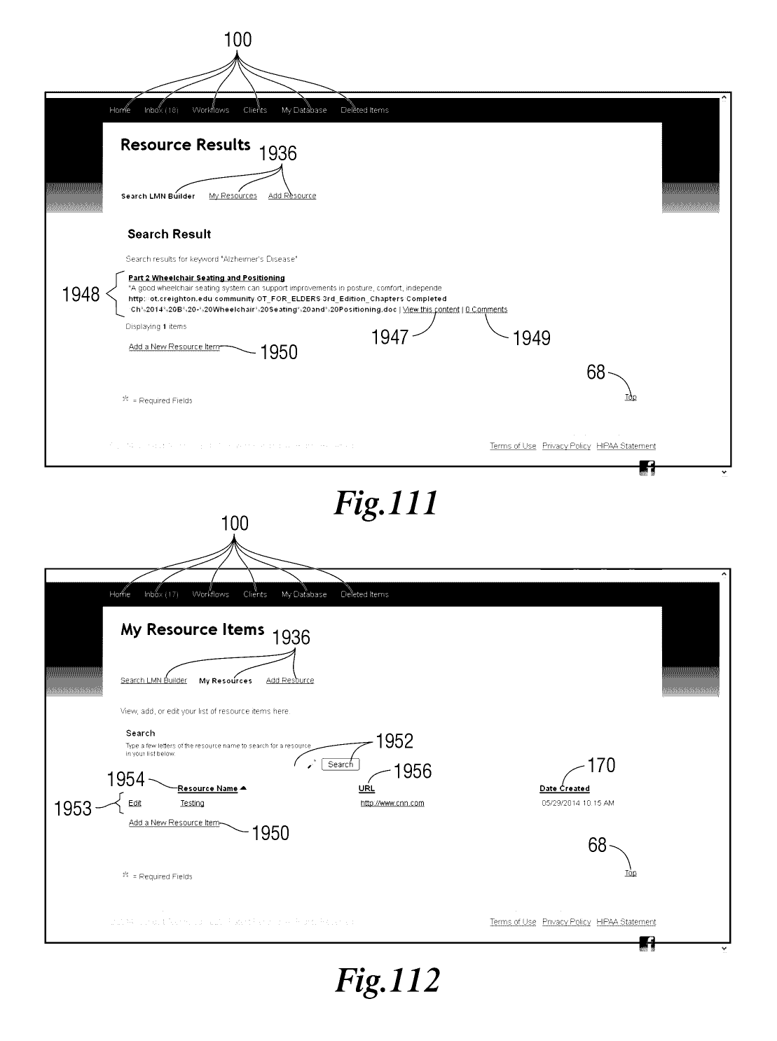

FIG. 111 displays an example of a resource search results interface. Search results 1948 can be displayed with a web link anchor text, a visible URL (uniform resource locator), an option to visit the URL 1947, and/or an option to view comments 1949 regarding the resource. Some embodiments can have resource rating options (with rating being obtained from the instant user and/or other users) and/or resource thumbnail/preview options. Additionally, a new resource can be added 1950.

FIG. 112 displays an exemplary resource management interface, which can correspond to the ‘my resources’ tab within the exemplary selectable resource options 1936. A user can search for their previously saved resources 1952 (utilizing any search techniques described herein), which can include resources related to their instant account, branch, and/or company, as well as data from the internet. As discussed above, resources can also be obtained from external data sources/databases. Each resource record 1953 can be displayed with the resource name 1954, the resource URL 1956 (if applicable), and a creation timestamp 170, for example. Some embodiments can also use an audit history regarding a resource and/or display rating information from the user and/or other users. Additionally, an option can be presented to add a new resource 1950.

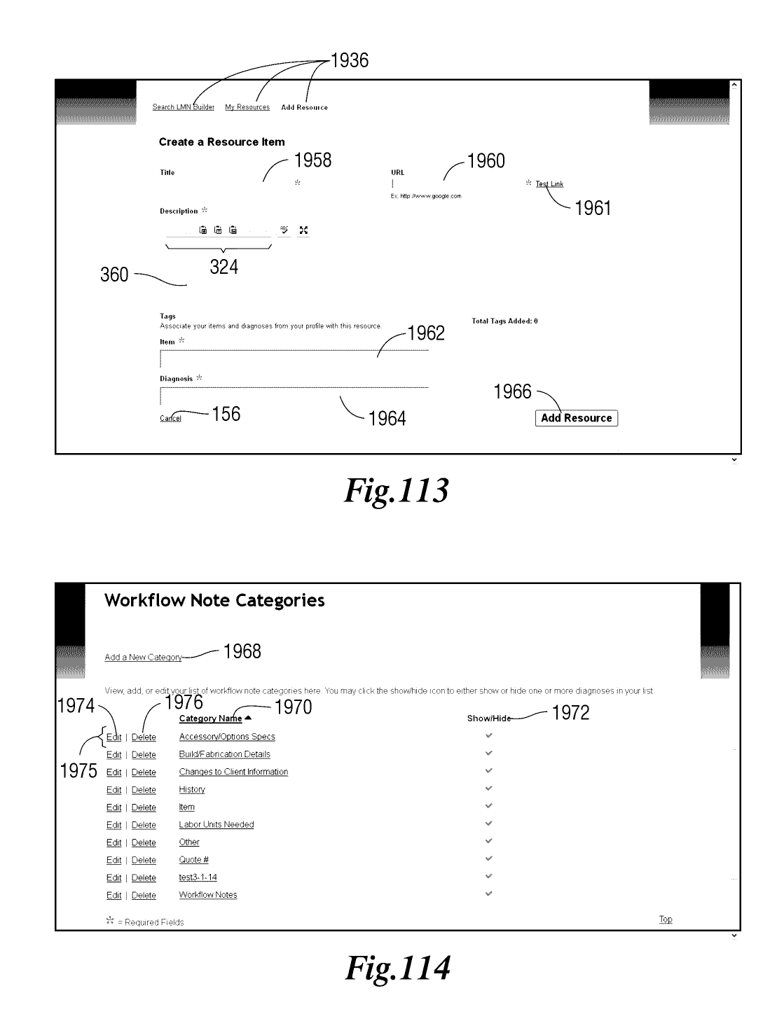

FIG. 113 depicts a sample resource creation interface, which can be utilized as a result of the add a new resource option 1950 discussed above. Here, a resource can be given a title 1958 and a URL 1960, with a form validation option to test the entered URL 1961. The URL 1960 must be deemed valid prior to being added as a resource, but some embodiments may not require such URL validation. In some embodiments, links can be periodically checked/validated, with outdated links being flagged/removed even though they were previously valid. A customized comment field can be utilized to create the resource description 360, although some embodiments can utilize regular text. Text editing options 324 can also be utilized. There can also be fields to enter the item(s) 1962 and diagnosis(es) 1964 to which the resource relates. Some embodiments can also include fields for related insurance providers. When complete, the resource can be added 1966.

Returning to FIG. 89, selecting workflow note categories 1444 can bring up a resource search interface as shown in FIG. 114. An option can be presented to add a new workflow note category 1968, along with displaying a record for each workflow note 1975. Each workflow note record 1975 can be displayed with an edit option 1974, a delete option 1976, a category name 1970, and a show/hide option/status 1972, which can be restricted to view-only based on any suitable and/or specifiable criteria. Timestamp and audit options can be presented in some embodiments.

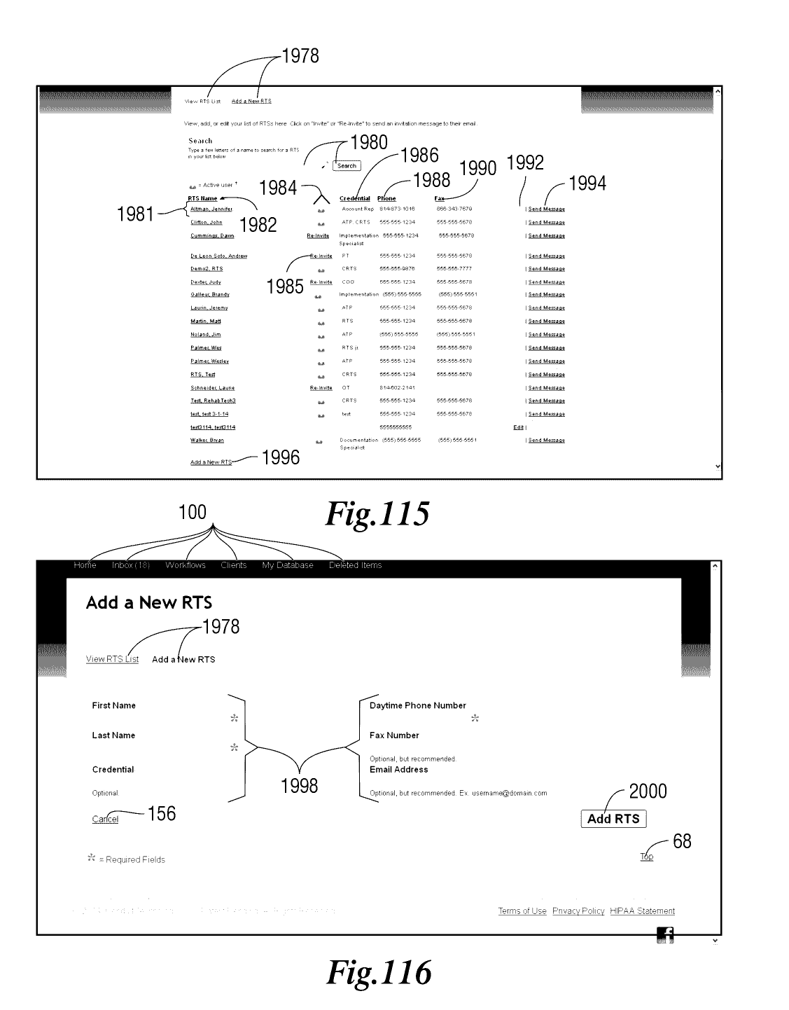

Returning to FIG. 89, selecting workflow note categories 1446 can bring up a vendor (or any other account-type) accounts listing management interface as shown in FIG. 115. Here, vendor (depicted as rehab technology suppliers, or rts) accounts were chosen, although the instant interface can apply to any other account type (clinician, physician, client, etc.). Account management options 1978 can include viewing existing accounts and creating a new account. Such options may be utilized by administrators or users, such as users designated within a company or branch to have account creation/modification/deletion rights. Here, an account search option 1980 is presented to search for vendor accounts, although some embodiments can have a role-type selection option as a search criterion. The account search option 1980 can utilize any search features and/or account information described herein. Each vendor account record 1981 can display a username 1982, account status 1984 (such as active or invited), account credentials 1986, account phone number 1988, account fax number 1990, an account edit option 1992, and an option to send a message to the account 1994. Some embodiments can also utilize an account email address. Accounts not having an active status 1984 can display an option to re-invite the account to become active 1985, which can be performed by any suitable notification type (such as electronic message and/or email, for example). Some embodiments can also present an account deletion option. An option to add a new vendor account 1996 (or any other account type) can be utilized as well.

Utilizing the add new vendor option 1996 or selecting the ‘add a new rts’ account management options tab 1978 can bring up an interface as depicted in FIG. 116. Account information fields 1998 (e.g., name, credential(s), phone/fax numbers, email address) and an add account option 2000 are presented.

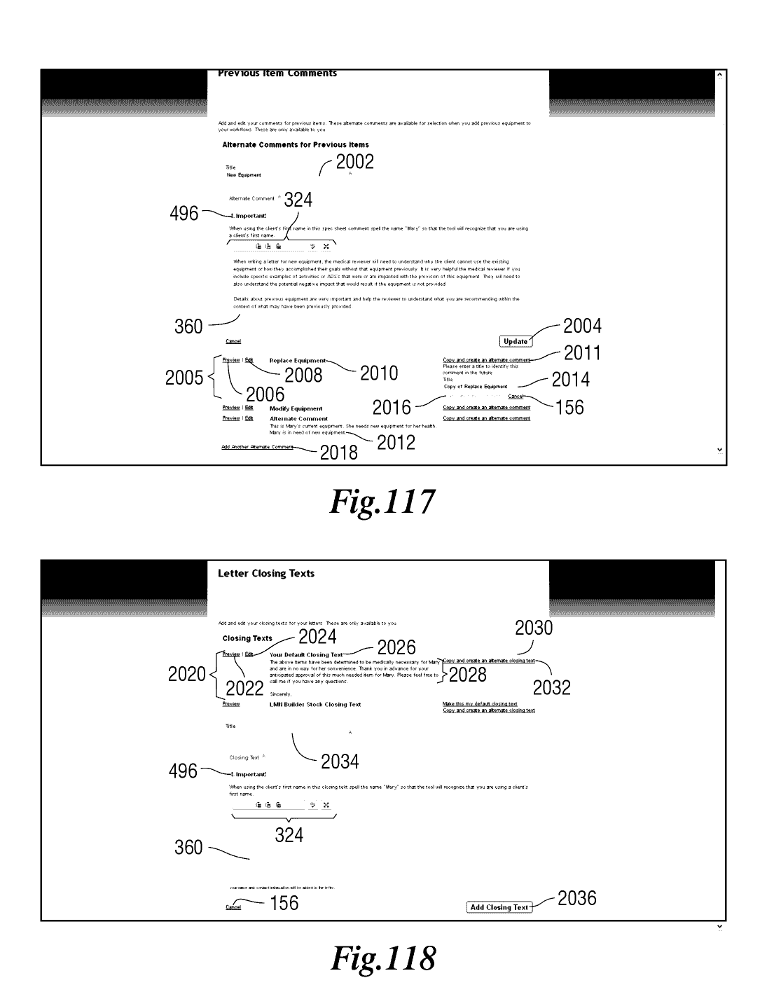

Returning to FIG. 89, selecting comment and spec sheet comment management options 1448 can bring up a previous item comment management interface as shown in FIG. 117. Alternate comments for previous items can have an entered/selected/suggested title 2002, with text editing options 324 that can be presented with a customizable comment field 360 (other text entry options can also be utilized) having an update option 2004. Stored previous item comment records 2005 can have a preview option 2006 (such as the preview text 2012 displayed for another item comment record), an edit option 2008, a displayed title 2010, and an option to copy and create an alternate previous item comment 2011 (which can require its own comment title 2014 in order to save/add as a new/alternate comment 2016). An option to add a new alternate comment 2018 is presented as well. Some embodiments can utilize any features associated with any description of a customized comment field as described herein.

Returning to FIG. 89, selecting letter closing text management options 1450 can bring up a letter closing text management interface as shown in FIG. 118. Existing closing text comments 2020 can include a closing text comment preview option 2022 (as shown by closing text body 2028) and an edit closing text comment option 2024, along with a closing text comment title 2026. Additionally, there can be options make the instant closing text comment the default closing text 2020, as well as to copy and create a new/alternate closing text comment 2032. A new/edited closing text comment can have a title field 2034, along with text editing options 324 and a customized comment field 360. An add closing text comment option 2036 can also be utilized. Some embodiments can utilize any features associated with any description of a customized comment field as described herein.

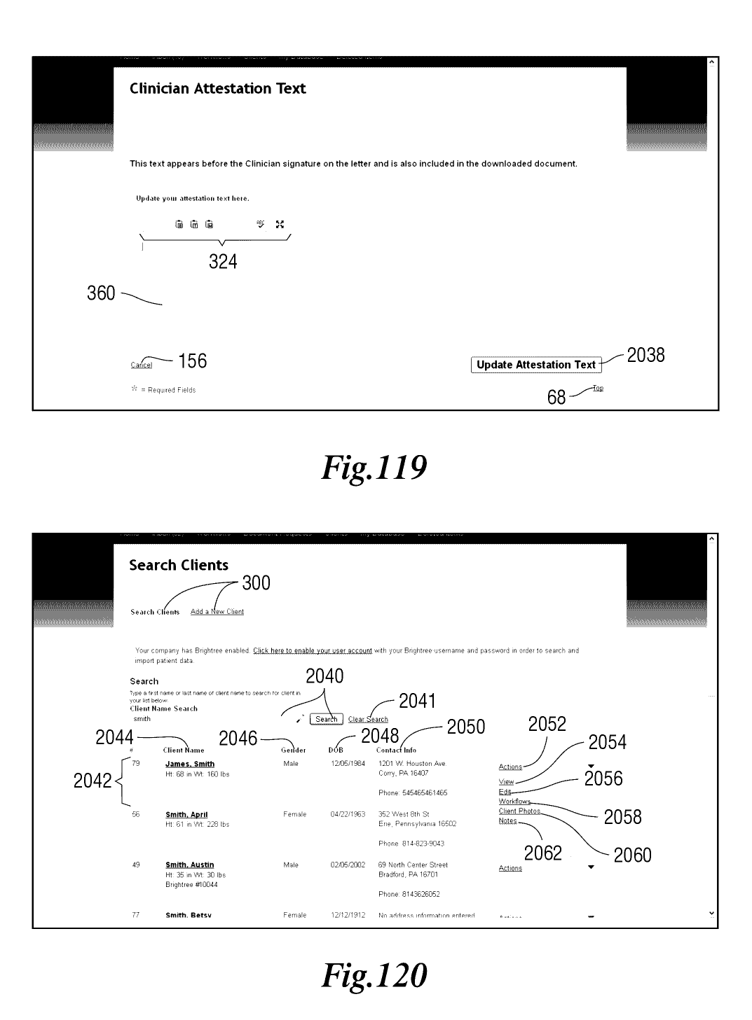

Returning to FIG. 89, selecting attestation text management options 1452 can bring up an attestation text management interface as shown in FIG. 119. Such attestation text can be used above a signature (such as a clinician's signature) associated with an account, wherein the some embodiments can apply to different account types. Text editing options 324 can be presented with a customizable comment field 360 (other text entry options can also be utilized) along with an option to create/update the account's attestation text 2038.

FIG. 120 depicts a client search interface (such as client interface options 300 in FIGS. 27-28) having a client search field 2040 (that can utilize any search options described herein) with an option to clear search text 2041. Client records 2042 that match whatever text has been entered in the client search field 2040 can be displayed in real-time as search text is entered (not shown), or upon receiving a search confirmation input 2040. Each client record 2042 can present, for example, the client's name 2044, the client's gender 2046, the client's date of birth (DOB) 2048, and client contact info 2050. Additionally, each client record can have client record actions 2052 that may include viewing the client record 2054, editing the client record 2056, viewing the workflows associated with the client 2058, viewing photos associated with the client 2060, and viewing notes associated with the client 2062.

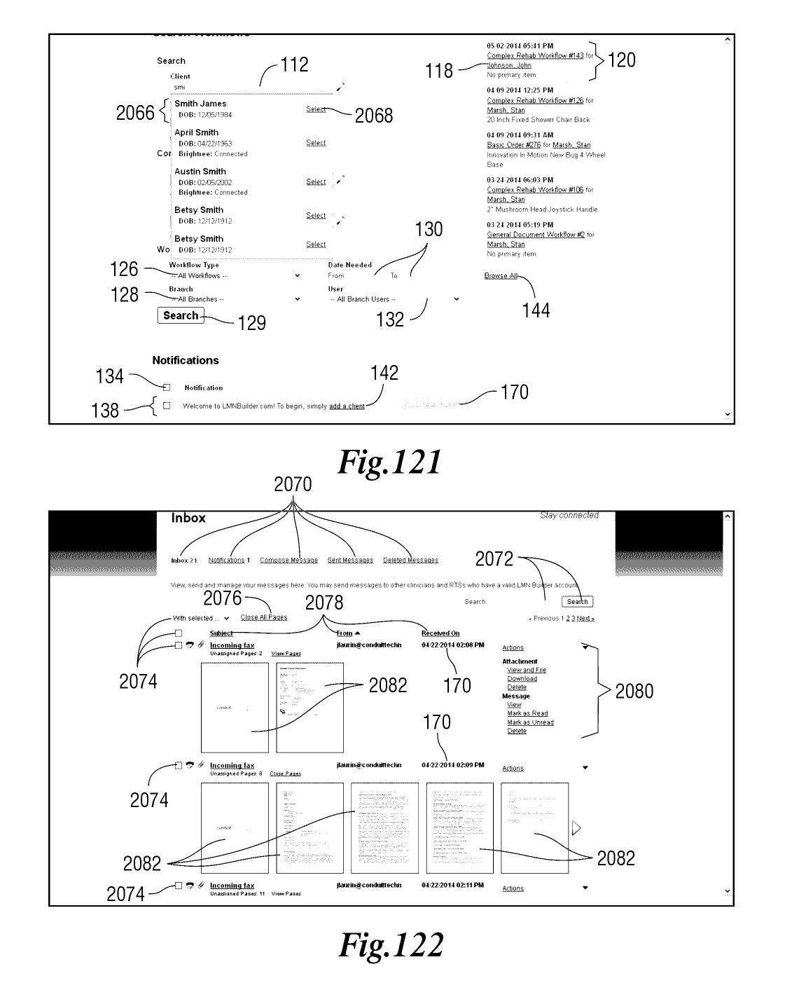

Returning to the exemplary home interface depicted FIG. 7, a client search field 112 can bring up a client search as shown in FIG. 121. Client records 2066 that match whatever text has been entered in the client search field 112 can be displayed in real-time as search text is entered, or upon receiving a search confirmation input (not shown). Each client record 2066 can present an option to be selected 2068.

FIG. 122 depicts an inbox interface having inbox options 2070 that can (for example) include a message (e.g., e-message, fax, etc.) inbox (depicted), a notifications tab (which can correspond to the notifications 138 as shown in FIG. 8), a compose new message option, a view sent messages option, and a view deleted messages option. The compose new message option can utilize a customized comment field or any other appropriate text interface, and can include recipient search options (implemented using any search techniques discussed herein), a subject, and file attachment options. The depicted message/fax inbox of the exemplary inbox interface can include message search options 2072 which can be implemented using any techniques discussed herein. Message selection options 2074 can include marking a message as read, marking a message as unread, flagging a message for deletion, copying and/or forwarding, as well as a check-all/none master checkbox. A view-all/close-all pages option 2076 can be utilized to display all messages (on a given page of viewable messages) in either a preview view that displays message document thumbnails 2082 or a closed (compact) view. Message sorting options 2078 can include message subject, message sender, and a receipt timestamp 170. Message action options 2080 can include viewing the instant message, marking the message as read, marking the message as unread, and deleting the instant message. Message action options 2080 can further include attachment options such as viewing, downloading, and deleting an attachment associated with the instant message.

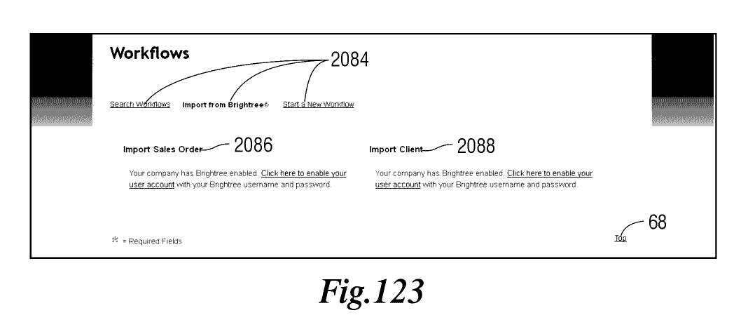

FIG. 123 depicts a workflow management interface that can include options to search existing workflows (an example being depicted in FIG. 7), import a workflow, and start a new workflow (an example being depicted in FIG. 43). Options for importing a workflow can be accomplished, for example, by importing a sales order 2086 and/or importing a client 2088 from or other data sources or external databases, such as BRIGHTREE®. The workflow management interface can restrict workflows shown according to workflow type, such as complex rehab workflows, basic orders, general document workflows, specification sheets, assessments, repairs, respiratory, and O & P.

Some embodiments utilize workflow templates that can serve as the basis of any number of workflows, wherein such workflows can then be customized (after being generated based on a workflow template). For example, workstates, steps, tasks, teams, team members/users, triggers, client assessments, equipment, and/or client measurements can be used to build a workflow template. A workstate can comprise steps, which in some embodiments can be a series of linear dependencies/requirements, whereas there can be interdependencies among steps in other embodiments. Further, in some embodiments, a step can comprise one or more tasks. In some embodiments, tasks can include, for example, obtaining a signature, verifying data, and/or sending a form/template. Each constituent part of a workflow template can have an associated temporal component (time limit/tracker). In other embodiments, any workstate can comprise one or more tasks without utilizing steps. The terms ‘form’ and ‘document’ can be utilized interchangeably throughout.

In some embodiments, each workflow template can have triggers, of which one or more must be satisfied to utilize the workflow template to serve as the basis for the instant workflow. A workflow template can be selected/de-selected automatically in some embodiments as the underlying data associated with the instant workflow changes. In one example, having a certain insurer, diagnosis, piece of equipment, client, etc., can cause a workflow template to be utilized or removed (if the workflow and/or workflow template no longer satisfies required trigger(s)). In some embodiments, each workstate and/or workstate template can have triggers, of which one or more must be satisfied to utilize the workstate template to serve as the basis for the instant workflow, whether or not a workflow template serves as its basis. In some embodiments, a given workflow template, workstate, or workstate template can be a subset of another respective workflow template, workstate, or workstate template. Despite the inherent overlap among a subset and a set (such as for triggers, for example), they can be treated as mutually exclusive for selection purposes, such that satisfying a trigger only present in the set (i.e., the larger workflow template, workstate, or workstate template) can automatically remove the subset (i. e., the smaller workflow template, workstate, or workstate template), even though it is still satisfied, and vice versa. For example, removal/dissatisfaction of any triggers that previously satisfied the set (but not the subset) can cause the subset to suddenly be utilized, as the subset was not previously utilized (even though the subset was already satisfied).

Some embodiments can utilize workstates to measure progress towards completing a workflow. Workstates can include tasks (whether or not delegated) to be completed, documents to be completed, appointments (such as client evaluations) to be completed, which role(s)/account(s) have been assigned to a task, the task's deadline for completion (‘get it done by’ date), and the next work-in-progress state. A workflow can thus be mapped out as a series of interdependencies/workstates in any manner, such as visually in a graphical dashboard interface. A workflow template can have one or more workstates, wherein some embodiments require one workstate to be completed before beginning another workstate. For example, a workflow template can require: workstate 1 must be completed prior to beginning workstate 2, workstate 2 must be completed prior to beginning workstate 3, and so on. Each workstate can have/require one or more steps. For example, steps 1-3 in workstate 1 may require completion prior to moving on to workstate 2. Other embodiments, however, may permit another workstate to begin upon completion of steps within a prior workstate. For example, step 3 in the workstate may be optional (or at least may not be as time-sensitive as other steps, wherein step 3 with a deadline extending beyond the start time of a subsequent workstate in some embodiments). In such a scenario, as long as steps 1 and 2 are completed within workstate 1, then workstate 2 could begin even before workstate 1 would be completed.

A step may comprise one or more tasks, such that a step may only be completed once some or all of its constituent tasks are completed. For example, before proceeding to step 2 within workstate 1, tasks 1-3 in step 1 may require completion. Tasks may also be grouped within a step, such that all steps are being worked on simultaneously. Some embodiments can utilize, even within the same workstate, some steps that require linear progression through their constituent tasks, with other steps permitting their constituent tasks to be completed in any order. Still further, some steps may have only certain task restrictions (task 4 cannot begin until task 2 is complete, with no bearing on any other task within the step). For example, task 1 of step 2 may have a dependency that requires tasks 1-2 to be completed first. Although step 1 may have its own time limit for completion of all its constituent tasks, step 2 may permit its task 1 to begin once tasks 1-2 have been completed (by the same or a different user) in step 1, even though subsequent tasks (tasks 3, 4, etc.) in step 1 have not been completed or even begun.

In some embodiments, users can be formed into teams. An administrator, supervisor, or any other appropriate user can manage teams (their creation, editing, removal, etc.), a team can be spread across branch locations, or limited to particular branch. Some embodiments can allow users to form their own teams, as well as request time off or block-off time (such as an upcoming vacation) so that teams and workloads can be recalibrated ahead of time, depending on varying availability of users. Depending on load-balancing and other factors, a user may belong to more than one team, although some embodiments may limit a user to only one team. A team can comprise roles, specific users, subgroups of users, or any combination thereof, wherein a user can have more than one role (even within the same team) in some embodiments. Some embodiments can also run conflict-checks regarding which roles a user can have (e.g., being a member of role 1 may preclude a user from also having role 2, which could be due to a conflict of interest between such roles) or what teams a user can be a member of. For example, one team may specify user1, user2, and user3. Another team may specify any user having roles such as oxygen specialist, bed specialist, and wheelchair specialist. Yet another team may comprise: (a) user1, (b) any user having the role of bed specialist, and (c) a member selected from a subgroup (user4, user5, user6). Some embodiments can permit specifying that a team member can have any of a plurality of roles, instead of just being limited to a single role, wherein some embodiments may permit an order of preference among a plurality of roles (and/or users), wherein such preferences can be manually specified or based on ratings information. Any criteria can be applied to groups, such as users meeting certain pendency/timeliness requirements, physical location, amount/level of experience, quality rating, probationary status, user/role/team workload/utilization (such as for load-balancing purposes). Users can also be assigned permissions, so that a team, step, and/or task can utilize only those users and/or roles having certain permissions.

In some embodiments, steps and tasks can be delegable, wherein such delegation may be required (workstates and/or workflow templates can store such delegation requirements). Once delegated, a pending task (such as completing required fields in one or more assigned document templates) can cause reminders to be sent to the delegator (and/or previous delegators) and/or the delegatee (and/or subsequent delegatees), to in order preemptively avoid bottlenecks/hold-ups in the workstate and/or workflow. For example, user1 may have a vendor-type account as a supervisor at a branch location of a company, who delegates two document templates (form1 and form2) in a workflow to a subordinate, user2 (either at the same or a different branch within the company). Each document template can have its own deadline date, along with the workflow having its own master deadline as well. User1 can receive notifications regarding each document template any time one is thereafter re-delegated, updated, completed, transferred, modified, or has any type of loggable/trackable event occur. Some embodiments permit users to specify which types of events (which can be customized for each form template type and field type as well) regarding a template document will trigger alerts to their accounts (or the accounts of others, such as subordinates/peers/superiors/delegators/delegatees/etc).

Continuing with this example, user1 receives a notification that form1 has been sent to a physician's account (physician1) by user2, and that form2 has been sent/delegated to a clinician's account (clinician1) by user2. User1 receives notifications when physician1 completes their portion of form1. When form1 is returned to user2 (after either passing form validation requirements or a notice that physician1 cannot complete form1), this causes notifications to user1 and user2, with user2 subsequently returning form1 to user1 (or form1 can automatically be returned to user1 upon satisfying or failing its present requirements), who can re-delegate form1 as necessary (such as to a peer, a supervisor, a different subordinate, or users having any appropriate role type). All document template transactions, such as delegation and completion, can appear in an audit option (discussed below), which can serve as the basis for customizable notifications. In some embodiments, any user can specify, customize, and modify the types of notifications they receive, as well as alert thresholds. Some embodiments allow users to specify whether a document template is delegable, to whom it is delegable, and delegation restrictive/permissive criteria (such as time, location, a minimum user rating that indicates promptness and/or trustworthiness ratings to filter the users to which delegation can be assigned (automatically or manually), wherein such ratings can be peer-based, etc.) User1 is alerted when form2 is delegated to a different physician account (physician2) after clinician1 completes their required portions of form2. Form2 may be have been delegated directly from clinician1 to physician2, or alternatively, clinician1 may have returned form2 to user2, who subsequently delegated it to physician2. Another possibility is that user1 or user2 may have set up a document template ‘path’ whereupon clinician1's completion of their portion(s) of form2, form2 is automatically forwarded from user2 to physician2, based on the preset path specified by user1 or user2. Such features are discussed in more detail below with respect to workstates and workflow templates.

Continuing with the instant example, user1 and/or user2 can be alerted when a deadline threshold, such as three business days (calendar days can also be specified, or any other unit(s) of time) until a deadline (regarding for form2, the workflow, and/or any interceding documents in the dependency chain) is reached. User1 can specify (in some embodiments) which types of alerts they receive, since a supervisor may not want preliminary warnings/status updates that are being handled by a multitude of reliable subordinates like user2. Some embodiments may remove a workflow/workstate from a user's list of tasks once that user has delegated all document templates in a workflow/workstate, wherein the workflow/workstate may be reappear on the user's list of tasks once a delegated task is completed. Further, any suitable type of graphical dashboard interface can be utilized to assist a user in tracking all their tasks and delegated tasks. Continuing with this example, form1 can have fields that are only viewable/editable by a clinician, as well as fields that are only viewable/editable by a physician. Some embodiments can permit access to such restricted fields to more than one role (such as by only either a physician or a clinician). Some embodiments may permit the specification of not only the role-type to which a field is visible, but also specified users within a role-type, such as specific clinicians or specific physicians. This may (but not necessarily have to) include clinicians and/or physicians associated with the instant workflow. Any such data can be stored in, for example, a workstate, workflow, workstate template, or workflow template.

Continuing with this example, if physician2 has forgotten about form2 and the deadline for form2 has elapsed (or exceeds any alert threshold, including warnings about approaching deadlines), notices (like overdue alerts) can be sent to all users affiliated with form2 (user1, user2, and physician2). Conversely, clinician1 would not be alerted in this instance, as they were not involved (yet or at all) with form2, even if their signature would be needed subsequent to physician2's signature or other input coming first in the chain of dependency). Moreover, some embodiments can restrict delegation authority based on role-type, company, and/or branch, as well as any rights associated with the user's account, branch, location, and/or any other criteria with which rights can be associated.

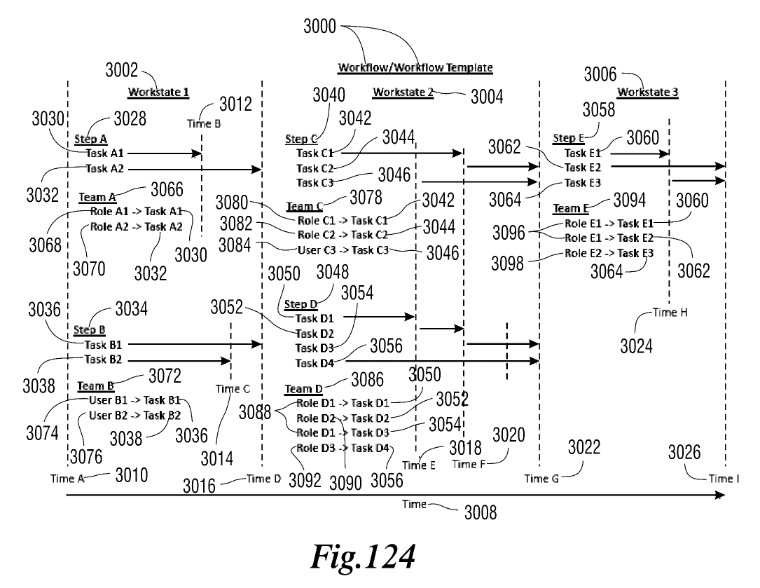

An example of a workflow and/or workflow template 3000 (either of which are termed a “workflow” for convenience in this non-limiting example) is provided in FIG. 124. This workflow 3000 comprises three workstates 3002, 3004, and 3006. Although these workstates are strictly linear in this example, in some embodiments they can overlap, such that not all steps and/or tasks within a workstate need be completed prior to the next workstate beginning. Some embodiments may permit users/administrators to specify overlapping exceptions to such a linear workflow nature. Other embodiments may accept input specifying dependencies and rules for some or every step and/or task within each workstate.

Within each workstate may be one or more steps that can each further comprise one or more tasks. One or more users (such as in a team) can be assigned to a workstate, a step, and/or a task. For example, within workstate 1 3002, there are steps A 3028 and B 3034. Step A 3028 has two tasks, A1 3030 and A2 3032, which both have a start time A 3010, but with each task having a different deadline. Task A1 3030 must be completed by time B 3012, whereas task A2 3032 must be completed by time D 3016. As will be readily understood by temporal axis 3008, time D 3016 is subsequent to time B 3012, for example. Each task can be assigned to a role-type or a specific user. Some embodiments may permit users to submit requests that they receive (or be delegated/docketed) specific tasks and/or steps, and/or to see all/some available steps/tasks that meet a user's specified criteria from which they can select one or more steps/tasks. In some embodiments, a user can query available work for which they are qualified. Some embodiments may permit a user to see what types of work they would be eligible for after a promotion or assuming a new role/credential. Some embodiments may allow steps/tasks to be assigned to users in this way without requiring approval, or may allow certain users to be designated as not requiring approval based on any suitable criteria (such as seniority, performance ratings, etc.). Here, team A 3066 can either exist persistently or just for the duration of the specific tasks, steps, workstates, workstate templates, workflows, and/or workflow templates. Team A 3066 comprises a user of role-type A1 3068 assigned to task A1 3030, which they must complete by time B 3012. Team A also assigns a user of role-type A2 3070 to task A2 3032, which has a completion deadline of time D 3016.

Within workstate 1 3002, step B 3034 comprises task B1 3036 having a completion deadline of time D 3016 and task B2 3038 having a completion deadline of time C 3014. Team B 3072 is assigned to step B 3034. Unlike team A 3066, which only requires users having certain user role-types (without specifying specific users, although specific user data is stored within the team and elsewhere), team B 3072 comprises specific users, with user B1 3074 being assigned to task B1 3036 and user B2 3076 being assigned to task B2 3038. Some embodiments can permit alternate users to be designated in case the specified user is/becomes unavailable prior to or during the task/step/workstate/workflow. Some embodiments may permit selection of a specific group of users, who may or may not have membership with respect to a particular role (wherein some embodiments permit users in more than one role, or conditional membership wherein a user can temporarily have membership in a role, such as when the number of available users within a role drops below a certain threshold). Some embodiments can permit one or more users to be designated as being available to fill-in for spots on the team there are not enough users having a role-type available and/or not enough users within a role-type that meet minimum threshold measures (such as quality, timeliness, etc., wherein a task/step/workstate/workflow can specify that all/some users/teams/roles must (or at least should under normal circumstances) meet certain threshold criteria due to the importance of such a task/step/workstate/workflow).

Workstate 2 3004 comprises step C 3040 and step D 3048. Step C 3040 comprises task C1 3042 having start time of time D 3016 and required completion time F 3020. Some embodiments can designate a completion/start time D 3048 having a fixed date/time. Other embodiments may define time D 3048 to be the time at which all steps/tasks within workstate 1 3002 are completed and therefore automatically starting the clock for tasks/steps in workstate 2 3004 having a start time of time D 3016 (although a buffer of time can be specified/defined for time D 3016 as well, so that the clock starts on workstate 2 3004, for example, an hour after workstate 1 3002 is completed, wherein this concept can apply to any dependencies or inter-dependencies described herein). Here, only tasks C1 3042, D1 3050 and D4 3056 start at time D 3016. By contrast, tasks C2 3044, C3 3046, D2 3052, and D3 3054 start later, and can, for example, start at a defined start time or start once another step/task has been completed.

Task C1 3042 has a start time D 3016 and a deadline of Time F 3020. Task C2 3044 can begin at time F 3020 and have a deadline of time G 3022. In some embodiments, task C2 3044 can begin immediately once one or more tasks (such as task C1 3042) have been completed. Other embodiments can begin task C2 3044 at a fixed time F 3020 even if task C1 3042 has been completed prior to time F 3020. Some embodiments can also include a “buffer” time which can require passage of a specified amount of time to pass once a step/task has been completed until another step/task can begin. Some embodiments can utilize combinations of dependencies, fixed beginning times, and/or buffers. A buffer can also be a minimum/maximum amount of time, subject to when the prior step/task is completed, relative to the next step/task. There can also be deviation from a default buffer value. For example, a buffer (of a day, for example) can be applied if the first step/task is completed more than one day prior to a defined start time of another step/task, but if the first step/task is still pending or completed with less than the buffer time (a day), then the buffer does not apply and the other step/task can begin immediately or at its default scheduled start time. In some embodiments, a later-starting task like C2 3044 can similarly depend on the completion of steps in another task, such as task D2 3052, which itself may or may not depend upon completion of task D1 3050. Task C3 3046 begins at time E 3018, which does not depend on the completion of tasks C1 3042 or C2 3044, although it could depend on the completion of task D1 3050 in step D 3048. Step C can be assigned to team C 3078, which utilizes a mixture of assignments to a specified user as well as to roles (i.e., any user having such a role, subject to other restrictions). Task C1 3042 is assigned to a role-type C1 3080, task C2 3044 is assigned to a role-type C2 3082, and task C3 3046 is assigned to a specific user C3 3084.

Step D 3048 comprises tasks D1 3050, D2 3052, D3 3054, and D4 3056. Task D1 3050 has a start time of time D 3016, which may or may not coincide with the completion of steps A 3028 and B 3034. Task D1 has a completion deadline of time E 3018. Task D2 3052 has a start time E 3018 (which could differ from the actual start time for task C3 3046 if it begins immediately following the completion of task D1 3050 whereas task D2 3052 may begin at a specified time, and wherein time E 3018 could mean: a specified time, the latest of the completion times of one or more preceding tasks, or both, thus (in some embodiments) being relative to each task). Task D3 3054 has a start time of time F 3020, with a deadline of time G 3022, wherein initiating task D3 3054 may depend upon completion of task D2 3052, which may depend upon the completion of task D1 3050. Task D4 3056 can have a start time of time D 3016 and a completion deadline of time G 3022.

Step D 3048 can be assigned to team D 3086 which comprises roles D1 3088, D2 3090, and D3 3092. Tasks D1 3050 and D3 3054 are assigned to role-type D1 3088. Some embodiments can assign the same user within role-type D1 3088 to both tasks D1 3050 and D3 3054. Other embodiments can require that different users (if desirable and/or not impracticable, due to either a lack of such users within the role, or other users having too much of a workload at the moment) within role-type D1 3088 be assigned to each of tasks D1 3050 and D3 3054. Other embodiments may not specifically require the same or a different user within a role-type for different tasks/steps, regardless of whether they overlap in time or not. Task D2 3052 is assigned to role-type D2 3090 and task D4 3056 is assigned to role-type D3 3092. Any role-type described herein can be a subset of any other role-type (such as role-type D3 3092 being a subset of role-type D2 3090, wherein role-type D2 3090 includes all users in role-type D3 3092, but not vice-versa).

Workstate 3 3006 comprises step E 3058, having a start time of time G 3022 and a completion deadline of Time I 3026. Step E 3058 comprises tasks E1 3060, E2 3062, and E3 3064. Task E1 3060 has a start time of time of Time G 3022 and a deadline of Time H 3024. Task E2 3062 has a start time of Time G 3022 and a deadline of Time I 3026. Task E3 3064 has a start time of Time H 3024 and a deadline of Time I 3026. Task E1 3060 may require completion prior to initiating task E3 3064.

Step E 3058 is assigned to team E 3094, which comprises role-types E1 3096 and E2 3098. Tasks E1 3060 and E2 3062 are assigned to role-type E1 3096 and task E3 3064 is assigned to role-type E2 3098. Completion of workstate 3 3006 can result in the initiation of a subsequent workstate (not shown) or in the completion of the workflow 3000.

Some embodiments can also utilize a graphical dashboard interface so that users and/or administrators can track workflows along with workstates, steps, and tasks within each workflow. For example, a user or administrator could set threshold time limits to change from green (up to 2 weeks before the deadline) to yellow (1-2 weeks before the deadline) to orange (1 week until the deadline) to red (deadline exceeded). Any change in status could trigger notification to the user, their supervisor(s), administrators, or other designated users/administrators in an organization or company (or other designated users/administrators outside the organization or company). Any type of reporting and/or metrics can be run based upon a user's performance (or the performance of multiple users, such as a designated group or team), such as average pendency across all (or a subset) of workflows/workstates/steps/tasks to which they have been assigned. Some embodiments can utilize reporting having a continuous query language (CQL) implementation, wherein a query is long-lasting (or permanent/persistent), wherein results are updated in real-time (or periodically) as new data becomes available and is fed through the query. For example, a continuous query can be established that updates in real-time (or periodically, such as weekly, for example) the top-n performing employees according to their aggregate timeliness, where n can be any positive integer. As updated data regarding each employee's timeliness is received, the persistent query can update the results anytime there is a change in the rankings, or based on a specified periodicity. Such CQL reporting can be implemented in any interface described herein, for any data described herein.

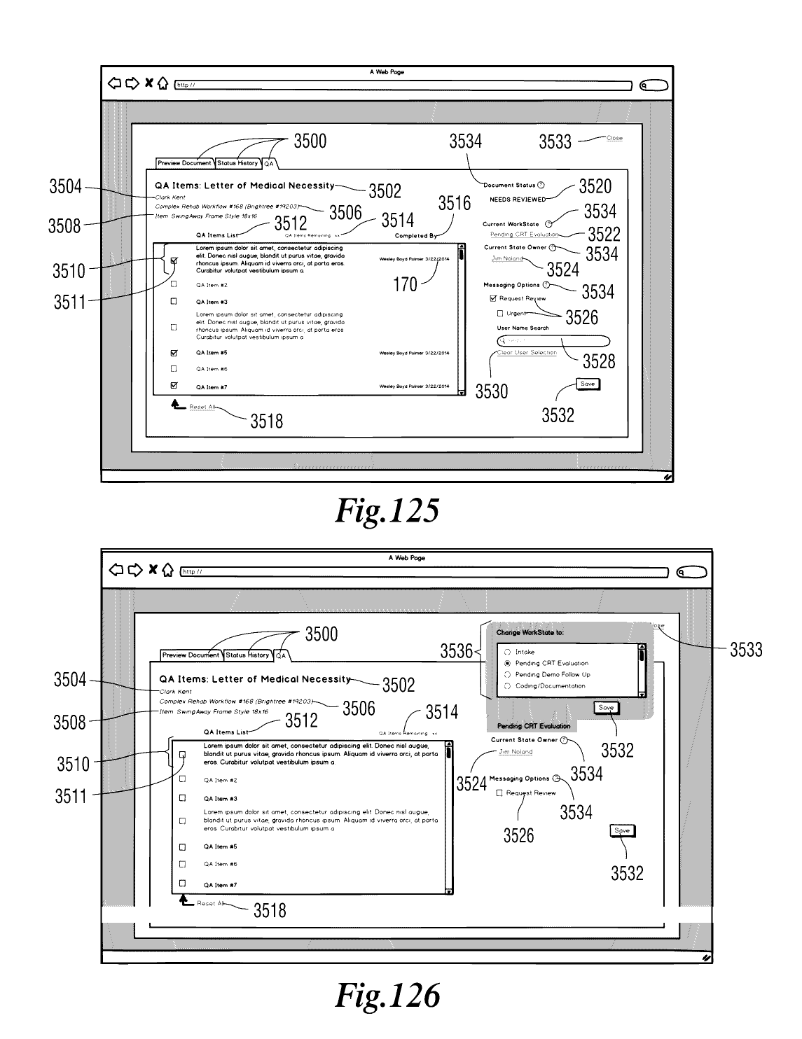

FIG. 125 is an example of a QA item status review interface for a workstate or workflow. Display tabs 3500 include options to preview a document, check status history, and manage QA items. Under the QA tab, for example, the current document title 3502 can be listed, along with the client name 3504, workflow name 3506, and the current equipment item 3508. Some embodiments utilize a similar interface for QA items associated with equipment items (instead of, or along with, QA items for documents). Each QA item record 3510 can be selected with any appropriate indicator, displayed here as a check-box 3511, along with an option to reset all available checkboxes 3518. The number of QA items remaining 3514 can be displayed as well. Each QA item record 3510 can be displayed with a QA items list 3512 which can include textual and/or graphical descriptions of QA items and a completed by 3516 indicator that can indicate the user that completed the QA item along with a completion timestamp 170. Current document status 3520 can include any appropriate status such as ‘needs review’ or ‘reviewed,’ for example. The current workstate 3522 within the current workflow 3506 can also be displayed. The current workstate owner 3524 can also be displayed. In some embodiments, a workstate owner can create/edit teams for step/task assignment within the workflow, and may also be able to specify deadlines, start times, dependencies, etc. Messaging options 3526 can include requesting a review and further specifying the request as urgent. An option can also be presented to search for a recipient name 3528 among a listing/directory of users, although any suitable entry/search interface can be utilized, including manual name entry and auto-complete/suggestions. User name search input can also be cleared 3530 at any time. When ready, the data in the QA item status review interface can be saved 3532. Alternatively, the QA item status review interface can be closed 3533 without saving the data. Various help indicators 3534 can also be utilized to clarify any such options.

FIG. 126 continues with the present embodiment by depicting an example of a workstate change interface. By selecting the current workstate 3522 as shown in FIG. 125, selectable workstates 3536 are presented, shown to be (for example) ‘intake,’ ‘pending CRT evaluation,’ ‘pending demo follow up,’ and ‘coding/documentation.’ Once selected (or manually inputted in some embodiments), the updated workstate can be saved 3532.

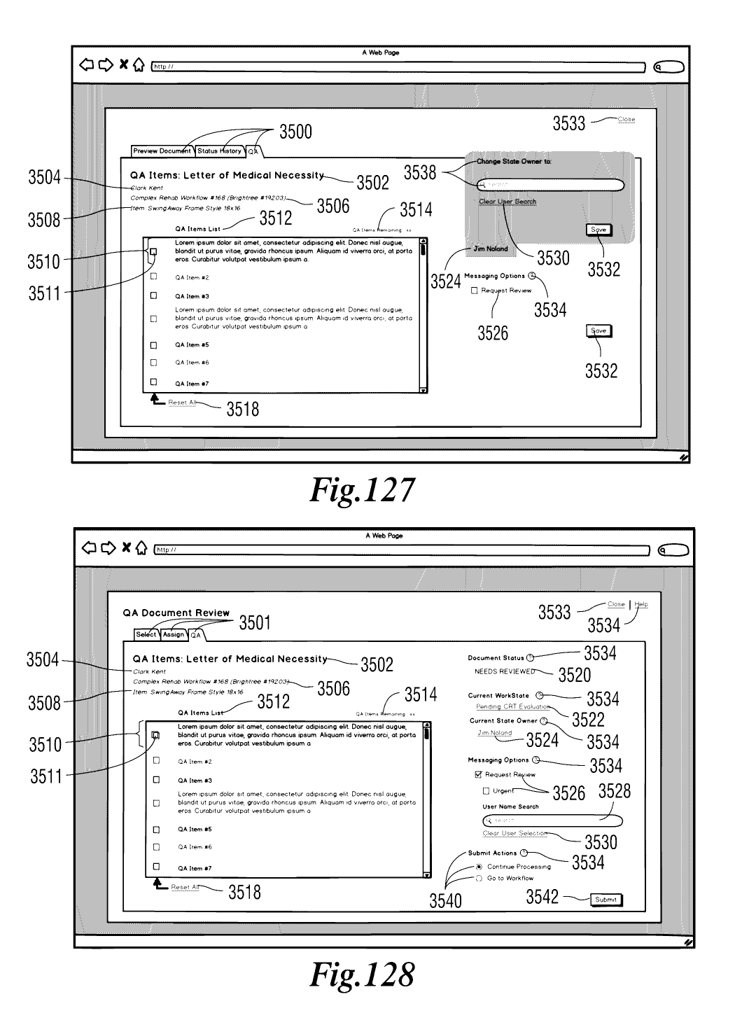

FIG. 127 continues with the present example by depicting a change in workstate ownership. By selecting the current workstate owner, as shown by 3524 in FIGS. 125-126, an option can be utilized to change the workstate owner, for example, by searching for another user to be assigned workstate ownership 3538, while the current workstate owner 3524 can also be displayed. An input-clearing option 3530 can also be presented to clear any text in the workstate owner search field 3538, along with a save option 3532.

FIG. 128 shows another embodiment with respect to FIG. 125, with QA item submission tabs 3501 that can include selection, assigning, and QA options. This embodiment displays submit actions 3540 that can include, for example, ‘continue processing’ and ‘go to workflow’ to govern what happens once a submit indicator 3542 is selected.

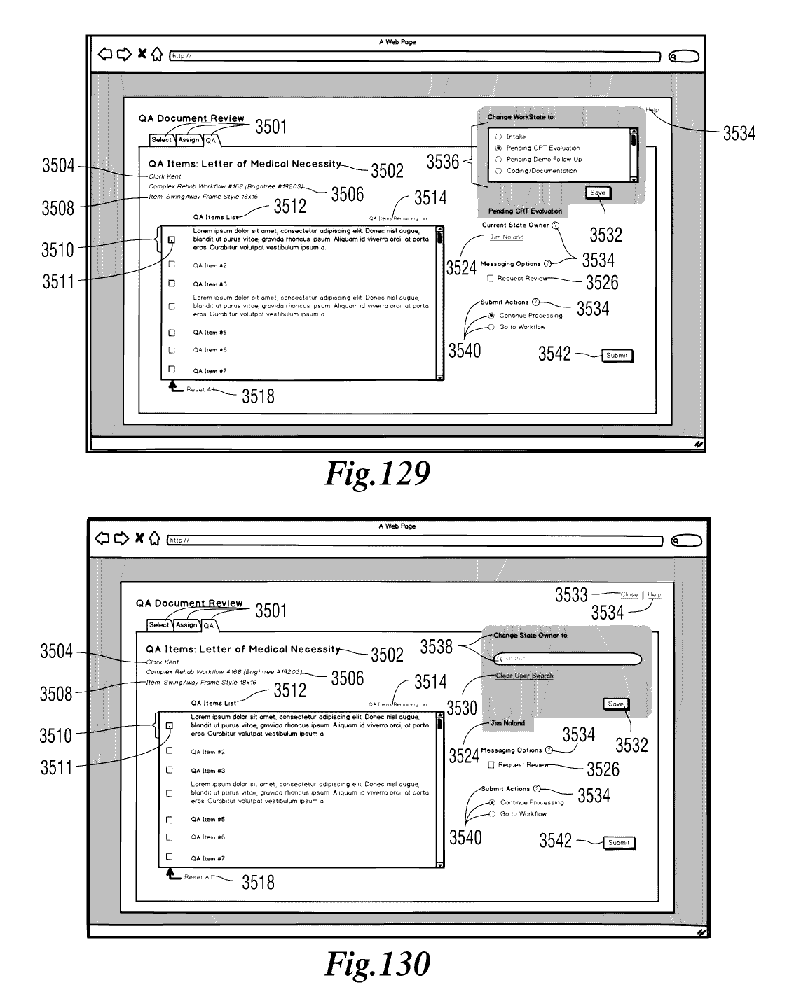

FIG. 129 shows another embodiment with respect to FIG. 126, with submit actions 3540 that can include, for example, ‘continue processing’ and ‘go to workflow’ to govern what happens once a submit indicator 3542 is selected.

FIG. 130 shows another embodiment with respect to FIG. 127, also having submit actions 3540 that can include, for example, ‘continue processing’ and ‘go to workflow’ to govern what happens once a submit indicator 3542 is selected.

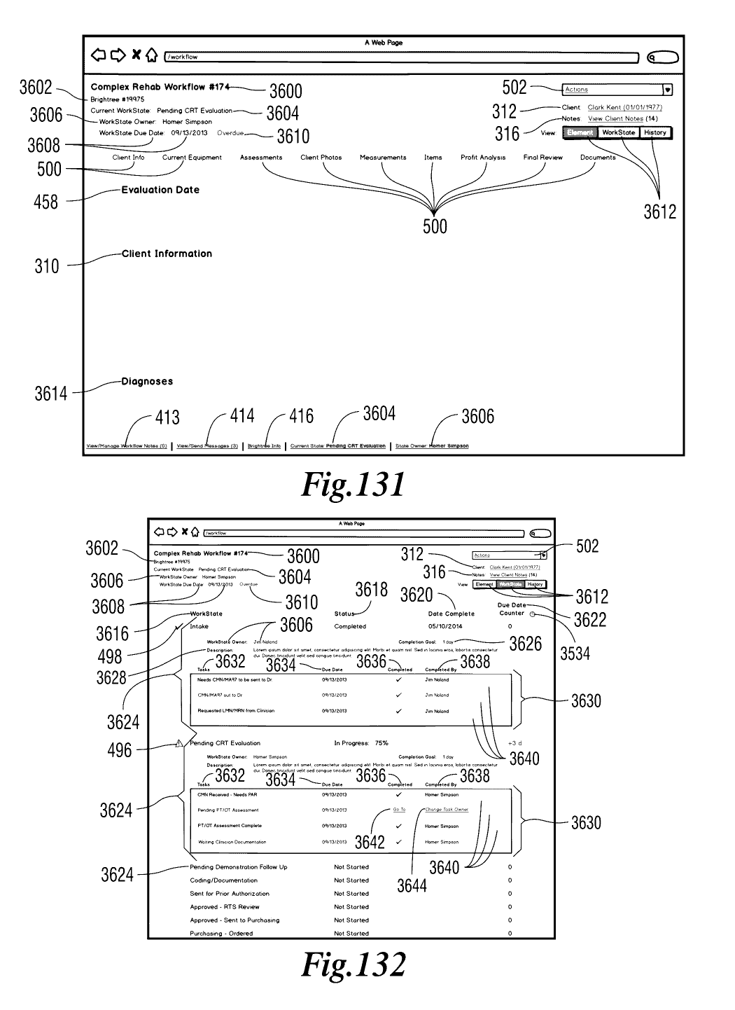

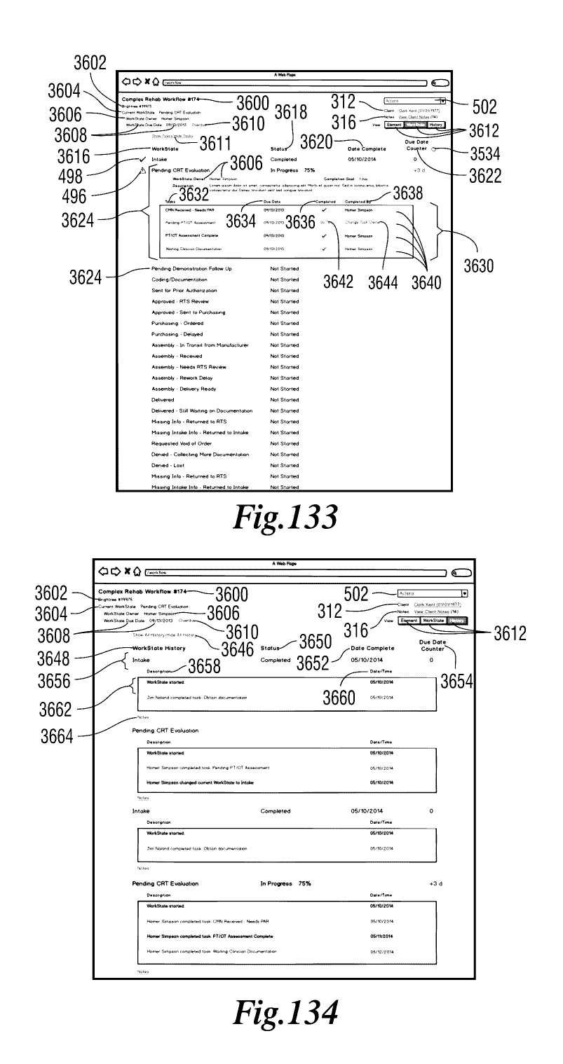

FIG. 131 depicts an element view of a workflow. The workflow title (and/or number) 3600, outside database/data source (here BRIGHTREE®) title/number 3602, current workstate 3604, workstate owner 3606, workstate due date 3608, and workstate status 3610 (such as ‘overdue’) can be displayed. Workflow actions 502 can include changing the workflow status or date needed, for example, as well as an option to delete the current workflow. A client display 312 can be utilized, which in some embodiments can bring up any client information interface described herein. Additionally, a notes selection option 316 can be utilized, which can bring up any notes interface described herein, such as the example depicted in FIG. 30. Workflow view options 3612 can include an element view (depicted here in FIG. 131), a workstate view (depicted in FIGS. 132-133), and a workstate history view (depicted in FIG. 134). Workflow interface options 500 can include, for example, accessing workflow data, here shown as tabs, comprising client info, current equipment, assessments, client photos, measurements, items, profit analysis, final review, and documents, for example. Here, data can be presented under the client info tab 500 relating to a client evaluation date 458, the client's information 310, and the client's diagnosis data 3614 (which can utilize or be similar to any diagnosis interface described herein). Further options, depicted here at the bottom, can include view/manage workflow notes 413 (which can utilize any notes interface described herein), view/send messages 414 (which can bring up a workflow messaging interface as depicted in FIG. 42, or any other suitable interface), outside database/data source info 416 (which can be used for connection to BRIGHTREE®, for example), current workstate 3604, and workstate owner 3606.

FIG. 132 is an illustration depicting a workflow with expanded workstates utilizing a workstate view 3612. For each workstate record 3624, the workstate name and/or type 3616, the workstate status 3618 (such as completed, not started, in progress, overdue, etc.), date complete 3620, and due date counter 3622 can be displayed. For a selected workstate 3624, information regarding, for example, the workstate owner 3606, a completion goal 3626, and a workstate description 3628 can be displayed. Additional information related to the records of each step and/or task 3640 within the workstate 3630 can be displayed. For each step/task record 3640, information can be displayed regarding (for example) the step/task name 3632, the step/task due date 3634, a completion indicator 3636, and a completed by indicator 3638, which that indicates the identity of user that completed the step/task (if completed). If a step/task is not yet complete, options can be presented to view more detailed step/task information 3642 and to change the step/task owner 3644.

FIG. 133 continues with the current illustration of a workflow with expanded workstates utilizing a workstate view 3612. This shows one completed workstate step/task 3624 ‘intake’ and one selected/expanded workstate 3624 ‘pending CRT evaluation’ having three completed steps/tasks 3640 (‘CMN received—needs PAR,’ ‘PT/OT assessment complete,’ and ‘waiting clinician documentation’) and one incomplete step/task 3640 (‘pending PT/OT assessment’) with options to go to a more detailed view of this incomplete step/task 3642 and to change the step/task owner 3644. In this embodiment, a single incomplete step/task 3640 (‘pending PT/OT assessment’) prevents the workstate 3624 (‘pending CRT evaluation’) from being complete (as indicated graphically 496), which in turn can prevent the workflow 3600 from being complete, even if all other workstates 3624 have been completed.

FIG. 134 is an illustration depicting a workstate history view 3612 of a workflow. An option can be utilized to show all or hide all history 3646. Each workstate's name 3648, status 3650 (e.g., completed, in progress, overdue, not started), date/time completed 3652, and due date counter 3654 can be displayed, for example. Within each workstate 3648, each step/task record 3662 can be displayed with its description 3658 and date/time completed 3660. Additionally, workstate notes 3664 can be viewed utilizing any notes interface described herein.

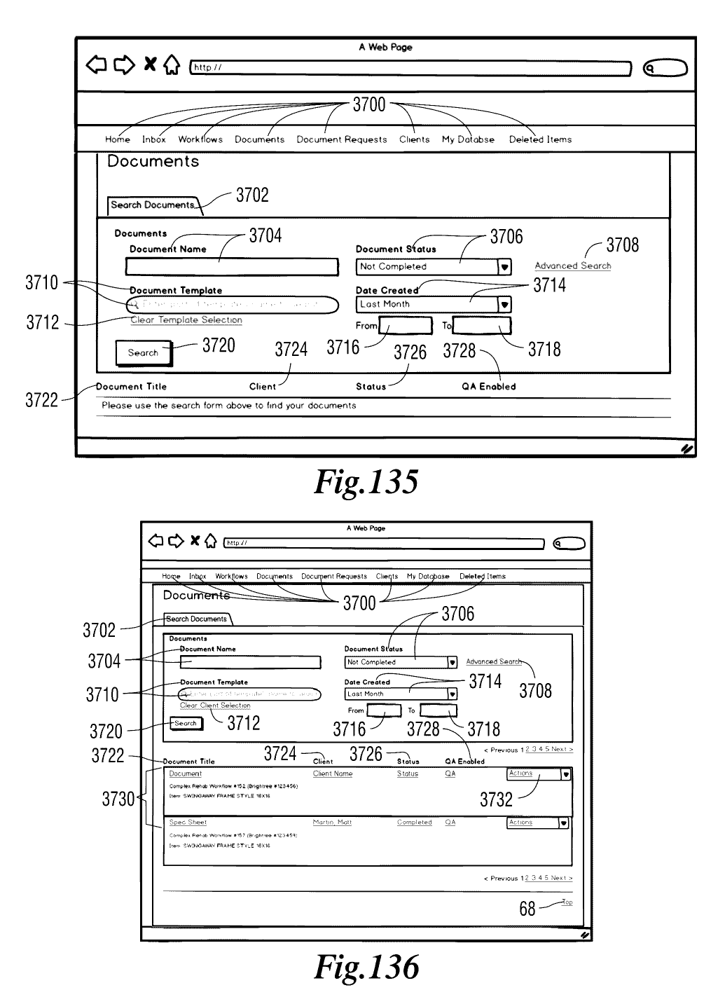

FIG. 135 is an illustration depicting a document search interface. Document menu items 3700 can include (for example) links to home, inbox, workflows, documents, document requests, clients, My Database, and deleted items, as discussed above. In documents tab 3702, search options can include document name 3704 (which can utilize any input criteria discussed herein, such as manual input, auto-complete/suggestions, selecting a document, etc.), document status 3706 (such as completed, overdue, in progress, not completed, etc.), and advanced search options 3708, which will be discussed below. Additionally, the template upon which a document is based (if applicable) can be searchable 3710, and can utilize any input criteria discussed herein (such as manual input, auto-complete/suggestions, selecting a template, etc.). A document can also be searched by its date of creation 3714, which can include a range specifying a start date/time 3716 and an end date/time 3718. Other embodiments can include options to search by last modified and/or to utilize any such search/query criteria to template searches. Once a document search request is indicated 3720, any suitable information, such as document title 3722, client 3724, document status 3726, and QA Enabled 3728 can be displayed for any document search results.

FIG. 136 is an illustration depicting another embodiment of a document search interface, here displaying document record search results. Here, two document records 3730 are displayed, each displaying the document title 3722, client 3724, document status 3726, QA enabled 3728, and document actions 3732 (which can include editing the document, assigning/modifying its assignments to various workstates/workflows, and deleting the document). Selecting any of these fields can bring up a corresponding interface to modify the document record's corresponding data, such as document title, client name, or status. Selecting QA can bring up any QA-type interface described herein, such as the QA item status review interface discussed above.

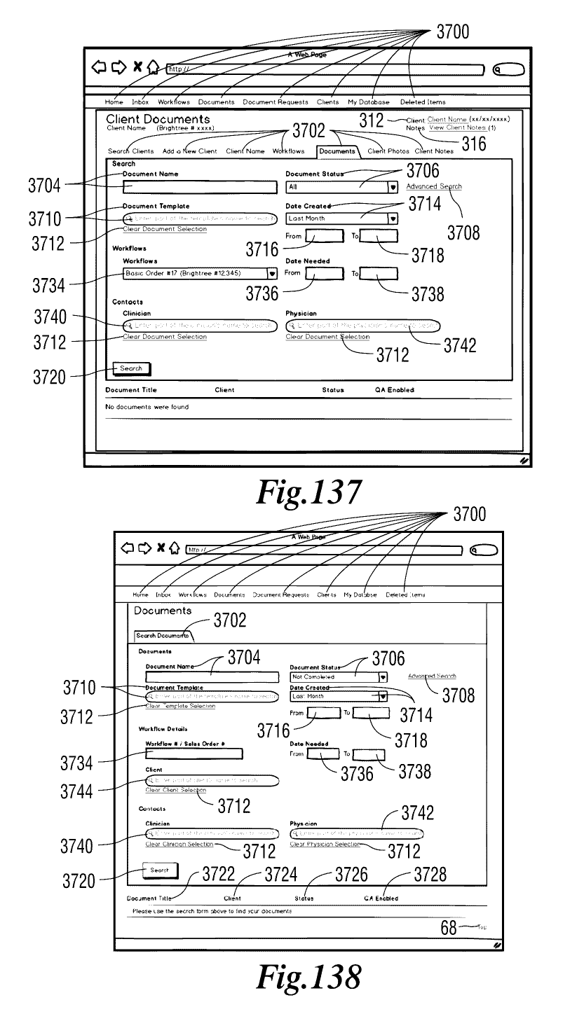

FIG. 137 is an illustration depicting a document search interface with advanced search options in another embodiment. Here, there are multiple options within the document tabs 3702, such as search clients, add a new client, client name, workflows, documents (presently selected), client photos, and client notes, for example. This embodiment shows additional document search criteria, which can correspond (in some embodiments) to the advanced search options 3708 depicted above in FIGS. 135-136. Such additional search criteria can include, for example, searching workflows 3734, including date range having a start date 3736 and an end date 3738 of when the workflow is needed (such as a workflow deadline). Additionally, search criteria can include a clinician's name 3740 and a physician's name 3742. Any combination of search criteria from any embodiments described can be utilized in combination.

FIG. 138 is an illustration depicting an embodiment of the document search interface with a combination of search fields described above with respect to embodiments described in FIGS. 136-137.

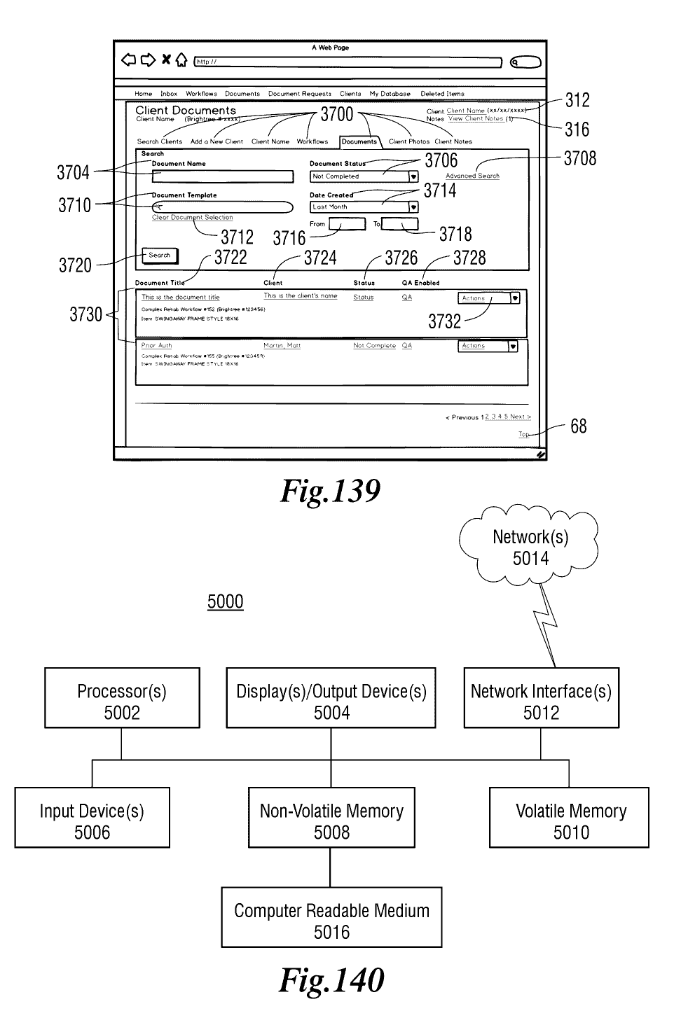

FIG. 139 is an illustration depicting an alternate embodiment of a document search interface with document records 3730 displayed in the document search results.

FIG. 140 illustrates an exemplary computer system 5000, through which embodiments of the disclosure can be implemented. The system 5000 described herein is but one example of a suitable computing environment and does not suggest any limitation on the scope of any embodiments presented. Nothing illustrated or described with respect to the system 5000 should be interpreted as being required or as creating any type of dependency with respect to any element or plurality of elements. In a basic embodiment, the system 5000 often includes at least one processor 5002 and memory (non-volatile memory 5008 and/or volatile memory 5010). The system 5000 can include one or more displays and/or output devices 5004 such as monitors, speakers, headphones, projectors, wearable-displays, holographic displays, and/or printers, for example. The system 5000 may further include one or more input devices 5006 which can include, by way of example, any type of mouse, keyboard, disk/media drive, memory stick/thumb-drive, memory card, pen, touch-input device, biometric scanner, voice/auditory input device, camera, etc. The system 5000 typically includes non-volatile memory 5008 (ROM, flash memory, etc.), volatile memory 5010 (RAM, etc.), or a combination thereof. The system 5000 can include one or more network interfaces 5012 to facilitate communication between the system 5000 and one or more additional devices, which may include, for example, client and/or server devices. A network interface 5012 can facilitate communications over one or more networks 5014 that may include any suitable type of public or private network, which by non-limiting example can include the internet, wireless networks, personal area networks (PAN), local area networks (LAN), wide area networks (WAN), municipal area networks (MAN), telephone networks, cable networks, fiber-optic networks, cellular networks, and/or satellite networks. All aforementioned devices, systems, connections, and/or accessories do not warrant further discussion as they are readily understood within the art.

A computer-readable medium 5016 may comprise a plurality of computer readable mediums, each of which may be either a computer readable storage medium or a computer readable signal medium. A computer readable storage medium 5016 may reside, for example, within an input device 5006, nonvolatile memory 5008, volatile memory 5010, or any combination thereof. A computer readable storage medium can include tangible media that is able to store instructions associated with, or used by, a device or system. A computer readable storage medium includes, by way of non-limiting examples: RAM, ROM, cache, fiber optics, EPROM/Flash memory, CD/DVD/BD-ROM, hard disk drives, solid-state storage, optical or magnetic storage devices, diskettes, electrical connections having a wire, or any combination thereof. A computer readable storage medium may also include, for example, a system or device that is of a magnetic, optical, semiconductor, or electronic type.

A computer readable signal medium can include any type of computer readable medium that is not a computer readable storage medium and may include, for example, propagated signals taking any number of forms such as optical, electromagnetic, or a combination thereof. A computer readable signal medium may include propagated data signals containing computer readable code, for example, within a carrier wave.

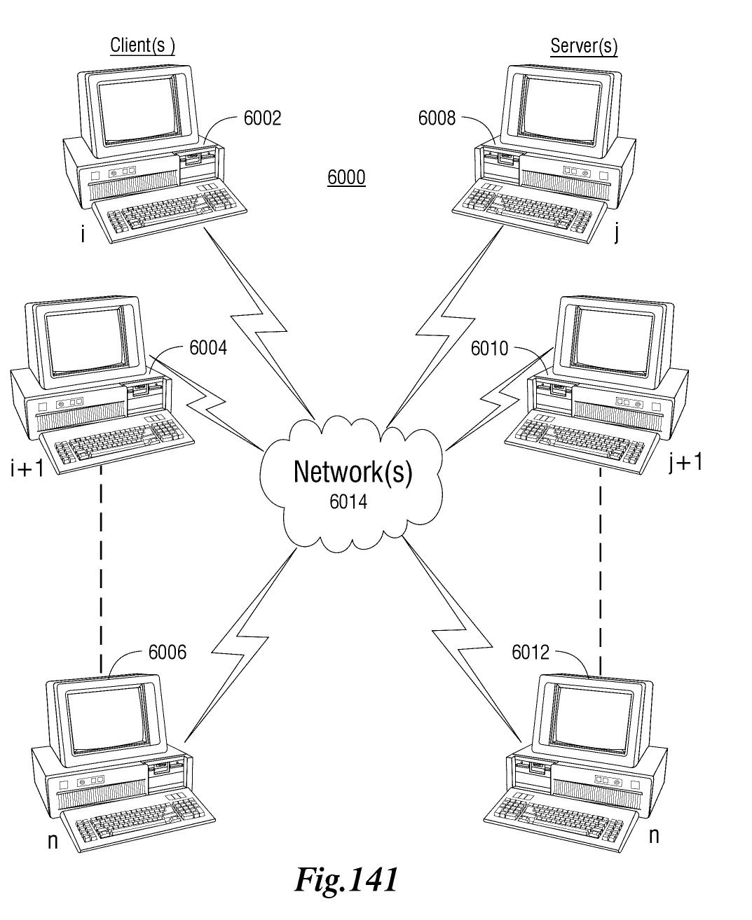

FIG. 141 illustrates an exemplary computing network 6000 through which client systems 6002, 6004, and 6006 can be coupled to one or more network(s) 6014 with server systems 6008, 6010, and 6012. Any respective quantities of client systems and server systems can be utilized. A client system, such as those depicted in 6002, 6004, and 6006, can include, for example, a computer system as depicted in 5000. Alternatively, a client can utilize any other configuration disclosed herein or as would be well known to one of ordinary skill in the art. Similarly, any server system, such as those depicted in 6008, 6010, and 6012, generally utilizes a computer system as depicted in 5000. Alternatively, a server can utilize any other configuration disclosed herein or as would be well known to one of ordinary skill in the art. Further, a server can be any known type of appropriate server, such as an application server, database server, etc. The network(s) depicted in 6014 can be implemented with, by non-limiting example, the internet, wireless networks, personal area networks (PAN), local area networks (LAN), wide area networks (WAN), municipal area networks (MAN), telephone networks, cable networks, fiber-optic networks, cellular networks, and/or satellite networks.

As described, exemplary computer system 5000 and/or one or more components of network architecture 6000 may perform and/or constitute a means for performing, either alone or in combination with other elements, one or more steps of an exemplary embodiment described herein. Any memory component, for example non-volatile memory 5008, volatile memory 5010, and/or a computer-readable medium 5016, as depicted in exemplary computer system 5000, can be utilized for distributed/cloud storage and/or retrieval. Any client or server can utilize one or more network interfaces as described above with respect to 5012, or any other suitable network interface. The network architecture 6000 need not be limited to the internet or any other particular type of network. Each client and/or server can utilize software, for example, a web browser, to remotely send and retrieve data with respect to any other connected device.

Any device disclosed herein need not be limited to the clients and servers depicted in network architecture 6000. All or any portion of any exemplary embodiment may be encoded as computer code, stored in, and/or run by, one or more servers 6008, 6010, and 6012, and distributed over network(s) 6014 to one or more clients 6002, 6004, and 6006, for example. Network architecture 6000 may perform and/or be a means for performing, either alone or in combination with any other element(s), one or more of the steps disclosed herein.

This invention has been described with reference to several preferred embodiments. Many modifications and alterations will occur to others upon reading and understanding the preceding specification. It is intended that the invention be construed as including all such alterations and modifications in so far as they come within the scope of the appended claims or the equivalents of these claims.

1. A computer-implemented method for workflow management of document processing through a user interface on a display device, comprising:
utilizing one or more objects associated with a workflow, wherein at least one object is imported from an external database;
creating or editing templates in a template editor utilizing the display device;
storing, in a template, rendering-data received through a template builder interface;
mapping to a workflow a template set whose criterion is satisfied by one of the objects associated with the workflow; and
generating a workflow of documents that are each rendered from the stored rendering-data in a template within a template set mapped to the workflow.

2. The computer-implemented method in claim 1 wherein:
the workflow comprises a workstate whose initiation requires the completion of another workstate; each workstate comprises a task whose initiation requires the completion of another task;
a team is assigned to each workstate;
each team comprises a plurality of roles, with each task corresponding to a role that corresponds to a team member; and
at least one team member is selected among a plurality of users having such role.

3. The computer-implemented method in claim 1 wherein:
the workflow comprises a workstate whose initiation requires the completion of another workstate; each workstate comprises a step whose initiation requires the completion of another step;
each step comprises a task whose initiation requires the completion of another task;
a team is assigned to each step;
each team comprises a plurality of roles, with each task corresponding to a role that corresponds to a team member;
at least one team member is selected among a plurality of users having such role;
each task, step, and workstate has deadline;
each team member receives a notification when a threshold amount of time, prior to their task's deadline, is exceeded and a subsequent notification when the deadline elapses;
each step is completed when the last incomplete constituent task is completed;
each workstate is completed when the last incomplete constituent step is completed; and the workflow is completed with the last incomplete workstate is completed.

4. The computer-implemented method in claim 1 wherein the criterion further comprises an object trigger condition that attaches a template set to a workflow, comprising:
insurance provider object trigger options for a specified insurance provider object or any insurance provider object associated with the workflow; a diagnosis object trigger option; or
item object trigger options comprising an item object code trigger, an item object name trigger, and an item object manufacturer trigger.

5. The computer-implemented method in claim 1 further comprising managing the template sets to which a template is assigned.

6. The computer-implemented method in claim 1 further comprising rendering one or more documents, each being rendered based upon the same selected template and being attached to the same workflow.

7. The computer-implemented method in claim 1 further comprising rendering one or more documents, each being based upon the same selected template and attached to the same workflow, based on displayed options that comprise:
rendering a document with a list of all insurance provider objects associated with the workflow;
rendering a document for each insurance provider object selected from among those associated with the workflow, wherein each generated document contains information regarding its associated insurance provider object; and
rendering a document for each insurance provider object associated with the workflow, wherein each generated document contains information regarding its associated insurance provider object.

8. The computer-implemented method in claim 1 wherein the template editor further comprises:
assigning or removing a template with respect to a template set based on:
object options comprising objects not being applicable, any objects, and only selected objects; and
code object options to use a template for all code objects, to use only specified code objects, and an option to exclude code objects entirely; and
displaying options to upload a template and to initialize or edit each of a template's properties, comprising: template title, field default font size, page counter location, recipient instructions text field, a fax cover sheet flag, and a compliance document flag.

9. The computer-implemented method in claim 1 further comprising:
rendering documents containing item object codes for:
all item objects associated with the instant workflow;
all item objects whose codes are specified; or
all item objects except those whose codes are specified as being excluded; and
attaching, to the instant workflow, documents rendered based upon the same selected template associated with the instant workflow.

10. The computer-implemented method in claim 1 wherein the template builder interface further comprises:
displaying an editable template with a listing of selectable input field templates;
receiving input designating a location within the template for a selected input field template; and
rendering a document, based upon the edited template, having an input field located thereon according to the received position information.

11. The computer-implemented method in claim 1 wherein the template builder interface further comprises:
displaying a selected editable template with a listing of selectable input field templates;
receiving input dragging and sizing a selected field template onto a pixel-defined location within the editable template;
displaying editable field property options comprising a required-field flag, a flag to propagate the field template to subsequent pages upon rendering, a specified default value, a specified comparison value, an encryption option, and a specified number of fields over which to split the instant field over upon rendering;
displaying a preview version of the editable template, wherein each associated field template is displayed according to its respective specified pixel position and specified field properties; and
rendering a document, based on the template, having an input field located thereon according to the received input.

12. The computer-implemented method in claim 1 wherein the template editor further comprises:
displaying options to assign and remove a template with respect to a template set; and displaying options to create and edit a template.

13. The computer-implemented method in claim 1 wherein the template editor further comprises displaying options to toggle template visibility, to indicate a template is a favorite, and to clone a template by requiring a different title.

14. The computer-implemented method in claim 1 wherein the template editor further comprises a customizable checklist designating which fields in a rendered document require completion prior to the rendered document being designated as complete.

15. The computer-implemented method in claim 1 wherein the user interface further comprises displaying options for downloading, secure-sending electronic transmission, and faxing a rendered document.

16. The computer-implemented method in claim 1 wherein the template builder interface displays a notification in a rendered document when an object value does not match any values in a list of comparison values in a field in the template.

17. The computer-implemented method in claim 1 wherein the template builder interface outputs an item object listing within a rendered document, with any item objects exceeding a quantity threshold for a page being rendered on a subsequent page of the rendered document.

18. The computer-implemented method in claim 1 wherein the template builder interface further comprises an editable field property flag that auto-copies a value entered into a field rendered across all supplemental pages in a rendered document.

19. The computer-implemented method in claim 1 wherein the user interface further comprises a user delegating each document template in a workflow to one or more different users, which removes the workflow from the user's interface until at least one delegated document template is returned or cancelled.

20. The computer-implemented method in claim 1 wherein the user interface further comprises a profit analyzer interface that displays a profit index calculated by dividing a received positive item allowance amount by a received positive item cost amount.

21. The computer-implemented method in claim 1 wherein the user interface displays an object imported from an outside database as a selectable pre-generated object.

22. The computer-implemented method in claim 1 wherein a template is manually associated with a workflow.

23. The computer-implemented method in claim 1 wherein a field is displayed in the rendered document only if a recipient account is of a role type matching a role type specified by the recipient options within the field's recipient options.

24. The computer-implemented method in claim 1 wherein a change in data associated with a field propagates the field's data by causing an automatic re-rendering of all documents in the same workflow utilizing the field.

25. The computer-implemented method in claim 1 further comprising a signature input field that includes options to type and draw a signature, an option indicating the signer is authorized to sign, and an option indicating the client cannot sign with a field receiving the signer's name and relationship to the client and a field receiving a reason the client cannot sign.

26. The computer-implemented method in claim 1 wherein the quantity of pages in a rendered document corresponds to the quantity of item objects rendered in the rendered document.

27. The computer-implemented method in claim 1 wherein the criterion further comprises an object trigger condition that attaches a template set to a workflow based on satisfying a data range condition for an input value received in a field in a rendered document from the template set.

28. The computer-implemented method in claim 1 wherein rendered documents are dynamically replicated into the workflow based on each different value of an object type within a workflow, each rendered document reflecting its respective value of the object type.

29. The computer-implemented method in claim 1 wherein rendered documents are delegated within a user account to selected user accounts associated with the user account, each selected user account being assigned to complete at least one delegated rendered document.

30. The computer-implemented method in claim 1 wherein rendered documents are delegated within a user account to selected user accounts associated with the user account, each selected user account being assigned to complete at least one delegated rendered document, whereupon completion of an assigned rendered document, the user interface presents append and replace options for the completed document.

31. The computer-implemented method in claim 1 wherein the workflow utilizes a work-in-progress comprising tasks to be completed, documents to be completed, appointments to be completed, role assigned to each task, deadline to complete each task, and the next work-in-progress state.

32. The computer-implemented method in claim 1 wherein the user interface presents a graphical dashboard interface of all workflows associated with a user account.

33. The computer-implemented method in claim 1 wherein the user interface removes a task associated with a user's account when the user has delegated all portions of the task to other users or groups within an organization to which the user account belongs.

34. The computer-implemented method in claim 1 wherein the user interface provides an option that hides a client's last name in all documentation associated with an organization.

35. The computer-implemented method in claim 1 wherein the criterion further comprises an object trigger condition that attaches a template set to a workflow based on satisfying a data range condition for an input value received in a field in a rendered document from the template set, wherein a document from the attached template set, once rendered, displays fields pre-populated with data from an object associated with the object trigger condition.

36. The computer-implemented method in claim 1 wherein the user interface further presents administrative options, for user accounts and fax numbers, comprising add, edit, update, and delete, with respect to both a company's account and to each of the company's plurality of branch locations.

37. A computer-implemented method of rendering a document through a template builder interface on a display device, comprising:
displaying a listing of selectable input field templates in an editable template;
displaying a thumbnail version of each template page;
subsequently receiving input dragging and sizing a selected field template onto the editable template, with the field template location corresponding to editable location values within the editable template;
displaying editable field properties comprising a required-field flag, a flag to propagate both the field template and its received data to subsequent pages upon rendering, a default value, and a comparison value;
subsequently displaying a preview version of the editable template, wherein each associated field template is displayed according to its respective specified location values and its field property values; and
subsequently rendering a document on the display device, based on the template, with an input field located on the rendered document according to the specified location values.

38. The computer-implemented method in claim 37 wherein the template builder interface further comprises displaying options, for a currently selected field template, comprising:
dragging, resizing, copying, deleting, field character limit, mandatory default value, optional default value, an encryption option, measurement unit types comprising weight measurement units, time measurement units, and size units comprising length, width, and height measurement units;
specifying a field type that comprises a text field, a drop-down list that utilizes input in a delimited document, a numeric split value that specifies a number of fields over which to split the instant field between upon rendering; and
selecting a recipient role comprising clinician, vendor, physician, and client.

39. A system for workflow management of document processing through a user interface on a display device, said system comprising:
a memory; and
a processor coupled to said memory, said processor configured to:
utilize one or more objects associated with a workflow, wherein at least one object is imported from an external database; create or edit templates in a template editor;
storing, in a template, rendering-data received through a template builder interface;
map to a workflow a template set whose criterion is satisfied by one of said objects associated with said workflow; and
generate a workflow of documents that are each rendered from said stored rendering-data in a template within a template set mapped to said workflow.

40. The system in claim 39 wherein:
the workflow comprises a workstate whose initiation requires the completion of another workstate; each workstate comprises a task whose initiation requires the completion of another task;
a team is assigned to each workstate;
each team comprises a plurality of roles, with each task corresponding to a role that corresponds to a team member; and
at least one team member is selected among a plurality of users having such role.

41. The system in claim 39 wherein:
the workflow comprises a workstate whose initiation requires the completion of another workstate; each workstate comprises a step whose initiation requires the completion of another step;
each step comprises a task whose initiation requires the completion of another task;
a team is assigned to each step;
each team comprises a plurality of roles, with each task corresponding to a role that corresponds to a team member;
at least one team member is selected among a plurality of users having such role;
each task, step, and workstate has deadline;
each team member receives a notification when a threshold amount of time, prior to their task's deadline, is exceeded and a subsequent notification when the deadline elapses;
each step is completed when the last incomplete constituent task is completed;
each workstate is completed when the last incomplete constituent step is completed; and
the workflow is completed with the last incomplete workstate is completed.

42. The system in claim 39 wherein said criterion further comprises an object trigger condition that attaches a template set to a workflow, comprising:
insurance provider object trigger options for a specified insurance provider object or any insurance provider object associated with said workflow;
a diagnosis object trigger option; or
item object trigger options comprising an item object code trigger, an item object name trigger, and an item object manufacturer trigger.

43. The system in claim 39 wherein said user interface further comprises managing said template sets to which a template is assigned.

44. The system in claim 39 wherein said user interface further comprises rendering one or more documents, each being rendered based upon said same selected template and being attached to said same workflow.

45. The system in claim 39 wherein said user interface further comprises rendering one or more documents, each being based upon said same selected template and attached to said same workflow, based on displayed options that comprise:
rendering a document with a list of all insurance provider objects associated with said workflow;
rendering a document for each insurance provider object selected from among those associated with said workflow, wherein each generated document contains information regarding its associated insurance provider object; and
rendering a document for each insurance provider object associated with said workflow, wherein each generated document contains information regarding its associated insurance provider object.

46. The system in claim 39 wherein said template editor further comprises:
assigning or removing a template with respect to a template set based on:
object options comprising objects not being applicable, any objects, and only selected objects; and
code object options to use a template for all code objects, to use only specified code objects, and an option to exclude code objects entirely; and
displaying options to upload a template and to initialize or edit each of a template's properties, comprising: template title, field default font size, page counter location, recipient instructions text field, a fax cover sheet flag, and a compliance document flag.

47. The system in claim 39 wherein said user interface further comprises:
rendering documents containing item object codes for:
all item objects associated with said instant workflow;
all item objects whose codes are specified; or
all item objects except those whose codes are specified as being excluded; and
attaching, to said instant workflow, documents rendered based upon said same selected template associated with said instant workflow.

48. The system in claim 39 wherein said template builder interface further comprises:
displaying an editable template with a listing of selectable input field templates;
receiving input designating a location within said template for a selected input field template; and
rendering a document, based upon said edited template, having an input field located thereon according to said received location information.

49. The system in claim 39 wherein said template builder interface further comprises:
displaying a selected editable template with a listing of selectable input field templates;
receiving input dragging and sizing a selected field template onto a pixel-defined location within said editable template;
displaying editable field property options comprising a required-field flag, a flag to propagate said field template to subsequent pages upon rendering, a specified default value, a specified comparison value, an encryption option, and a specified number of fields over which to split said field over upon rendering; displaying a preview version of said editable template, wherein each associated field template is displayed according to its respective specified pixel position and specified field properties; and
rendering a document, based on said template, having an input field located thereon according to said received input.

50. The system in claim 39 wherein said template editor further comprises:
displaying options to assign and remove a template with respect to a template set; and
displaying options to create and edit a template.

51. The system in claim 39 wherein said template editor further comprises displaying options to toggle template visibility, to indicate a template is a favorite, and to clone a template by requiring a different title.

52. The system in claim 39 wherein said template editor further comprises a customizable checklist designating which fields in a rendered document require completion prior to said rendered document being designated as complete.

53. The system in claim 39 wherein said user interface further comprises displaying options for downloading, secure-sending electronic transmission, and faxing a rendered document.

54. The system in claim 39 wherein said template builder interface displays a notification in a rendered document when an object value does not match any values in a list of comparison values in a field in said template.

55. The system in claim 39 wherein said template builder interface outputs an item object listing within a rendered document, with any item objects exceeding a quantity threshold for a page being rendered on a subsequent page of said rendered document.

56. The system in claim 39 wherein said template builder interface further comprises an editable field property flag that auto-copies a value entered into a field rendered across all supplemental pages in a rendered document.

57. The system in claim 39 wherein said user interface further comprises a user delegating each document template in a workflow to one or more different users, which removes said workflow from said user's interface until at least one delegated document template is returned or cancelled.

58. The system in claim 39 wherein said user interface further comprises a profit analyzer interface that displays a profit index calculated by dividing a received positive item allowance amount by a received positive item cost amount.

59. The system in claim 39 wherein said user interface displays an object imported from an outside database as a selectable pre-generated object.

60. The system in claim 39 wherein a template is manually associated with a workflow.

61. The system in claim 39 wherein said user interface further comprises displaying a field in said rendered document only if a recipient account is of a role type matching a role type specified by recipient options within said field's recipient options.

62. The system in claim 39 wherein a change in data associated with a field propagates said field's data by causing an automatic re-rendering of all documents in the same workflow utilizing said field.

63. The system in claim 39 wherein said user interface further comprises a signature input field that includes options to type and draw a signature, an option indicating the signer is authorized to sign, and an option indicating the client cannot sign with a field receiving the signer's name and relationship to the client and a field receiving a reason the client cannot sign.

64. The system in claim 39 wherein the quantity of pages in a rendered document corresponds to the quantity of item objects rendered in said rendered document.

65. The system in claim 39 wherein said criterion further comprises an object trigger condition that attaches a template set to a workflow based on satisfying a data range condition for an input value received in a field in a rendered document from said template set.

66. The system in claim 39 wherein rendered documents are dynamically replicated into said workflow based on each different value of an object type within a workflow, each rendered document reflecting its respective value of said object type.

67. The system in claim 39 wherein rendered documents are delegated within a user account to selected user accounts associated with said user account, each selected user account being assigned to complete at least one delegated rendered document.

68. The system in claim 39 wherein rendered documents are delegated within a user account to selected user accounts associated with said user account, each selected user account being assigned to complete at least one delegated rendered document, whereupon completion of an assigned rendered document, said user interface presents append and replace options for said completed document.

69. The system in claim 39 wherein said workflow utilizes a work-in-progress comprising tasks to be completed, documents to be completed, appointments to be completed, role assigned to each task, deadline to complete each task, and the next work-in-progress state.

70. The system in claim 39 wherein said user interface presents a graphical dashboard interface of all workflows associated with a user account.

71. The system in claim 39 wherein said user interface removes a task associated with a user's account when said user has delegated all portions of said task to other users or groups within an organization to which said user account belongs.

72. The system in claim 39 wherein said user interface provides an option that hides a client's last name in all documentation associated with an organization.

73. The system in claim 39 wherein said criterion further comprises an object trigger condition that attaches a template set to a workflow based on satisfying a data range condition for an input value received in a field in a rendered document from said template set, wherein a document from said attached template set, once rendered, displays fields pre-populated with data from an object associated with said object trigger condition.

74. The system in claim 39 wherein said user interface further presents administrative options, for user accounts and fax numbers, comprising add, edit, update, and delete, with respect to both a company's account and to each of said company's plurality of branch locations.

75. A system for workflow management of rendering a document through a template builder interface on a display device, said system comprising:
a memory; and
a processor coupled to said memory, said processor configured to:
display a listing of selectable input field templates in an editable template;
display a thumbnail version of each template page;
subsequently receive input dragging and sizing a selected field template onto said editable template, with said field template location corresponding to editable location values within said editable template;
display editable field properties comprising a required-field flag, a flag to propagate both said field template and its received data to subsequent pages upon rendering, a default value, and a comparison value; subsequently display a preview version of said editable template, wherein each associated field template is displayed according to its respective specified location values and its field property values; and
subsequently render a document, based on said editable template, with an input field located on said rendered document according to said specified location values.

76. The system in claim 75 wherein said template builder interface further comprises displaying options, for a currently selected field template, comprising:
dragging, resizing, copying, deleting, field character limit, mandatory default value, optional default value, an encryption option, measurement unit types comprising weight measurement units, time measurement units, and size units comprising length, width, and height measurement units;
specifying a field type that comprises a text field, a drop-down list that utilizes input in a delimited document, a numeric split value that specifies a number of fields over which to split said field between upon rendering; and
selecting a recipient role comprising clinician, vendor, physician, and client.

77. A non-transitory computer-readable medium for workflow management of document processing through a user interface containing instructions that, when executed by a processor, cause the processor to perform a method comprising:
utilizing one or more objects associated with a workflow, wherein at least one object is imported from an external database;
creating or editing templates in a template editor utilizing the display device;
storing, in a template, rendering-data received through a template builder interface;
mapping to a workflow a template set whose criterion is satisfied by one of the objects associated with the workflow; and
generating a workflow of documents that are each rendered from the stored rendering-data in a template within a template set mapped to the workflow.

78. The non-transitory computer-readable medium in claim 77 wherein:
the workflow comprises a workstate whose initiation requires the completion of another workstate; each workstate comprises a task whose initiation requires the completion of another task;
a team is assigned to each workstate;
each team comprises a plurality of roles, with each task corresponding to a role that corresponds to a team member; and
at least one team member is selected among a plurality of users having such role.

79. The non-transitory computer-readable medium in claim 77 wherein:
the workflow comprises a workstate whose initiation requires the completion of another workstate;
each workstate comprises a step whose initiation requires the completion of another step;
each step comprises a task whose initiation requires the completion of another task;
a team is assigned to each step;
each team comprises a plurality of roles, with each task corresponding to a role that corresponds to a team member;
at least one team member is selected among a plurality of users having such role;
each task, step, and workstate has deadline;
each team member receives a notification when a threshold amount of time, prior to their task's deadline, is exceeded and a subsequent notification when the deadline elapses;
each step is completed when the last incomplete constituent task is completed;
each workstate is completed when the last incomplete constituent step is completed; and
the workflow is completed with the last incomplete workstate is completed.

80. The non-transitory computer-readable medium in claim 77 wherein the criterion further comprises an object trigger condition that attaches a template set to a workflow, comprising:
insurance provider object trigger options for a specified insurance provider object or any insurance provider object associated with the workflow;
a diagnosis object trigger option; or
item object trigger options comprising an item object code trigger, an item object name trigger, and an item object manufacturer trigger.

81. The non-transitory computer-readable medium in claim 77 further comprising managing the template sets to which a template is assigned.

82. The non-transitory computer-readable medium in claim 77 further comprising rendering one or more documents, each being rendered based upon the same selected template and being attached to the same workflow.

83. The non-transitory computer-readable medium in claim 77 further comprising rendering one or more documents, each being based upon the same selected template and attached to the same workflow, based on displayed options that comprise:
rendering a document with a list of all insurance provider objects associated with the workflow;
rendering a document for each insurance provider object selected from among those associated with the workflow, wherein each generated document contains information regarding its associated insurance provider object; and
rendering a document for each insurance provider object associated with the workflow, wherein each generated document contains information regarding its associated insurance provider object.

84. The non-transitory computer-readable medium in claim 77 wherein the template editor further comprises:
assigning or removing a template with respect to a template set based on:
object options comprising objects not being applicable, any objects, and only selected objects; and
code object options to use a template for all code objects, to use only specified code objects, and an option to exclude code objects entirely; and
displaying options to upload a template and to initialize or edit each of a template's properties, comprising: template title, field default font size, page counter location, recipient instructions text field, a fax cover sheet flag, and a compliance document flag.

85. The non-transitory computer-readable medium in claim 77 further comprising:
rendering documents containing item object codes for:
all item objects associated with the instant workflow;
all item objects whose codes are specified; or
all item objects except those whose codes are specified as being excluded; and
attaching, to the instant workflow, documents rendered based upon the same selected template associated with the instant workflow.

86. The non-transitory computer-readable medium in claim 77 wherein the template builder interface further comprises:
displaying an editable template with a listing of selectable input field templates;
receiving input designating a location within the template for a selected input field template; and
rendering a document, based upon the edited template, having an input field located thereon according to the received position information.

87. The non-transitory computer-readable medium in claim 77 wherein the template builder interface further comprises:
displaying a selected editable template with a listing of selectable input field templates;
receiving input dragging and sizing a selected field template onto a pixel-defined location within the editable template;
displaying editable field property options comprising a required-field flag, a flag to propagate the field template to subsequent pages upon rendering, a specified default value, a specified comparison value, an encryption option, and a specified number of fields over which to split the instant field over upon rendering;
displaying a preview version of the editable template, wherein each associated field template is displayed according to its respective specified pixel position and specified field properties; and
rendering a document, based on the template, having an input field located thereon according to the received input.

88. The non-transitory computer-readable medium in claim 77 wherein the template editor further comprises:
displaying options to assign and remove a template with respect to a template set; and
displaying options to create and edit a template.

89. The non-transitory computer-readable medium in claim 77 wherein the template editor further comprises displaying options to toggle template visibility, to indicate a template is a favorite, and to clone a template by requiring a different title.

90. The non-transitory computer-readable medium in claim 77 wherein the template editor further comprises a customizable checklist designating which fields in a rendered document require completion prior to the rendered document being designated as complete.

91. The non-transitory computer-readable medium in claim 77 wherein the user interface further comprises displaying options for downloading, secure-sending electronic transmission, and faxing a rendered document.

92. The non-transitory computer-readable medium in claim 77 wherein the template builder interface displays a notification in a rendered document when an object value does not match any values in a list of comparison values in a field in the template.

93. The non-transitory computer-readable medium in claim 77 wherein the template builder interface outputs an item object listing within a rendered document, with any item objects exceeding a quantity threshold for a page being rendered on a subsequent page of the rendered document.

94. The non-transitory computer-readable medium in claim 77 wherein the template builder interface further comprises an editable field property flag that auto-copies a value entered into a field rendered across all supplemental pages in a rendered document.

95. The non-transitory computer-readable medium in claim 77 wherein the user interface further comprises a user delegating each document template in a workflow to one or more different users, which removes the workflow from the user's interface until at least one delegated document template is returned or cancelled.

96. The non-transitory computer-readable medium in claim 77 wherein the user interface further comprises a profit analyzer interface that displays a profit index calculated by dividing a received positive item allowance amount by a received positive item cost amount.

97. The non-transitory computer-readable medium in claim 77 wherein the user interface displays an object imported from an outside database as a selectable pre-generated object.

98. The non-transitory computer-readable medium in claim 77 wherein a template is manually associated with a workflow.

99. The non-transitory computer-readable medium in claim 77 wherein a field is displayed in the rendered document only if a recipient account is of a role type matching a role type specified by the recipient options within the field's recipient options.

100. The non-transitory computer-readable medium in claim 77 wherein a change in data associated with a field propagates the field's data by causing an automatic re-rendering of all documents in the same workflow utilizing the field.

101. The non-transitory computer-readable medium in claim 77 further comprising a signature input field that includes options to type and draw a signature, an option indicating the signer is authorized to sign, and an option indicating the client cannot sign with a field receiving the signer's name and relationship to the client and a field receiving a reason the client cannot sign.

102. The non-transitory computer-readable medium in claim 77 wherein the quantity of pages in a rendered document corresponds to the quantity of item objects rendered in the rendered document.

103. The non-transitory computer-readable medium in claim 77 wherein the criterion further comprises an object trigger condition that attaches a template set to a workflow based on satisfying a data range condition for an input value received in a field in a rendered document from the template set.

104. The non-transitory computer-readable medium in claim 77 wherein rendered documents are dynamically replicated into the workflow based on each different value of an object type within a workflow, each rendered document reflecting its respective value of the object type.

105. The non-transitory computer-readable medium in claim 77 wherein rendered documents are delegated within a user account to selected user accounts associated with the user account, each selected user account being assigned to complete at least one delegated rendered document.

106. The non-transitory computer-readable medium in claim 77 wherein rendered documents are delegated within a user account to selected user accounts associated with the user account, each selected user account being assigned to complete at least one delegated rendered document, whereupon completion of an assigned rendered document, the user interface presents append and replace options for the completed document.

107. The non-transitory computer-readable medium in claim 77 wherein the workflow utilizes a work-in-progress comprising tasks to be completed, documents to be completed, appointments to be completed, role assigned to each task, deadline to complete each task, and the next work-in-progress state.

108. The non-transitory computer-readable medium in claim 77 wherein the user interface presents a graphical dashboard interface of all workflows associated with a user account.

109. The non-transitory computer-readable medium in claim 77 wherein the user interface removes a task associated with a user's account when the user has delegated all portions of the task to other users or groups within an organization to which the user account belongs.

110. The non-transitory computer-readable medium in claim 77 wherein the user interface provides an option that hides a client's last name in all documentation associated with an organization.

111. The non-transitory computer-readable medium in claim 77 wherein the criterion further comprises an object trigger condition that attaches a template set to a workflow based on satisfying a data range condition for an input value received in a field in a rendered document from the template set, wherein a document from the attached template set, once rendered, displays fields pre-populated with data from an object associated with the object trigger condition.

112. The non-transitory computer-readable medium in claim 77 wherein the user interface further presents administrative options, for user accounts and fax numbers, comprising add, edit, update, and delete, with respect to both a company's account and to each of the company's plurality of branch locations.

113. A non-transitory computer-readable medium for rendering a document through a template builder interface containing instructions that, when executed by a processor, cause the processor to perform a method comprising:
displaying a listing of selectable input field templates in an editable template;
displaying a thumbnail version of each template page;
subsequently receiving input dragging and sizing a selected field template onto the editable template, with the field template location corresponding to editable location values within the editable template;
displaying editable field properties comprising a required-field flag, a flag to propagate both the field template and its received data to subsequent pages upon rendering, a default value, and a comparison value;
subsequently displaying a preview version of the editable template, wherein each associated field template is displayed according to its respective specified location values and its field property values; and
subsequently rendering a document on the display device, based on the template, with an input field located on the rendered document according to the specified location values.

114. The non-transitory computer-readable medium in claim 113 wherein the template builder interface further comprises displaying options, for a currently selected field template, comprising:
dragging, resizing, copying, deleting, field character limit, mandatory default value, optional default value, an encryption option, measurement unit types comprising weight measurement units, time measurement units, and size units comprising length, width, and height measurement units;
specifying a field type that comprises a text field, a drop-down list that utilizes input in a delimited document, a numeric split value that specifies a number of fields over which to split the instant field between upon rendering; and
selecting a recipient role comprising clinician, vendor, physician, and client.
